SEQUENCE LISTING (19 sequences)

SEQ ID NO: 1 - DNA, 2187 bp, Homo sapiens
  mRNA (1)...(2187): Human interferon regulatory factor 5 (IRF5) mRNA
gcggcgggaggcgcagcctgggcagagctcagcttggtcccgccgcccggccggtgctccctggcgcagccacgcaggcgcaccgcagacagacccctctgccatgaaccagtccatcccagtggctcccaccccaccccgccgcgtgcggctgaagccctggctggtggcccaggtgaacagctgccagtacccagggcttcaatgggtcaacggggaaaagaaattattctgcatcccctggaggcatgccacaaggcatggtcccagccaggacggagataacaccatcttcaaggcctgggccaaggagacagggaaatacaccgaaggcgtggatgaagccgatccggccaagtggaaggccaacctgcgctgtgcccttaacaagagccgggacttccgcctcatctacgacgggccccgggacatgccacctcagccctacaagatctacgaggtctgctccaatggccctgctcccacagactcccagccccctgaggattactcttttggtgcaggagaggaggaggaagaagaggaagagctgcagaggatgttgccaagcctgagcctcacagatgcagtgcagtctggcccccacatgacaccctattctttactcaaagaggatgtcaagtggccgcccactctgcagccgcccactctgcagccgcccgtggtgctgggtccccctgctccagaccccagccccctggctcctccccctggcaaccctgctggcttcagggagcttctctctgaggtcctggagcctgggcccctgcctgccagcctgccccctgcaggcgaacagctcctgccagacctgctgatcagcccccacatgctgcctctgaccgacctggagatcaagtttcagtaccgggggcggccaccccgggccctcaccatcagcaacccccatggctgccggctcttctacagccagctggaggccacccaggagcaggtggaactcttcggccccataagcctggagcaagtgcgcttccccagccctgaggacatccccagtgacaagcagcgcttctacacgaaccagctgctggatgtcctggaccgcgggctcatcctccagctacagggccaggacctttatgccatccgcctgtgtcagtgcaaggtgttctggagcgggccttgtgcctcagcccatgactcatgccccaaccccatccagcgggaggtcaagaccaagcttttcagcctggagcattttctcaatgagctcatcctgttccaaaagggccagaccaacaccccaccacccttcgagatcttcttctgctttggggaagaatggcctgaccgcaaaccccgagagaagaagctcattactgtacaggtggtgcctgtagcagctcgactgctgctggagatgttctcaggggagctatcttggtcagctgatagtatccggctacagatctcaaacccagacctcaaagaccgcatggtggagcaattcaaggagctccatcacatctggcagtcccagcagcggttgcagcctgtggcccaggcccctcctggagcaggccttggtgttggccaggggccctggcctatgcacccagctggcatgcaataacaaggctgcagacggtgactggccctggcttcctgggtggcggtgcggactgatgtggagatgtgacagccccgatgagcacctggctggctgcagggtcctacctctgggtttcctggaagtggatttgggccaagaaggagagggagaaaggcccgagcccctgccttcccgggcctttctctcctgggctgtctctggtctggtcagcctggctctcgggaaattcagccatgagcagggaaagaactctcccaaccctggggcctagctgtataggaggaattgcctaagggtggcccactcttgtgattgccccatttcctctggcaacaaaagccagagtgttgtgggccaagtccccccacagggcctctgcagggcatggccctgatttccctggtttgagactcacttcctcatctccctgtcctctgagataatatgagtgagcacttaggtatcatatcagatgctcaaggctggcagctacccccttcttgagagtccaagaacctggagcagaaataatttttatgtatttttggattaataaatgttaaaaacag

SEQ ID NO: 2 - DNA, 1462 bp, Homo sapiens
  mRNA (1)...(1462): Human cell division cycle 34 (CDC34) mRNA
ggcaagcgccggtggggcggcggcgccagagctgctggagcgctcggggtccccgggcggcggcggcggcgcagaggaggaggcaggcggcggccccggtggctcccccccggacggtgcgcggcccggcccgtctcgcgaactcgcggtggtcgcgcggccccgcgctgctccgaccccgggcccctccgccgccgccatggctcggccgctagtgcccagctcgcagaaggcgctgctgctggagctcaaggggctgcaggaagagccggtcgagggattccgcgtgacactggtggacgagggcgatctatacaactgggaggtggccatcttcgggccccccaacacctactacgagggcggctacttcaaggcgcgcctcaagttccccatcgactacccatactctccaccagcctttcggttcctgaccaagatgtggcaccctaacatctacgagacgggggacgtgtgtatctccatcctccacccgccggtggacgacccccagagcggggagctgccctcagagaggtggaaccccacgcagaacgtcaggaccattctcctgagtgtgatctccctcctgaacgagcccaacaccttctcgcccgcaaacgtggacgcctccgtgatgtacaggaagtggaaagagagcaaggggaaggatcgggagtacacagacatcatccggaagcaggtcctggggaccaaggtggacgcggagcgtgacggcgtgaaggtgcccaccacgctggccgagtactgcgtgaagaccaaggcgccggcgcccgacgagggctcagacctcttctacgacgactactacgaggacggcgaggtggaggaggaggccgacagctgcttcggggacgatgaggatgactctggcacggaggagtcctgacaccaccagaataaacttgccgagtttacctcactagggccggacccgtggctccttagacgacagactacctcacggaggttttgtgctggtccccgtctcctctggttgtttcgttttggctttttctccctccccatgtctgttctgggttttcacgtgcttcagagaagaggggctgccccaccgccactcacgtcactcggggctcggtggacgggcccagggtgggagcggccggcccacctgtcccctcgggaggggagctgagcccgacttctaccggggtcccccagcttccggactggccgcaccccggaggagccacgggggcgctgctgggaacgtgggcggggggccgtttcctgacactaccagcctgggaggcccaggtgtagcggtccgaggggcccggtcctgcctgtcagctccaggtcctggagccacgtccagcacagagtggacggattcaccgtggccgactcttttccctgctttggtttgtttgaaatctaaataaaactactttatgagaaaaaaaaaaaaaaaaaa

SEQ ID NO: 3 - DNA, 3505 bp, Homo sapiens
  mRNA (1)...(3505): Human BCL2/adenovirus E1B 19kDa interacting protein 3-like (BNIP3L) mRNA
cgtcaggggcaggggagggacggcgcaggcgcagaaaagggggcggcggactcggcttgttgtgttgctgcctgagtgccggagacggtcctgctgctgccgcagtcctgccagctgtccgacaatgtcgtcccacctagtcgagccgccgccgcccctgcacaacaacaacaacaactgcgaggaaaatgagcagtctctgcccccgccggccggcctcaacagttcctgggtggagctacccatgaacagcagcaatggcaatgataatggcaatgggaaaaatggggggctggaacacgtaccatcctcatcctccatccacaatggagacatggagaagattcttttggatgcacaacatgaatcaggacagagtagttccagaggcagttctcactgtgacagcccttcgccacaagaagatgggcagatcatgtttgatgtggaaatgcacaccagcagggaccatagctctcagtcagaagaagaagttgtagaaggagagaaggaagtcgaggctttgaagaaaagtgcggactgggtatcagactggtccagtagacccgaaaacattccacccaaggagttccacttcagacaccctaaacgttctgtgtctttaagcatgaggaaaagtggagccatgaagaaagggggtattttctccgcagaatttctgaaggtgttcattccatctctcttcctttctcatgttttggctttggggctaggcatctatattggaaagcgactgagcacaccctctgccagcacctactgagggaaaggaaaagcccctggaaatgcgtgtgacctgtgaagtggtgtattgtcacagtagcttatttgaacttgagaccattgtaagcatgacccaacctaccaccctgtttttacatatccaattccagtaactctcaaattcaatattttattcaaactctgttgaggcattttactaaccttataccctttttggcctgaagacattttagaatttcctaacagagtttactgttgtttagaaatttgcaagggcttcttttccgcaaatgccaccagcagattataattttgtcagcaatgctattatctctaattagtgccaccagactagacctgtatcattcatggtataaattttactcttgcaacataactaccatctctctcttaaaacgagatcaggttagcaaatgatgtaaaagaagctttattgtctagttgttttttttcccccaagacaaaggcaagtttccctaagtttgagttgatagttattaaaaagaaaacaaaacaaaaaaaaaaggcaaggcacaacaaaaaaatatcctgggcaataaaaaaaatattttaaaccagctttggagccacttttttgtctaagcctcctaatagcgtcttttaatttataggaggcaaactgtataaatgataggtatgaaatagaataagaagtaaaatacatcagcagattttcatactagtatgttgtaatgctgtcttttctatggtgtagaatctttctttctgataaggaacgtctcaggcttagaaatatatgaaattgctttttgagatttttgcgtgtgtgtttgatattttttacgataattagctgcatgtgaatttttcatgaccttctttacattttttattttttatttctttatttttttttctctaagaagaggctttggaatgagttccaatttgtgatgttaatacaggcttcttgttttaggaagcatcacctatactctgaagcctttaaactctgaagagaattgtttcagagttattccaagcacttgtgcaacttggaaaaacagacttgggttgtgggaacagttgacagcgttctgaaaagatgccatttgtttccttctgatctctcactgaataatgtttactgtacagtcttcccaaggtgattcctgcgactgcaggcactggtcattttctcatgtagctgtcttttcagttatggtaaactcttaaagttcagaacactcaacagattccttcagtgatatacttgttcgttcatttctaaaatgtgaagctttaggaccaaattgttagaaagcatcaggatgaccagttatctcgagtagattttcttggatttcagaacatctagcatgactctgaaggataccacatgttttatatataaataattactgtttatgatatagacattgatattgactatttagagaaccgttgttaattttaaaactagcaatctataaagtgcaccaggtcaacttgaataaaaacactatgacagacaggtttgccagtttgcagaaactaactcttttctcacatcaacatttgtaaaattgatgtgttatagtggaaaataacatatagattaaacaaaatttttatcttttttcaagaatatagctggctatctttaagaaagatgatatatcctagttttgaaagtaattttcttttttctttctagcatttgatgtctaaataattttggacatctttttcctagaccatgtttctgtcttactcttaaacctggtaacacttgatttgccttctataacctatttatttcaagtgttcatatttgaatttctttgggaagaaagtaaatctgatggctcactgatttttgaaaagcctgaataaaattggaaagactggaaagttaggagaactgactagctaaactgctacagtatgcaatttctattacaattggtattacaggggggaaaagtaaaattacactttacctgaaagtgacttcttacagctagtgcattgtgctctttccaagttcagcagcagttctatcagtggtgccactgaaactgggtatatttatgatttctttcagcgttaaaaagaaacatagtgttgccctttttcttaaagcatcagtgaaattatggaaaattacttaaaacgtgaatacatcatcacagtagaatttattatgagagcatgtagtatgtatctgtagccctaacacatgggatgaacgttttactgctacacccagatttgtgttgaacgaaaacattgtggtttggaaaggagaattcaacaattaatagttgaaattgtgaggttaatgtttaaaaagctttacacctgtttacaatttggggacaaaaaggcaggcttcatttttcatatgtttgatgaaaactggctcaagatgtttgtaaatagaatcaagagcaaaactgcacaaacttgcacattggaaagtgcaacaagttcccgtgattgcagtaaaaatatttactattctaaaaaaatgagaattgaagacttagccagtcagataagttttttcatgaacccgttgtggaaattattggaattaactgagccaaagtgattatgcattcttcatctattttagttagcactttgtatcgttatatacagtttacaatacatgtataacttgtagctataaacattttgtgccattaaagctctcacaaaactttaaaaa

SEQ ID NO: 4 - DNA, 1441 bp, Homo sapiens
  mRNA (1)...(1441): beta tubulin mRNA
caggctggtcaatgtggcaaccagatcggtgccaagttctgggaggtgatcagtgatgaacatggcatcgaccccaccggcacctaccacggggacagcgacctgcagctggaccgcatctctgtgtactacaatgaagccacaggtggcaaatatgttcctcgtgccatcctggtggatctagaacctgggaccatggactctgttcgctcaggtccttttggccagatctttagaccagacaactttgtatttggtcagtctggggcaggtaacaactgggccaaaggccactacacagagggcgccgagctggttgattctgtcctggatgtggtacggaaggaggcagagagctgtgactgcctgcagggcttccagctgacccactcactgggcgggggcacaggctctggaatgggcactctccttatcagcaagatccgagaagaataccctgatcgcatcatgaataccttcagtgtggtgccttcacccaaagtgtctgacaccgtggtcgagccctacaatgccaccctctccgtccatcagttggtagagaatactgatgagacctattgcattgacaacgaggccctctatgatatctgcttccgcactctgaggctgaccacaccaacctacggggatctgaaccaccttgtctcaggcaccatggagtgtgtcaccacctgcctccgtttccctggccagctcaatgctgacctccgcaagttggcagtcaacatggtccccttcccacgtctccatttctttatgcctggctttgcccctctcaccagccgtggaagccagcagtatcgagctctcacagtgccggacctcacccagcaggtcttcgatgccaagaacatgatggctgcctgtgacccccgccacggccgatacctcaccgtggctgctgtcttccgtggtcggatgtccatgaaggaggtcgatgagcagatgcttaacgtgcagaacaagaacagcagctactttgtggaatggatccccaacaatgtcaagacagccgtctgtgacatcccacctcgtggcctcaagatggcagtcaccttcattggcaatagcacagccatccaggagctcttcaagcgcatctcggagcagttcactgccatgttccgccggaaggccttcctccactggtacacaggcgagggcatggacgagatggagttcaccgaggctgagagcaacatgaacgacctcgtctctgagtatcagcagtaccaggatgccaccgcagaagaggaggaggatttcggtgaggaggccgaagaggaggcctaaggagagcccccatcacctcaggcttctcagttcccttagccgtcttactcaactgccccctttcctctccctcagaatttgtgtttgctgcctctatcttgttttttgttttttcttctgggggggg

SEQ ID NO: 5 - DNA, 1673 bp, Homo sapiens
  mRNA (1)...(1673): Human erythrocyte 2,3-bisphosphoglycerate mutase (BPGM) mRNA
ggaggagcggctgctgctgctgctgctgctgctggtggcccctttgcagatgtattgctgtccttgaatattagcccatttgaaaacgcctgggaagttcagccatcagtatgtccaagtacaaacttattatgttaagacatggagagggtgcttggaataaggagaaccgtttttgtagctgggtggatcagaaactcaacagcgaaggaatggaggaagctcggaactgtgggaagcaactcaaagcgttaaactttgagtttgatcttgtattcacatctgtccttaatcggtccattcacacagcctggctgatcctggaagagctaggccaggaatgggtgcctgtggaaagctcctggcgtctaaatgagcgtcactatggggccttgatcggtctcaacagggagcagatggctttgaatcatggtgaagaacaagtgaggctctggagaagaagctacaatgtaaccccgcctcccattgaggagtctcatccttactaccaagaaatctacaacgaccggaggtataaagtatgcgatgtgcccttggatcaactgccacggtcggaaagcttaaaggatgttctggagagactccttccctattggaatgaaaggattgctcccgaagtattacgtggcaaaaccattctgatatctgctcatggaaatagcagtagggcactcctaaaacacctggaaggtatctcagatgaagacatcatcaacattactcttcctactggagtccccattcttctggaattggatgaaaacctgcgtgctgttgggcctcatcagttcctgggtgaccaagaggcgatccaagcagccattaagaaagtagaagatcaaggaaaagtgaaacaagctaaaaaatagtctttctcaactgttggctaagaagaaatgcaaaagaagtggcataggagtgtgttatgggtgctgaactctctctctttttccccgattttccagagctaggctgtggagtagagtttgtataggtaactaggtaacttattgtggcccagataaggctttaggatgcctcagtgcttatgtcatagccttatgagttagctttcttgctagccccctagtcggtcaccaaactagtaactagtggggcttaatgaaggtcataagtttctgagatgggagagcaacaagtagagatgaagttaaaggtatttatcattcaagaaatcattattgagtcaccaattgacaggcactattctaatcagtagttcactttaatatttaataagattttctgggataacagtaagggatattagataatataccgtatgtatttattactagtcttttcctctaggaaaagggatactttgataattaaggccagaggcccattagttgagaaagtcacagatatatttctccaagaaagccaacaaccaccaccacaatgacagaaatgacaacaaggccctttaacttgtcttctagtttagagacatccttcatttgacatttagtagaattcctctttggccacaagaataagcagcaaataaacaactatggctgttgaggttctcattttggtttgttttaattttttgaactttgggtacctgtaattagtttaaaaataaagttcctgataataaagtgactgaaaatggcatcccc

SEQ ID NO: 6 - DNA, 1941 bp, Homo sapiens
  mRNA (1)...(1941): Human aminolevulinate, delta-, synthase 2 (ALAS2) mRNA
cacctgtcattcgttcgtcctcagtgcagggcaacaggactttaggttcaagatggtgactgcagccatgctgctacagtgctgcccagtgcttgcccggggccccacaagcctcctaggcaaggtggttaagactcaccagttcctgtttggtattggacgctgtcccatcctggctacccaaggaccaaactgttctcaaatccaccttaaggcaacaaaggctggaggagattctccatcttgggcgaagggccactgtcccttcatgctgtcggaactccaggatgggaagagcaagattgtgcagaaggcagccccagaagtccaggaagatgtgaaggctttcaagacagatctgcctagctccctggtctcagtcagcctaaggaagccattttccggtccccaggagcaggagcagatctctgggaaggtcacacacctgattcagaacaatatgcctggaaactatgtcttcagttatgaccagtttttcagggacaagatcatggagaagaaacaggatcacacctaccgtgtgttcaagactgtgaaccgctgggctgatgcatatccctttgcccaacatttctctgaggcatctgtggcctcaaaggatgtgtccgtctggtgtagtaatgattacctgggcatgagccgacaccctcaggtcttgcaagccacacaggagaccctgcagcgtcatggtgctggagctggtggcacccgcaacatctcaggcaccagtaagtttcatgtggagcttgagcaggagctggctgagctgcaccagaaggactcagccctgctcttctcctcctgctttgttgccaatgactctactctcttcaccttggccaagatcctgccagggtgcgagatttactcagacgcaggcaaccatgcttccatgatccaaggtatccgtaacagtggagcagccaagtttgtcttcaggcacaatgaccctgaccacctaaagaaacttctagagaagtctaaccctaagatacccaaaattgtggcctttgagactgtccactccatggatggtgccatctgtcccctcgaggagttgtgtgatgtgtcccaccagtatggggccctgaccttcgtggatgaggtccatgctgtaggactgtatgggtcccggggcgctgggattggggagcgtgatggaattatgcataagattgacatcatctctggaactcttggcaaggcctttggctgtgtgggcggctacattgccagcacccgtgacttggtggacatggtgcgctcctatgctgcaggcttcatctttaccacttctctgccccccatggtgctctctggagctctagaatctgtgcggctgctcaagggagaggagggccaagccctgaggcgagcccaccagcgcaatgtcaagcacatgcgccagctactcatggacaggggccttcctgtcatcccctgccccagccacatcatccccatccgggtgggcaatgcagcactcaacagcaagctctgtgatctcctgctctccaagcatggcatctatgtgcaggccatcaactacccaactgtcccccggggtgaagagctcctgcgcttggcaccctccccccaccacagccctcagatgatggaagattttgtggagaagctgctgctggcttggactgcggtggggctgcccctccaggatgtgtctgtggctgcctgcaatttctgtcgccgtcctgtacactttgagctcatgagtgagtgggaacgttcctacttcgggaacatggggccccagtatgtcaccacctatgcctgagaagccagctgcctaggattcacaccccacctgcgcttcacttgggtccaggcctactcctgtcttctgctttgttgtgtgcctctagctgaattgagcctaaaaataaagcacaaaccacagca

SEQ ID NO: 7 - DNA, 1721 bp, Homo sapiens
  mRNA (1)...(1721): Human selenium binding protein 1 (SELENBP1) mRNA
caccagcacagcaaacccgccgggatcaaagtgtaccagtcggcagcatggctacgaaatgtgggaattgtggacccggctactccacccctctggaggccatgaaaggacccagggaagagatcgtctacctgccctgcatttaccgaaacacaggcactgaggccccagattatctggccactgtggatgttgaccccaagtctccccagtattgccaggtcatccaccggctgcccatgcccaacctgaaggacgagctgcatcactcaggatggaacacctgcagcagctgcttcggtgatagcaccaagtcgcgcaccaagctggtgctgcccagtctcatctcctctcgcatctatgtggtggacgtgggctctgagccccgggccccaaagctgcacaaggtcattgagcccaaggacatccatgccaagtgcgaactggcctttctccacaccagccactgcctggccagcggggaagtgatgatcagctccctgggagacgtcaagggcaatggcaaagggggttttgtgctgctggatggggagacgttcgaggtgaaggggacatgggagagacctgggggtgctgcaccgttgggctatgacttctggtaccagcctcgacacaatgtcatgatcagcactgagtgggcagctcccaatgtcttacgagatggcttcaaccccgctgatgtggaggctggactgtacgggagccacttatatgtatgggactggcagcgccatgagattgtgcagaccctgtctctaaaagatgggcttattcccttggagatccgcttcctgcacaacccagacgctgcccaaggctttgtgggctgcgcactcagctccaccatccagcgcttctacaagaacgagggaggtacatggtcagtggagaaggtgatccaggtgccccccaagaaagtgaagggctggctgctgcccgaaatgccaggcctgatcaccgacatcctgctctccctggacgaccgcttcctctacttcagcaactggctgcatggggacctgaggcagtatgacatctctgacccacagagaccccgcctcacaggacagctcttcctcggaggcagcattgttaagggaggccctgtgcaagtgctggaggacgaggaactaaagtcccagccagagcccctagtggtcaagggaaaacgggtggctggaggccctcagatgatccagctcagcctggatgggaagcgcctctacatcaccacgtcgctgtacagtgcctgggacaagcagttttaccctgatctcatcagggaaggctctgtgatgctgcaggttgatgtagacacagtaaaaggagggctgaagttgaaccccaacttcctggtggacttcgggaaggagccccttggcccagcccttgcccatgagctccgctaccctgggggcgattgtagctctgacatctggatttgaactccaccctcatcacccacactccctattttgggccctcacttccttggggacctggcttcattctgctctctcttggcacccgacccttggcagcatgtaccacacagccaagctgagactgtggcaatgtgttgagtcatatacatttactgaccactgttgcttgttgctcactgtgctgcttttccatgagctcttggaggcaccaagaaataaactcgtaaccctgtccttcaaaaaaaaaaaaaaaaa

SEQ ID NO: 8 - DNA, 3637 bp, Homo sapiens
  mRNA (1)...(3637): Human solute carrier family 4, anion exchanger, member 1 (erythrocyte membrane protein band 3, Diego blood group) (SLC4A1) mRNA
cagcggctgcaggacttcaccaagggaccctgaggctcgtgagcagggacccgcggtgcgggttatgctgggggctcagatcaccgtagacaactggacactcaggaccacgccatggaggagctgcaggatgattatgaagacatgatggaggagaatctggagcaggaggaatatgaagacccagacatccccgagtcccagatggaggagccggcagctcacgacaccgaggcaacagccacagactaccacaccacatcacacccgggtacccacaaggtctatgtggagctgcaggagctggtgatggacgaaaagaaccaggagctgagatggatggaggcggcgcgctgggtgcaactggaggagaacctgggggagaatggggcctggggccgcccgcacctctctcacctcaccttctggagcctcctagagctgcgtagagtcttcaccaagggtactgttctcctagacctgcaagagacctccctggctggagtggccaaccaactgctagacaggtttatctttgaagaccagatccggcctcaggaccgagaggagctgctccgggccctgctgcttaaacacagccacgctggagagctggaggccctggggggtgtgaagcctgcagtcctgacacgctctggggatccttcacagcctctgctcccccaacactcctcactggagacacagctcttctgtgagcagggagatgggggcacagaagggcactcaccatctggaattctggaaaagattcccccggattcagaggccacgttggtgctagtgggccgcgccgacttcctggagcagccggtgctgggcttcgtgaggctgcaggaggcagcggagctggaggcggtggagctgccggtgcctatacgcttcctctttgtgttgctgggacctgaggccccccacatcgattacacccagcttggccgggctgctgccaccctcatgtcagagagggtgttccgcatagatgcctacatggctcagagccgaggggagctgctgcactccctagagggcttcctggactgcagcctagtgctgcctcccaccgatgccccctccgagcaggcactgctcagtctggtgcctgtgcagagggagctacttcgaaggcgctatcagtccagccctgccaagccagactccagcttctacaagggcctagacttaaatgggggcccagatgaccctctgcagcagacaggccagctcttcgggggcctggtgcgtgatatccggcgccgctacccctattacctgagtgacatcacagatgcattcagcccccaggtcctggctgccgtcatcttcatctactttgctgcactgtcacccgccatcaccttcggcggcctcctgggagaaaagacccggaaccagatgggagtgtcggagctgctgatctccactgcagtgcagggcattctcttcgccctgctgggggctcagcccctgcttgtggtcggcttctcaggacccctgctggtgtttgaggaagccttcttctcgttctgcgagaccaacggtctagagtacatcgtgggccgcgtgtggatcggcttctggctcatcctgctggtggtgttggtggtggccttcgagggtagcttcctggtccgcttcatctcccgctatacccaggagatcttctccttcctcatttccctcatcttcatctatgagactttctccaagctgatcaagatcttccaggaccacccactacagaagacttataactacaacgtgttgatggtgcccaaacctcagggccccctgcccaacacagccctcctctcccttgtgctcatggccggtaccttcttctttgccatgatgctgcgcaagttcaagaacagctcctatttccctggcaagctgcgtcgggtcatcggggacttcggggtccccatctccatcctgatcatggtcctggtggatttcttcattcaggatacctacacccagaaactctcggtgcctgatggcttcaaggtgtccaactcctcagcccggggctgggtcatccacccactgggcttgcgttccgagtttcccatctggatgatgtttgcctccgccctgcctgctctgctggtcttcatcctcatattcctggagtctcagatcaccacgctgattgtcagcaaacctgagcgcaagatggtcaagggctccggcttccacctggacctgctgctggtagtaggcatgggtggggtggccgccctctttgggatgccctggctcagtgccaccaccgtgcgttccgtcacccatgccaacgccctcactgtcatgggcaaagccagcaccccaggggctgcagcccagatccaggaggtcaaagagcagcggatcagtggactcctggtcgctgtgcttgtgggcctgtccatcctcatggagcccatcctgtcccgcatccccctggctgtactgtttggcatcttcctctacatgggggtcacgtcgctcagcggcatccagctctttgaccgcatcttgcttctgttcaagccacccaagtatcacccagatgtgccctacgtcaagcgggtgaagacctggcgcatgcacttattcacgggcatccagatcatctgcctggcagtgctgtgggtggtgaagtccacgccggcctccctggccctgcccttcgtcctcatcctcactgtgccgctgcggcgcgtcctgctgccgctcatcttcaggaacgtggagcttcagtgtctggatgctgatgatgccaaggcaacctttgatgaggaggaaggtcgggatgaatacgacgaagtggccatgcctgtgtgaggggcgggcccaggccctagaccctcccccaccattccacatccccaccttccaaggaaaagcagaagttcatgggcacctcatggactcaggatcctcctggagcagcagctgaggccccagggctgtgggtggggaaggaaggcgtgtccaggagaccttccacaaagggtagcctggcttttctggctggggatggccgatggggcccacattagggggtttgttgcacagtccctcctgttgccacactttcactggggatcccgtgctggaagacttagatctgagccctccctcttcccagcacaggcaggggtagaagcaaaggcaggaggtgggtgagcgggtggggtgcttgctgtgtgaccttgggtaagtcccttgacctttccaggcctatatttcctcttctgtaaaatgggtatattgatgataatacccacattacaggatggttactgaggaccaaagatacatgtaaaatagggctttgtaaactccacagggactgttctatagcagtcatcatttgtctttgaacgtacccaaggtcacatagctgggatttgaactgagccgtgcagctgggatttgaaccaggccttctgatttcaaggtccgagctctgtcctctgtcagtcatgcgtccactttcccttcccctgtgactcctcccttccccactctgctcccagcccctaccttgagaccctcttctctgggcccagagagaggcgtcctgggtgaaggaaggtacaggcaggatgatccagggattgggctg

SEQ ID NO: 9 - DNA, 847 bp, Homo sapiens
  mRNA (1)...(847): Human surfeit 2 (SURF2) mRNA
gcgagcggcttccgccgggctgctccgcgggcgcgtcggccatgagcgagttgccgggcgacgtgcgggcgtttctgcgggagcacccgagcctgcggctccagacggacgcccgcaaggtgaggtgcatcctgacaggtcacgagctgccctgccgcctgccggagctccaggtctacacccgcggcaaaaagtaccagcggctggtccgcgcctccccggccttcgactatgcagagttcgagccgcacatcgtgcccagcaccaagaacccgcaccagttgttctgcaaactcaccctgcggcacatcaacaagtgcccagaacacgtgctgaggcacacccagggccggcggtaccagcgagctctgtgtaaatatgaagaatgtcagaagcaaggggtggagtacgtgcctgcctgcctggtgcaccggaggaggaggagggaggaccagatggacggtgacgggcctcgcccgcgggaagccttctgggagcccacatccagtgatgaggggggagctgcaagtgatgacagcatgacagacctgtacccacctgagctattcaccagaaaggaccttggaagcacggaggatggggatggcactgatgactttttgacagacaaagaggatgagaaggcaaagcccccaagagagaaggccactgatgagggcaggagagagacgaccgtgtaccgagggctggtccagaagcgcgggaagaagcagttgggctcgttgaaaaagaagttcaagagtcatcaccgcaaacccaagagcttcagctcctgtaaacagccaggttaataaaagcacatgccgtgaaaaaaaaaaaaaaaaaa

SEQ ID NO: 10 - DNA, 2121 bp, Homo sapiens
  mRNA (1)...(2121): Human transmembrane 9 superfamily member 1 (TM9SF1) mRNA
gttccactgccttaaggatgacagtcgtagggaaccctcgaagttggagctgccagtggttgccaatcctgatactgttgctgggcacaggccatgggccaggggtggaaggcgtgacacactacaaggccggcgaccctgttattctgtatgtcaacaaagtgggaccctaccataaccctcaggaaacttaccactactatcagcttccagtctgctgccctgagaagatacgtcacaaaagccttagcctgggtgaagtgctggatggggaccgaatggctgagtctttgtatgagatccgctttcgggaaaacgtggagaagagaattctgtgccacatgcagctcagttctgcacaggtggagcagctgcgccaggccattgaagaactgtactactttgaatttgtggtagatgacttgccaatccggggctttgtgggctacatggaggagagtggtttcctgccacacagccacaagataggactctggacccatttggacttccacctagaattccatggagaccgaattatatttgccaatgtttcagtgcgggacgtcaagccccacagcttggatgggttacgacctgacgagttcctaggccttacccacacttatagcgtgcgctggtctgagacttcagtggagcgtcggagtgacaggcgccgtggtgacgatggtggtttctttcctcgaacactggaaatccattggttgtccatcatcaactccatggtgcttgtgtttttactggtgggttttgtggctgtcattctaatgcgtgtgcttcggaatgacctggctcggtacaacttagatgaggagaccacctctgcaggttctggtgatgactttgaccagggtgacaatggctggaaaattatccatacagatgtcttccgcttccccccataccgtggtctgctctgtgctgtgcttggcgtgggtgcccagttcctggcccttggcactggcattattgtcatggcactgctgggcatgttcaatgtgcaccgtcatggggccattaactcagcagccatcttgttgtatgccctgacctgctgcatctctggctacgtgtccagccacttctaccggcagattggaggcgagcgttgggtgtggaacatcattctcaccaccagtctcttctctgtgcctttcttcctgacgtggagtgtggtgaactcagtgcattgggccaatggttcgacacaggctctgccagccacaaccatcctgctgcttctgacggtttggctgctggtgggctttcccctcactgtcattggaggcatctttgggaagaacaacgccagcccctttgatgcaccctgtcgcaccaagaacatcgcccgggagattccaccccagccctggtacaagtctactgtcatccacatgactgttggaggcttcctgcctttcagtgccatctctgtggagctgtactacatctttgccacagtatggggtcgggagcagtacactttgtacggcatcctcttctttgtcttcgccatcctgctgagtgtgggggcttgcatctccattgcactcacctacttccagttgtctggggaggattaccgctggtggtggcgatctgtgctgagtgttggctccaccggcctcttcatcttcctctactcagttttctattatgcccggcgctccaacatgtctggggcagtacagacagtagagttcttcggctactccttactcactggttatgtcttcttcctcatgctgggcaccatctcctttttttcttccctaaagttcatccggtatatctatgttaacctcaagatggactgagttctgtatggcagaactattgctgttctctccctttcttcatgccctgttgaactctcctaccagcttctcttctgattgactgaattgtgtgatggcattgttgccttcccttttgccctttgggcattccttccccagagagggcctggaaattataaatctctatcacataaggattatatatttgaactttttaagttgcctttagttttggtcctgatttttctttttacaattaccaaaataaaatttattaagaaaaagaaaaaaaaaaaaaaaa

SEQ ID NO: 11 - DNA, 5910 bp, Homo sapiens
  mRNA (1)...(5910): Human death-associated protein kinase 1 (DAPK1) mRNA
cggaggacagccggaccgagccaacgccggggactttgttccctccacggaggggactcggcaactcgcagcggcagggtctggggccggcgcctgggagggatctgcgccccccactcactccctagctgtgttcccgccgccgccccggctagtctccggcgctggcgcctatggtcggcctccgacagcgctccggagggaccgggggagctcccaggcgcccgggactggagactgatgcatgaggggcctacggaggcgcaggagcggtggtgatggtctgggaagcggagctgaagtcccctgggctttggtgaggcgtgacagtttatcatgaccgtgttcaggcaggaaaacgtggatgattactacgacaccggcgaggaacttggcagtggacagtttgcggttgtgaagaaatgccgtgagaaaagtaccggcctccagtatgccgccaaattcatcaagaaaaggaggactaagtccagccggcggggtgtgagccgcgaggacatcgagcgggaggtcagcatcctgaaggagatccagcaccccaatgtcatcaccctgcacgaggtctatgagaacaagacggacgtcatcctgatcttggaactcgttgcaggtggcgagctgtttgacttcttagctgaaaaggaatctttaactgaagaggaagcaactgaatttctcaaacaaattcttaatggtgtttactacctgcactcccttcaaatcgcccactttgatcttaagcctgagaacataatgcttttggatagaaatgtccccaaacctcggatcaagatcattgactttgggttggcccataaaattgactttggaaatgaatttaaaaacatatttgggactccagagtttgtcgctcctgagatagtcaactatgaacctcttggtcttgaggcagatatgtggagtatcggggtaataacctatatcctcctaagtggggcctccccatttcttggagacactaagcaagaaacgttagcaaatgtatccgctgtcaactacgaatttgaggatgaatacttcagtaataccagtgccctagccaaagatttcataagaagacttctggtcaaggatccaaagaagagaatgacaattcaagatagtttgcagcatccctggatcaagcctaaagatacacaacaggcacttagtagaaaagcatcagcagtaaacatggagaaattcaagaagtttgcagcccggaaaaaatggaaacaatccgttcgcttgatatcactgtgccaaagattatccaggtcattcctgtccagaagtaacatgagtgttgccagaagcgatgatactctggatgaggaagactcctttgtgatgaaagccatcatccatgccatcaacgatgacaatgtcccaggcctgcagcaccttctgggctcattatccaactatgatgttaaccaacccaacaagcacgggacacctccattactcattgctgctggctgtgggaatattcaaatactacagttgctcattaaaagaggctcgagaatcgatgtccaggataagggcgggtccaatgccgtctactgggctgctcggcatggccacgtcgataccttgaaatttctcagtgagaacaaatgccctttggatgtgaaagacaagtctggagagatggccctccacgtggcagctcgctatggccatgctgacgtggctcaagttacttgtgcagcttcggctcaaatcccaatatccaggacaaaggaagaagaaacccccctgcactgtgctgcttggcacggctattactctgtggccaaagccctttgtgaagccggctgtaacgtgaacatcaagaaccgagaaggagagacgcccctcctgacagcctctgccaggggctaccacgacatcgtggagtgtctggccgaacatggagccgaccttaatgcttgcgacaaggacggacacattgcccttcatctggctgtaagacggtgtcagatggaggtaatcaagactctcctcagccaagggtgtttcgtcgattatcaagacaggcacggcaatactcccctccatgtggcatgtaaagatggcaacatgcctatcgtggtggccctctgtgaagcaaactgcaatttggacatctccaacaagtatgggcgaacgcctctgcaccttgcggccaacaacggaatcctagacgtggtccggtatctctgtctgatgggagccagcgttgaggcgctgaccacggacggaaagacggcagaagatcttgctagatcggaacagcacgagcacgtagcaggtctccttgcaagacttcgaaaggatacgcaccgaggactcttcatccagcagctccgacccacacagaacctgcagccaagaattaagctcaagctgtttggccactcgggatccgggaaaaccacccttgtagaatctctcaagtgtgggctgctgaggagctttttcagaaggcgtcggcccagactgtcttccaccaactccagcaggttcccaccttcacccctggcttctaagcccacagtctcagtgagcatcaacaacctgtacccaggctgcgagaacgtgagtgtgaggagccgcagcatgatgttcgagccgggtcttaccaaagggatgctggaggtgtttgtggccccgacccaccacccgcactgctcggccgatgaccagtccaccaaggccatcgacatccagaacgcttatttgaatggagttggcgatttcagcgtgtgggagttctctggaaatcctgtgtatttctgctgttatgactattttgctgcaaatgatcccacgtcaatccatgttgttgtctttagtctagaagagccctatgagatccagctgaacccagtgattttctggctcagtttcctgaagtcccttgtcccagttgaagaacccatagccttcggtggcaagctgaagaacccactccaagttgtcctggtggccacccacgctgacatcatgaatgttcctcgaccggctggaggcgagtttggatatgacaaagacacatcgttgctgaaagagattaggaacaggtttggaaatgatcttcacatttcaaataagctgtttgttctggatgctggggcttctgggtcaaaggacatgaaggtacttcgaaatcatctgcaagaaatacgaagccagattgtttcggtctgtcctcccatgactcacctgtgtgagaaaatcatctccacgctgccttcctggaggaagctcaatggacccaaccagctgatgtcgctgcagcagtttgtgtacgacgtgcaggaccagctgaaccccctggccagcgaggaggacctcaggcgcattgctcagcagctccacagcacaggcgagatcaacatcatgcaaagtgaaacagttcaggacgtgctgctcctggacccccgctggctctgcacaaacgtcctggggaagttgctgtccgtggagaccccacgggcgctgcaccactaccggggccgctacaccgtggaggacatccagcgcctggtgcccgacagcgacgtggaggagctgctgcagatcctcgatgccatggacatctgcgcccgggacctgagcagcgggaccatggtggacgtcccagccctgatcaagacagacaacctgcaccgctcctgggctgatgaggaggacgaggtgatggtgtatggtggcgtgcgcatcgtgcccgtggaacacctcacccccttcccatgtggcatctttcacaaggtccaggtgaacctgtgccggtggatccaccagcaaagcacagagggcgacgcggacatccgcctgtgggtgaatggctgcaagctggccaaccgtggggccgagctgctggtgctgctggtcaaccacggccagggcattgaggtccaggtccgtggcctggagacggagaagatcaagtgctgcctgctgctggactcggtgtgcagcaccattgagaacgtcatggccaccacgctgccagggctcctgaccgtgaagcattacctgagcccccagcagctgcgggagcaccatgagcccgtcatgatctaccagccacgggacttcttccgggcacagactctgaaggaaacctcactgaccaacaccatgggggggtacaaggaaagcttcagcagcatcatgtgcttcgggtgtcacgacgtctactcacaggccagcctcggcatggacatccatgcatcagacctgaacctcctcactcggaggaaactgagtcgcctgctggacccgcccgaccccctggggaaggactggtgccttctcgccatgaacttaggcctccctgacctcgtggcaaagtacaacaccaataacggggctcccaaggatttcctccccagccccctccacgccctgctgcgggaatggaccacctaccctgagagcacagtgggcaccctcatgtccaaactgagggagctgggtcgccgggatgccgcagaccttttgctgaaggcatcctctgtgttcaaaatcaacctggatggcaatggccaggaggcctatgcctcgagctgcaacagcggcacctcttacaattccattagctctgttgtatcccggtgagggcagcctctggcttggacagggtctgtttggactgcagaaccaagggggtgatgtagcccatccttccctttggagatgctgagggtgtttcttcctgcacccacagccagggggatgccactcctccctccggcttgacctgtttctctgccgctacctccctccccgtctcattccgttgtctgtggatggtcattgcagtttaagagcagaacagatcttttactttggccgcttgaaaagctagtgtacctcctctcagtgttttggactccatctctcatcctccagtaccttgcttcttactgataattttgctggaattcctaacttttcaatgacattttttttaactatcatattgattgtcctttaaaaaagaaaagtgcatatttatccaaaatgtgtatttcttatacgcttttctgtgttataccatttcctcagcttatctcttttatatttgtaggagaaactcccatgtatggaatcccactgtatgatttataaacagacaatatgtgagtgccttttgcagaagagggtgtgtttgaaatcatcggagtcagccaggagctgtcaccaaggaaacgctacctctctgtcccttgctgtatgctgatcatcgccagaggtgcttcaccctgagttttgttttgtattgttttctgacagtttttctgttttgtttggcaaggaaaggggagaagggaatcctcctccagggtgattttatgatcagtgttgttgctctaggaagacatttttccgtttgcttttgttccaatgtcaatgtgaacgtccacatgaaacctacacactgtcatgcttcatcattccctctcatctcaggtagaaggttgacacagttgtagggttacagagacctatgtaagaattcagaagacccctgactcatcatttgtggcagtcccttataattggtgcatagcagatggtttccacatttagatcctggtttcataacttcctgtacttgaagtctaaaagcagaaaataaaggaagcaagttttcttccatgattttaaattgtgatcgagttttaaattgataggagggaacatgtcctaattcttctgtcctgagaagcatgtaatgttaatgttatatcatatgtatatatatatatgcactatgtatatacatatatattaatactggtatttttacttaatctataaaatgtcgttaaaaagttgtttgtttttttctttttttataaataaactgttgctcgttaaaaaaaaaaaaaa

SEQ ID NO: 12 - DNA, 1579 bp, Homo sapiens
  mRNA (1)...(1579): Human RAP1A, member of RAS oncogene family (RAP1A) mRNA
atccttcgcgtactgacggaaacactggcggcacatattgaggccgtatttcaggatcagctgccggttcgaacacacgcgagaagagcaaagaagttaaaagagaagtgtctgtgtggctccttccacgtgggtgaaggactgtgccagctgagaggtggtagagcaggaagctgcctgagacctccatttatttggtgaaaaaccgccgcccttaagagagcaagtcgagggccgtgtaggagttggaggagagaaatgaaattttggaagagtcagcagaagatcgtcagtatttaaacacatcacatcatgcgtgagtacaagctagtggtccttggttcaggaggcgttgggaagtctgctctgacagttcagtttgttcagggaatttttgttgaaaaatatgacccaacgatagaagattcctacagaaagcaagttgaagtcgattgccaacagtgtatgctcgaaatcctggatactgcagggacagagcaatttacagcaatgagggatttgtatatgaagaacggccaaggttttgcactagtatattctattacagctcagtccacgtttaacgacttacaggacctgagggaacagattttacgggttaaggacacggaagatgttccaatgattttggttggcaataaatgtgacctggaagatgagcgagtagttggcaaagagcagggccagaatttagcaagacagtggtgtaactgtgcctttttagaatcttctgcaaagtcaaagatcaatgttaatgagatattttatgacctggtcagacagataaataggaaaacaccagtggaaaagaagaagcctaaaaagaaatcatgtctgctgctctaggcccatagtcagcagcagctctgagccagattacaggaatgaagaactgttgcctaattggaaagtgccagcattccagacttcaaaaataaaaaatctgaagaggcttctcctgttttatatattatgtgaagaatttagatcttatattggtttgcacaagttccctggagaaaaaaattgctctgtgtatatctcttggaaaataagacaatagtatttctcctttgcaatagcagttataacagatgtgaaaatatacttgactctaatatgattatacaaaagagcatggatgcatttcaaatgttagatattgctactataatcaaatgatttcatattgatctttttatcatgatcctacctatcaagcactaaaaagttgaaccattatactttatatctgtaatgatactgattatgaaatgtcccctgaaactcattgcagcagataacttttttgagtcattgacttcattttatatttaaaaaattatggaatatcatctgtcattatattctaattaaaattgtgcataatgctttggaaaaatgggtcttttataggaaaaaaactgggataactgatttctatggctttcaaagctaaaatatataatatactaaaccaactctaatattgcttcttgtgttttactgtcagattaaattacagcttttatggatgattaaattttagtacattttc

SEQ ID NO: 13 - DNA, 3222 bp, Homo sapiens
  mRNA (1)...(3222): Human down-regulator of transcription 1, TBP-binding (negative cofactor 2) (DR1) mRNA
gagcggcttcctgcaaaccttccctggcatctggagggaccaccgttgccgcgtcttcggcttccacgatctgcgttcgggctacgcggccacggcggcagccactgcgactcccactgtgcctggctctgtccatattagttcccaggcggccgtcgccgttccagcagcggcagcggcagcggcagcggcggacatgttgtgaggcggcggcgcgggtgtctgaaggatggtttggccgaggcggcggcaacggctgctggcggcggcggcagcggcagcggggcctcgggctctatagagccgagcccgctgggtacccgcccggtaccgcggcgaggccagtgcccctggatcttgcctctgctccgacgccgttggggaccagttaggcgacagcgcccgcccctctgaggagacacgaaggtggttccccagccgctcaaatttccggaccaccgcgctttcccctcctcagcctgggctgtgctctctctagaatcctcgggcccccactttcttcccaaactcatcctaaatctctcacacacgcgagtgttcccagccctcaagccagctgctcctccgttcattttctgcaccctcttcgcaaagcaccccccgggatcactctccgagggcgactttttgagaaatctcggtggagtagtggaccagagctggggagtttttaaaagccggggcgcgagaaacaggaaggtactatggcttcctcgtctggcaacgatgatgatctcactatccccagagctgctatcaataaaatgatcaaagagactcttcctaatgtccgggtggccaacgatgctcgagagctggtggtgaactgctgcactgaattcattcaccttatatcttctgaagccaatgagatttgtaacaaatcggaaaagaagaccatctcaccagagcatgtcatacaagcactagaaagtttgggatttggctcttacatcagtgaagtaaaagaagtcttgcaagagtgtaaaacagtagcattaaaaagaagaaaggccagttctcgtttggaaaaccttggcattcctgaagaagagttattgagacagcaacaagaattatttgcaaaagctagacagcaacaagcagaattggcccaacaggaatggcttcaaatgcagcaagctgcccaacaagcccagcttgctgctgcctcagccagtgcatctaatcaggcgggatcttctcaggatgaagaagatgatgatgatatctgaaattcaccagctgagtttctatttcttctataaatgtttttccctgcacaacaaaaacagtgaaagaaatgcttatctgtaattttgtatgcatcttggtggacttgtcattggtattctagggatgtctgctattaagtttcatctattgtgtgctatacatgtaaaaactgtctctttgaactattgaaaatttaaggttcagtataatatcaattttgaatttttaatggtgtttatgaaattttagatagcagcgagtccttcgtttgatcaataaacagtgttacagataacttcaagtttataaaaatacagtgaaatttctacaaagctctaaatctgcatttgcatttcctctgcccttttaactaaactaaaacttgtgaattttaaattattaaggggggggtgctgtgtgaatcagtagacattggattgggttggtgaaagagttcagttctgtagtatctgaatttgtcttttaaaatgagtacatatataggcaataaatatatatgctcagatcaatatacttgtttagaaaaacttcaagacattcaaaaactaggaaggagtatgtttaatagtatttgtataaatttggtggttatgtttttttattttgtttctgttttgtgtagaggtaaaaactatagttttattacagcataattcattttgagctccactatgacatttcaaagactgcccagtttggaagtctgtcatgatttttactctttcactccaattcagtaattgttgatagtattacttacctagtccatccatactcatattattcaaatatataggtggtacttttgaaacaattacattggttctcttggtttaactgaggtttatgaatattcaaacctttgctgggggaaagaaatgaaagttaatgagcatgcttgctatgagagagggatttttaatttaacttgtagttatagtttacttattgtttttagaattacttttacattttcccaactagatggcctagagtccaacattaccttttgagatgacattattgtctccataattgagtgatagctttaaaaaaaagattagttttgcttaagaagttatgttacaactgatcagccctatatgaattaactgatcagccctatatgaaacataagttgtgttataacttatcagccgtatatggaacataaatagtttctacctgcttgttagagaagctttaatttggttctaataaatacagtatggtagtgtttataggaatccaggatgttgaagaaatggcataatgtctatattttggaaacagaaaggaaaagtcacttaagatagtattaagtaattaaattcctatgtcagttgccaaatcttttaaacttatgtattcaccaagcccaaaaatagattgtggctcccaggattccaattttaattggagagctaagtaagtaaagttttataactgttaggtttcttaatgatcatattttgcagttttagtaaaagggaaatattgttatacatttattaaatatacttcccccatgaagtgaaaaggttaattttgctgaatgttttaagttgaagttacttcatggatgtcatacccatgaagtgcatttggatgagatagaagaaattgttttttaaaaagtttaagtaccaaaggtagtctagtctagaacgataagttaatacgtgttggcttttctaatttgtactgtaacatccttatactttctattttaagtatatctgtttcttaagtaaacaacttagatattttccacacctttttttttttttctgatgcagagttcaggttaatattttactgcatctgataatgtattatacgtttgaagcctagtgacttttcattttgacattcttgtgatttcatatgctgtattcttcaagcaataaaattgtgatgtgttttataaaaaaaaaaaaaaaa

SEQ ID NO: 14 - DNA, 3541 bp, Homo sapiens
  mRNA (1)...(3541): Human Janus kinase 1 (JAK1) mRNA
tccagtttgcttcttggagaacactggacagctgaataaatgcagtatctaaatataaaagaggactgcaatgccatggctttctgtgctaaaatgaggagctccaagaagactgaggtgaacctggaggcccctgagccaggggtggaagtgatcttctatctgtcggacagggagcccctccggctgggcagtggagagtacacagcagaggaactgtgcatcagggctgcacaggcatgccgtatctctcctctttgtcacaacctctttgccctgtatgacgagaacaccaagctctggtatgctccaaatcgcaccatcaccgttgatgacaagatgtccctccggctccactaccggatgaggttctatttcaccaattggcatggaaccaacgacaatgagcagtcagtgtggcgtcattctccaaagaagcagaaaaatggctacgagaaaaaaaagattccagatgcaacccctctccttgatgccagctcactggagtatctgtttgctcagggacagtatgatttggtgaaatgcctggctcctattcgagaccccaagaccgagcaggatggacatgatattgagaacgagtgtctagggatggctgtcctggccatctcacactatgccatgatgaagaagatgcagttgccagaactgcccaaggacatcagctacaagcgatatattccagaaacattgaataagtccatcagacagaggaaccttctcaccaggatgcggataaataatgttttcaaggatttcctaaaggaatttaacaacaagaccatttgtgacagcagcgtgtccacgcatgacctgaaggtgaaatacttggctaccttggaaactttgacaaaacattacggtgctgaaatatttgagacttccatgttactgatttcatcagaaaatgagatgaattggtttcattcgaatgacggtggaaacgttctctactacgaagtgatggtgactgggaatcttggaatccagtggaggcataaaccaaatgttgtttctgttgaaaaggaaaaaaataaactgaagcggaaaaaactggaaaataaagacaagaaggatgaggagaaaaacaagatccgggaagagtggaacaatttttcattcttccctgaaatcactcacattgtaataaaggagtctgtggtcagcattaacaagcaggacaacaagaaaatggaactgaagctctcttcccacgaggaggccttgtcctttgtgtccctggtagatggctacttccggctcacagcagatgcccatcattacctctgcaccgacgtggcccccccgttgatcgtccacaacatacagaatggctgtcatggtccaatctgtacagaatacgccatcaataaattgcggcaagaaggaagcgaggaggggatgtacgtgctgaggtggagctgcaccgactttgacaacatcctcatgaccgtcacctgctttgagaagtctgagcaggtgcagggtgcccagaagcagttcaagaactttcagatcgaggtgcagaagggccgctacagtctgcacggttcggaccgcagcttccccagcttgggagacctcatgagccacctcaagaagcagatcctgcgcacggataacatcagcttcatgctaaaacgctgctgccagcccaagccccgagaaatctccaacctgctggtggctactaagaaagcccaggagtggcagcccgtctaccccatgagccagctgagtttcgatcggatcctcaagaaggatctggtgcagggcgagcaccttgggagaggcacgagaacacacatctattctgggaccctgatggattacaaggatgacgaaggaacttctgaagagaagaagataaaagtgatcctcaaagtcttagaccccagccacagggatatttccctggccttcttcgaggcagccagcatgatgagacaggtctcccacaaacacatcgtgtacctctatggcgtctgtgtccgcgacgtggagaatatcatggtggaagagtttgtggaagggggtcctctggatctcttcatgcaccggaaaagtgatgtccttaccacaccatggaaattcaaagttgccaaacagctggccagtgccctgagctacttggaggataaagacctggtccatggaaatgtgtgtactaaaaacctcctcctggcccgtgagggaatcgacagtgagtgtggcccattcatcaagctcagtgaccccggcatccccattacggtgctgtctaggcaagaatgcattgaacgaatcccatggattgctcctgagtgtgttgaggactccaagaacctgagtgtggctgctgacaagtggagctttggaaccacgctctgggaaatctgctacaatggcgagatccccttgaaagacaagacgctgattgagaaagagagattctatgaaagccggtgcaggccagtgacaccatcatgtaaggagctggctgacctcatgacccgctgcatgaactatgaccccaatcagaggcctttcttccgagccatcatgagagacattaataagcttgaagagcagaatccagatattgtttccagaaaaaaaaaccagccaactgaagtggaccccacacattttgagaagcgcttcctaaagaggatccgtgacttgggagagggccactttgggaaggttgagctctgcaggtatgaccccgaagacaatacaggggagcaggtggctgttaaatctctgaagcctgagagtggaggtaaccacatagctgatctgaaaaaggaaatcgagatcttaaggaacctctatcatgagaacattgtgaagtacaaaggaatctgcacagaagacggaggaaatggtattaagctcatcatggaatttctgccttcgggaagccttaaggaatatcttccaaagaataagaacaaaataaacctcaaacagcagctaaaatatgccgttcagatttgtaaggggatggactatttgggttctcggcaatacgttcaccgggacttggcagcaagaaatgtccttgttgagagtgaacaccaagtgaaaattggagacttcggtttaaccaaagcaattgaaaccgataaggagtattacaccgtcaaggatgaccgggacagccctgtgttttggtatgctccagaatgtttaatgcaatctaaattttatattgcctctgacgtctggtcttttggagtcactctgcatgagctgctgacttactgtgattcagattctagtcccatggctttgttcctgaaaatgataggcccaacccatggccagatgacagtcacaagacttgtgaatacgttaaaagaaggaaaacgcctgccgtgcccacctaactgtccagatgaggtttatcagcttatgagaaaatgctgggaattccaaccatccaatcggacaagctttcagaaccttattgaaggatttgaagcacttttaaaataagaagcatgaataacatttaaattccacagattatcaa

SEQ ID NO: 15 - DNA, 1596 bp, Homo sapiens
  mRNA (1)...(1596): Human tubulin, alpha, ubiquitous (K-ALPHA-1) mRNA
tgtcggggacggtaaccgggacccgtgctctgctcctgtcgccttcgcctcctgaatccctagccatatgcgtgagtgcatctccatccacgttggccaggctggtgtccagattggcaatgcctgctgggagctctactgcctggaacacggcatccagcccgatggccagatgccaagtgacaagaccattgggggaggagatgactccttcaacaccttcttcagtgagacgggcgctggcaagcacgtgccccgggctgtgtttgtagacttggaacccacagtcattgatgaagttcgcactggcacctaccgccagctcttccaccctgagcagctcatcacaggcaaggaagatgctgccaataactatgcccgagggcactacaccattggcaaggagatcattgaccttgtgttggaccgaattcgcaagctggctgaccagtgcacccgtcttcagggcttcttggttttccacagctttggtgggggaactggttctgggttcacctccctgctcatggaacgcctgtcagttgattatggcaagaaatccaagctggagttctccatttacccggcaccccaggtttccacagctgtagttgagccctacaactccatcctcaccacccacaccaccctggagcactctgattgtgccttcatggtagacaatgaggccatctatgacatctgtcgtagaaacctcgatatcgagcgcccaacctacactaaccttaaccgccttattagccagattgtgtcctccatcactgcttccctgagatttgatggagccctgaatgttgacctgacagaattccagaccaacctggtcccctacccccgcatccacttccctctggccacatatgcccctgtcatctctgctgagaaagcctaccatgaacagctttctgtagcagacatcaccaatgcttgctttgagccagccaaccagatggtgaaatgtgaccctggccatggtaaatacatggcttgctgcctgttgtaccgtggtgacgtggttcccaaagatgtcaatgctgccattgccaccatcaaaaccaagcgcacgatccagtttgtggattggtgccccactggcttcaaggttggcatcaactaccagcctcccactgtggtgcctggtggagacctggccaaggtacagagagctgtgtgcatgctgagcaacaccacagccattgctgaggcctgggctcgcctggaccacaagtttgacctgatgtatgccaagcgtgcctttgttcactggtacgtgggtgaggggatggaggaaggcgagttttcagaggcccgtgaagatatggctgcccttgagaaggattatgaggaggttggtgtggattctgttgaaggagagggtgaggaagaaggagaggaatactaattatccattccttttggccctgcagcatgtcatgctcccagaatttcagcttcagcttaactgacagatgttaaagctttctggttagattgttttcacttggtgatcatgtcttttccatgtgtacctgtaatatttttccatcatatctcaaagtaaagtcattaacatca

SEQ ID NO: 16 - DNA, 1746 bp, Homo sapiens
  mRNA (1)...(1746): Human zinc finger protein 36, C3H type, homolog (mouse) (ZFP36) mRNA
gagcctgacttcagcgctcccactctcggccgacacccctcatggccaaccgttacaccatggatctgactgccatctacgagagcctcctgtcgctgagccctgacgtgcccgtgccatccgaccatggagggactgagtccagcccaggctggggctcctcgggaccctggagcctgagcccctccgactccagcccgtctggggtcacctcccgcctgcctggccgctccaccagcctagtggagggccgcagctgtggctgggtgcccccaccccctggcttcgcaccgctggctccccgcctgggccctgagctgtcaccctcacccacttcgcccactgcaacctccaccaccccctcgcgctacaagactgagctatgtcggaccttctcagagagtgggcgctgccgctacggggccaagtgccagtttgcccatggcctgggcgagctgcgccaggccaatcgccaccccaaatacaagacggaactctgtcacaagttctacctccagggccgctgcccctacggctctcgctgccacttcatccacaaccctagcgaagacctggcggccccgggccaccctcctgtgcttcgccagagcatcagcttctccggcctgccctctggccgccggacctcaccaccaccaccaggcctggccggcccttccctgtcctccagctccttctcgccctccagctccccaccaccacctggggaccttccactgtcaccctctgccttctctgctgcccctggcacccccctggctcgaagagaccccaccccagtctgttgcccctcctgccgaagggccactcctatcagcgtctgggggcccttgggtggcctggttcggaccccctctgtacagtccctgggatccgaccctgatgaatatgccagcagcggcagcagcctggggggctctgactctcccgtcttcgaggcgggagtttttgcaccaccccagcccgtggcagccccccggcgactccccatcttcaatcgcatctctgtttctgagtgacaaagtgactgcccggtcagatcagctggatctcagcggggagccacgtctcttgcactgtggtctctgcatggaccccagggctgtggggacttgggggacagtaatcaagtaatccccttttccagaatgcattaacccactcccctgacctcacgctggggcaggtccccaagtgtgcaagctcagtattcatgatggtgggggatggagtgtcttccgaggttcttgggggaaaaaaaattgtagcatatttaagggaggcaatgaaccctctcccccacctcttccctgcccaaatctgtctcctagaatcttatgtgctgtgaataataggccttcactgcccctccagtttttatagacctgaggttccagtgtctcctggtaactggaacctctcctgagggggaatcctggtgctcaaattaccctccaaaagcaagtagccaaagccgttgccaaaccccacccataaatcaatgggccctttatttatgacgactttatttattctaatatgattttatagtatttatatatattgggtcgtctgcttcccttgtatttttcttcctttttttgtaatattgaaaacgacgatataattattataagtagactataatatatttagtaatatatattattaccttaaaagtctatttttgtgttttgggcatttttaaataaacaatctgagtgt

SEQ ID NO: 17 - DNA, 154394 bp, Homo sapiens
  allele (1)...(154394): Human nuclear transcription factor Y, alpha; DNA sequence from clone RP1-34B21 on chromosome 6p12.1-21.1; accession number AL031778
gatcaaagggtcctccctggccacttccacctacaggaggtcaaaaatggagagagggaaaacaggttgatatcctgaaccttatggggctgggcttcatccattcctttcatgaatatgcacagacacatgtgcaaacacacacatacactgagctgtaccatgagcaaggcactgtgccgagtgtcaacaattttaaaagatttcacccagctcctgcctttgaggagtgcatggtccagaggaggaagcacgtgatagcagtgtagtgtgaatggtgctggaataggctgatggaacctcatgaatgcacggagaacagaggcctggtgccacccagtgtggacgagaggatggcatagcaggactaagaggtagccaggagccagctcatgaaaggccttatatgctgagccaatgctattgagattggactttgtcttaagagcaatggggagcaactgagcagttttgagcaggacagtggaattatagaatttattctttgaaaatattcctctggcttccgtgtggaggaaggattagaggtgggtggccagtgagggctttgcagttatccagcttagcaggatggagcactgccaacccaaccagagcaaatggggaggccaccagcctcaccctgaccctggacatgcccaccatgatgggaagacacagactgttccacaacaaccccttggaccccagcccagccctggaagaaccatgtaccttgactggcagggaagcctccactccgggcctgggcacacatgggagggtagggccccatgcttggtatgggctcaggctagcgctgctgccctggagtcagagctgtgtagagaggggcaagccccactcccagagagaaggagccacatgccgtgatggcaggtggtcggtgcagaccctcagctgttgggggagtggtcgggatgcctgaaatgtctgggaccgaggttctgggtgcagcctggagagttggggctgtgcgttcttgttgccattgttacattggctcatattgctgagtccttattcattaggctgttgggtacttttagacacacacacacaccagtctggagcacagagaaaactgtcataggcactcaaaattagagcaagttagataaaggggccagtaagtacagacctcacatgcccccagtggtggattcaggggtcactgattctatccattcctacagatgaacaggataaatatacctccgaccccgtccagtttttctatcccatttaatcactcctcagctgagaaagccagaaactcattcctgacgtggctgacaaatgctggggaaatctttggttttcttagagtgagcctctctttgtaaccagagagcaagagaaggaacagggccttaaaatcacttcaagtggcctgtgcctgatcctgaggtccagagaaggagaatgacttattcaagatcacagtttaatcatacatgcctttatccattcactcagcaaacacagttcaaacacctaccacttgccaaaccttctagatagttattaccaacataaccaagcaaagtatatggaatgccagatggcaatgggtacaggagagaaaaataaattggacaaggggatagacagtgctttggaggtagaggcagctttaagtagggtcacactagagtgaagatcgcaaggaggtgaagcttattctgggggaagaatattctaggaaaaggggacagtgagtgcagagtccctaagacaaggcatgctggggcgccggaagaaaagcagaggatggtgtagctggagaggaggtagccaggaggtgagttgtaggagattaagtcagagatgtgcgaggtatgagggagaagttcttttgtagagacttcaccttgactctagtcggatgggagcccatgtgggctctgagcagaaaaggaacagctctgacttaggatttagttggctgctgtgctgtggatagacagacagttggcaagcctgaagtcaaagagtccatgtaggagatccaggcaagaaataatggttgcttgaaccaaggaggcagtagtggaggtgggaagaggaaatcacacagagtctggccagattatggaggtaaaggcaacagtattgactaaaggaccaaatgcaagatgtgagaagaacagagtcagaatgaccccaaggtttttgtcccatgctgctagaaggaagacgtttcccattagccatgttggaggataccacaggagaatgggtctctgtttgagcatcttattcaagatgccattcaacatctagtgaaggtggacaggagacagtggacacaagtcaggacctcagggaccaggtcacaggcagagctagaccttgaacttcaagattcacagatcacactgcttctgactgaggagtgacagaagtgccagagcaatctcaccagctctggaatgttcatcacttgacggctgggctggcaatgaagaagctccatgcagtctttgggacaacactgcaccaagagaccacagcaacaggggagctcgcagagtagaacactggcattcaacccaaagcctcactgtttccagatacaagtgaaggtaaattccctgcccctccccctgccccaccacattcatccatccttgaagaactcctgggagctcactgggaaactcactgagcagtgagtaatatggttttgcttaagccttgctcaagtagcagaataagcaagtttgactaaaattctctagattcacaaatcccaaagccctaaactacagaaaacagactagtcaagagagaggaagctgtctgctggctatttgtggagcatcacccaatcaatgaacaagtatgcatagactgctgggtgcagagggaggggtgtttaagggatgtcttaatcgggttttccagaagcagatcctgagacaaggatttggttgcaagtagttatttagaaagtgaacccaggaagcaccagtaggagaatgaggaagcaagacaggtaatgaatgtattagtgaactgatcaccactgtgagcaattaggctcaattctactctaggaggctgtacagaatgtatctcagggttgtcccaccaaggggcaaggaaactgaggtacttatccactaactctcttttgttgttgagtgttcttcccacaaaccttaacttccaggcacttccagtttgtccctttattaagctgaccaatctcctgaggccagagaaagccttccagcagagaccagcaggtgtttccagtaggacactgtctgtgtgtactgaaaccagagtgtcatagggaattagaaggacgcagcaccaaccataatgggtttcacaggaactgcctggtctccacaaatagggactctaattttggtctggattctaagaaccaccttcaccccagtaaataggactgagatgacttttatcattcctgtaagcagagatagaaatgccagagcaaagtctcattggtccacacagaaagaaggaagcctcggtgctctttaattggagaccagagctgtggcaattcccaaccagtgtcagaattttgcaatgtgttggagacaggcagccctccctaggaatctactgagagacccagatctttgggcccttagtgagtgtttgagtaaataggtaagcagtggctgcggctcaggcaggagggtcctggaagttaatgtcccagcacagagcttcagcccagaccacagtgccaacatcctagcccttctggttaataattatccctaattccttagcgtgggaggcctggagatgaaaatcacaactctccatgtcctcatcagtctgttgtatgtgcatgtgtaccagatacctacatgcaacctcatgaaattccagacattctcatcaacaaatccctttgtcatcttcataaaatccaaagttaaagggcccaccctaagaattgtgactcatagattcctggatggatcaactctatgtgactattagagctagttttctcatgcccatattgggcaaaacctggtaaacagcacccctgtctctccctccccaaaattctgtctggatgagcagtcccttatgtaacaagctaaaacctttacaactgaccatatgtcaggaaacagtaaggtgtttacaagatacatgagaggggagtccctgtctttcaagagctcctgagtcctgccaatgaacaccttaagtacctgccctttaggggatacttgctgaaatcattccttgaatagaatgttagaatggcagaatgacagtggctgccaccgataggtcagagcattaaggactgggtcttttgaccgaccctaggatctctcttcagtggaactctgcccccaccaaccctattcagcctcctcctctatgctcaggcagctactgcttctcagccatcagtacaggctacctcattcaagttgaatttgcaatggctgttgtggttttttgtttttctgaccatgtggggaactctcatataggctttggaattatatagtcctggtttgtccaaagcactctccacaaacaggctgtgtgaccttcaaatagctgcttaacccctctaagcctgtcatctgaaagtagaaatgataatgataacattagagtaaaccacatgaaagtgtctttgtaggttaaaaattgttgaatattggcagtctcataggttccacctaaaacctttgtggggttctggggaagattcggtaagagaatatatgtattactgctagggcctcagatctaactagtttaggaccacagaagaaggtcacgttccccttagtgtctgaaccacatctcctgtcaaatatctacaggataggagttcgaagtctattcttacaggattcccagtgatttcaggaatccttgtggcctcttattccctcccttgtgttcccctcataaagatgttgatgtttattgtgcgtttactctctgccaagtattgtgccaggctctttgtacataaacatcgatgtacctctctacccatgtgaggtgggtgcttctactatcatccccctttcacagataatgaaactttagatatgagctaagaggaatgaaaaaattaaaaataaaaaaaaagcagataaggaaactaaagtgcaaagaagcaaaatgttttgccaaggtcacaaggacctcagggtccgtatggttgtaagaagcagactaggccctaaggtttcttccatgtctggcatcctagggggttaggactgccactgagatgctgaacaaatgataaggcaggcacttccccgacaaagaatttgtgttggtggcaggaggagagaagaaagctgcgaccaggagagctgagccaggagcttttgcccacctcatcatctaaatgagcatcagactctcaggtgttgcagataaaatcccctggcatgtgatcataggtgacatctacccagcgctcatgatggtaatgccaggcactactccaagctccttacatgatcaatcatttaaccctcacaaccttggggtctaaacagtactgttagtcccattttacagatgggtaaattgaggtatggagctgttaagtcactggcccaggatcacacaaccaataagtgacccagctggagatggaacacaagcaggctggctcccaagtccatgacgtgaaccataccagatactgcctgtcagaagtgtaaacagccctgtctcataatcacctcctttgatttggaagcctagaccaggggtcagcaaactatggcctgagagattcagagctaaatctagctgaccaactgtttttataaataacattgcattgaaatacacccacattcatttatttattgactgatttgcaaaaaacaagggcagcagtgagtagatgcaagagatcataggcctgcaaagcataaaacatcaactttctgaccctttatagataaaacttgttgacccctgacctacagtatgcacctaaggtgtgtcctatgtgtcctaagatggctccgacacttgctatgtgaccccagacaagttgctttcctgaatctccatttcctcatctgtaaaatgtgcttgtgggaatttggtgaggaagtgtgtgtatgtgtaagtgcctgacccaaggcaggtgtttgataagggtttgcagctatcattgccaatagtatgatgaaaattatgactgattcctatgatatcactgaagacagggcagagacctttatggccactttatgggcaatgaaaccctggtgcagagagaggatatggtgagaggcagagcccaggtcttcccagtccaagtcctgcactctgctgcctcctttcccccgccttccaatccatagctgccctagtcctcatttatgtttgccagcgtgcggagcagcccttctgtgtttgtgagttttcggcatctgtaagtacccacagccgcacagagctcgccagcacagacatttgtcaaagatgacatgccagtcatccatgccaccggagacagtgacagatgcgctctccagccccaccatccaggcagtggaggatagatggggccttggcaccggcgcccgctcttggcctggcatgtgcagggagctgcagaccaggcaagagacaaattgcagcctggtcagtgggcaggaggctcagtgtgcatgcaggcagatgtggctgcagcctgcccctgaaccagacacctgcctgccctccccagtgtcctagacctgcccaaatctggtgtttgcttaagatttgtatgtggtcactgatgaggaggtgagtgctcacgggctttgggttgtttccaataataatagtgacaatggctgatgctaacatatgctgctctgctgttctaagtccttagcatacatcgagctctttaatccttagccatccggtggtggaggtacaggaaactgagcctagagaggttggaggcctcttccaagttcacacattaagtggcagaggcaggaatcaaatccagacactctggctccagagttcaatgcccctcaggactactgtctaatatttgagagcctggagtggaggaaaaatcgtgactaggcaaaggattcaggtaggcagggctcaccactaacctgagtggacaggaacaggttgccctgcctcaatttttccaccagaaaaaatgagcagtggctgctattgcaaggccctgcaaggtcccagaccagctccagggcaggcctctctgttcttctgggacccttgggcactaggtcctctgccgacacacattcactccctccgcctaataatcccaacccagatcccctggagtatcatctcgtagttcattaaaccatcacctctgtgtccctgaggcaagcttgcagtctgttgagattttgtagggatgtttatggctagtggcagcaaagggaacagaccacataaaacaaaaagagacagtatgagctcttaaaaagtttccaaagtctggcataaaagctcccacaggtgtttcattcatacaaatgaccagcttccctccgctctggatgaagggtttggaaagaccaaagtctggttcagtccagccagtctcctattgtgggaccttccttgcgaaagtacccttctttctctgagccttggtttccttgtctgtaaaatgggtataatgatagtacctatctcataaaattattgtgaggattaaaacacaaaaaacacttagaacagggcccgacacaaagcgaatgctcaacaaatgccaactgttctcattctctggtttttagtttcctcagtgggaaaatgaggaggtgagttttgtgccaggtatgggcttctggctcgaacattctgtgacttcatgatgttcctagggtgcttccttgtctcctcccacttgcctgagtctttcttctttgtttctgtgagccccagccaattagtttactcacaagtgtagggtagagagaactacacaaacaggaagtgttaccactcatactcacagtggtgaatcattccaaccttccatcaagtggatccacctccattggtcgacacagctggggaatctgagctactgtggccagaactctgttgaccacatcctgcaatgacagacctcagaatccttcctgaaccttccatgggaaggagtctgtgacagcccacctgtgtagactgggcctcatcagcctgaatttgctgaaataagtaattccagtttccctgaattcatgcagagggcacccacgctgggaaggagtttctctggcttttcaagctccataaacacttgaaaagtcattttatttttcaatctgtgggcaggatgccaccaaacgaggaagcctcattaaacagaccttgaaggctatttctttgttgttttttttgtgggagtgggatgaggtttggtgttggcttttttttcccccactgatgctttttggataaacacataaatcagcatcatctatattcattagatatcgtgccttgttcagtacaaaattacccctgttttgcatgactttccccccttgtgattaatataaatgacttaagttaattatgtttctcttcatggaaaaatgtatttgtcaaagtgctgaaacatcaataaaaaataaacactgtcatttgaagaagggctcatttgcaaatgagtagctggggtgtggggaaaggaatggactcacccgtctggaggtgtcattctgattgagtaggcacacttcatatttactaacaatgacaaaagcatttttcttagttaagcactcacaggtcctgatgaggtagactgatgtcatcattattaacaataatgacacctcaggcgtagagaaaacaattttccttactagagaaaactaacgctgggtattttaccatccagacctccaaaactaggcccagcatggggactttgcaggaatagaccaagaggcaaatacagatgattggagtgggagggaagagaagtgaagaaaagcaaaccatggagctggtgtggcatctcagagcaacatggaagcttagggatgagacagcacaaacacctccctgggccaatgacaagactaagaaccagagaggggacttgccccttgggtaaacagcatattagtggcagagcccagagagaacccaggactcttgactcctagacccccaccctttccctgcactctgctgcctcccttgccaccagggatcaaaggctccccctcacttgagtaagtggtcaatggcaccagcaaggtgcaggggctcagactgctggacagtcagggccccagggaaatctacaggttactgacttttttcatggtatctggaatagcctttccccacactgactgtcttagtttgggtttcctgaaggcagaccctgagacaagatcgtaggtgctggtggtttatgtaagaggtgagcctaagacaccaagtgaggtggagaagtgagacagggaagggagaaaagccaatacagggcacatgtatgagggggttactgctttggacacttggactcactccccccaggagtgactgcagagaatatgcctctgagttgtcccggtgctggacagggaagcagaaatatttatttactgacctctggggactttaatttccaacccctctgggtcaccctgtacctaagctgagcaaactcccatagtaccagaaaaacccagagatccaaaaccctgagcaggtgagtgggaagcgctagtgggcacagtcactgtctatggcagatgcacgtgaacctggaggtggtatggggggatgtgggtggggcaggcatgttatctactacatcacccttatctaagtgctcccagccttccaagaaatcccccctccaagtaaacatgatcatcttgtcttctgatggtcagaaaccattcatctggccaccttattttacttatcttcttaaatattatttctgtcaccctaaatatactgtaaagcattcaagggcaaaattaaggccattatcattctgtcattcaacaaatacttactgagcacttactctgtgctggactatctttaaggtgctaggaatatagcatcaaagataaagaaaatccttgtcttcaaggaacttgcatcttaaaagtagagctagacaataaacacataaataaatgctataatttcaagtggtgataagtggctcaaagaaaaagaaagcagggtaaaggggatagcataatggaagtgcagtactcctggggacatttgagcaaaagcctgaatgaaataccggagtaagccatgtaagaatctggtggaatggaattcaatcaaagagaatgtcaatgcaaagaccctagggaataacaggaaggctggtgtgacactcagcggagtgaaaaagaaggtggtaggaactgaagaaggggacaaccagatcgtctaggaccttacctttaaacagtgcctggcacaaaagaaaggtactccaagctgactggatggatagatgggtggatataacagatggaaggatggaaataatgacagactagtggatgaagaaagaagaaaacaaagcaggttctataggtagagtgtggtgccaatggtgcattcaaagccagactttgcagaaatagcaaatattgaacccaaagtacccaatgagtagttattagaccaaggaagcagttgaaggagaaatgttcctctctgggcttcagccaatgagaatcctagaaacctgagtgtccttatctttctttacattccctgcagaggcccagcttctcccctgtggtgagtatccaataacattaaatggtattacagtggattaattaaactttggtggctggaagctagtgaatcattccctccaccacatattaccatgtttactcatcagggctccatttttaatagcggtcttttaattaaagcatgtcaccacggtccattagggaagaatttggaggatgagatgtgcatgtgggtgcaagcatcatttaattcagcagttctttactgagtgcctactatgtgcctggcaagtcttgaggtactatgagaaaataaggtgcaagtgaagggcttcaaggaacttacgcgatcaaacaaagtgaattcacactcacgatcaactgaggaacattggcatattaatcattgcttgccaactaaccagaattctttattagtaacttctcccacctagtttaatttggaagaaccaggccaatcataagaaaaattctggggcttttcgttttcagcaaaatatccagggtatactgtggcctagaccctgatgcagtcatatatctttgggaaagcctcctaaaacttctgagcctcaatcagtctcttcaagaataaaagcagaggttgttcttatccagaaattctctagattccagctgtaacattttctcatctgcgaccctccaaatctccaggcccagaccatgaggatgggttttccagaatggtggaaatttcatctaaagtcactctaagatttttacccaccagagaaagatccttttcattacattcatgacattttgttttctgaattttcaaagaggaccaagaagacctgtttggaagtaggagtagttacaatgcatgcactatgtgtgcacttagatgaggaggaacaaaccacatactgccagaaaagcaggctctattcatggggtgactgggtaaaaggcattggaactggaccctaaagactaggtaatagtttgagagtaggagaaatggggggaaagagccaattttcagcctgattctagccatgttccaagtatgggtccccactttgcaactgcatgacaagctcccccaggaggagggaccaggtctctttttcttttgtctgagattcttccttccagctcttcactccttaggcgagctcagccagtctcataggttagggcccacctgtgtgatgatgactcccacatttccatctccagctcagcacctctctgcggagctctctattcagtcagctacctgcttggcacagcacttagaggcttcaagacatcacaaacaacgtggacaaaatgaggctcctatttctgtgtccagtctgttgatcctcattcttcaggtctcaatgtaggagtcacttccccagaatgtaaatatatatcttaccccagaatgtgtgtgtgtgtgtgtgtgtgtgtgtgtgtgtatatatatatatatatacacacacatatatgaatatatttgtttatatatatttatatatacatatatatgaatatttatttatttatatatgaatatttatttatttatttatttatgaatatatatttatttatttatatatatattatatatatgaaggaggggtcaggacctctccgatccctcttctataaacaccctaggttttccttcacaaatgttgtcacattgtcaggaaatctttgtgttgtgatatcttttctgtgaggtatttgatgaatggttgcctgtcttactggatttttaagtcccattgggcatagatcagcccccatttactcaccactgtctcctgagtacctgggactgtgcctagaacataataggcccccagtaaatatttgttaagggaaggcatgggttccccaaccccagccagtgtgcaagatccatttccgcataccactggcacacaacattcaggcactgggagccgcacagtgacggaagcttgaacattttcttcgtgtcaagttctcagtaaagctattttctcacattgtctcatgtaattcttaaaccaccctggaaggaataggttttattgctgtttccattatataggtggggaaacatggctcagaggaaagtggcatgtccaagatcacacatcctgcaggggacagacagaccaaacccatgttttcaccagcctctcatctcacaaacaacactaggtttgttaatacctgggaactctgtgtaagcgaggtccctggcttggtgtcagaagacctgggtttgagtcttgacaatgtcctttgtaagtagcttaaggtagctcctcagttccctgtgagacactgcacacaacatcctttaaactgccttaagaaaaacagccctacaaatgaagactccattgccactccctttgaagcagctgctctcagagtcctctgcactgcctcatctgaattgaactatctccccaccttctcgcagaatcaaaaactagaggctgcaggctgaagagggcaccattattttgtttaactcacagagtatttaaaacttttttttaagttgttgggtaaattctaacaggttttcttcagggtccagatttttaccttctcttgaaaaattagaagctcctgcaacatcagtcccacagctctgcacatcattgactggcatcaattggttgagccaagaggtagccatgctctctccccagtgtgccactatccctacctgaggctgggaatcaggtgtcacttaccttgacatctgttcccttatttttccaacaatgggaatacatttttctgcattcatgtcgctaacagaactaggaaaagcaagcctggaccacaaggatagtgcagtgagagataatgtgagtataattcttgatgcaagtgaagaataatcatgagttcaatatggttaagtgcatgtgtttcaaaacaacacaacccaaacaagattcagcaaaaatactatcccccagctctattttgttatgttgcctctatgacccctgtaagattttgaatttcagatgcttgcttcagttaaataaagagttttctagatgaaggcatgcagtaggtctctaacactgagccactgccttgtccctctcaattaacctttgtctttaagtccctgtctaatgcctactagtagctaggtccctgagattgtaaagaccccaaggccccaggaccctgaagagcccaggaagtatcagaccaatgaaccagacctgaggtctcctgtactcttcagcttctgaactataggagaatcccaaggaaaacagggcaacaacaacttataataaatagtaatactgccagaatcctatttgtatttaccagtttgcaaagcactctcattcattcaacagtcatatggcaaatataagttgaggctctattacagatctaggccctgtgggcgtgatgttatacttggtagtcaagatccctgaccttaggaagcttccagtctggccaggaaacatcagagaactaacatttctatagcactttaccatgaaccagtcactcttctaggtgctttacactgagtaactcatttacccttcatagcaattctaggagataagtactgctgttttccccatttcacagatgaagaaactgaggctacagaagttaagtaacttcctcaagctcagtggtggagccagccatctgacccacagaagcaagttgctggaggcaggcttttgggaccacagactgggaagatgatatcttcaccagtgaagatttccaaggccaacatcacatggccaaattgcatcaccccatggccctgggctcttctccctgttcacactaaaactcagaaacatttattcatggggggagtagtcagcacactggttgctcaggtctgagaatgccagggctgagctagcagggtttgcaggtcccaaggcaatttgcatctcctgttggaagtcttcctcatcaaagcaacggaaatcaatgcagtaaatagttataatgaactgacctgctcacactccctgtctcttcctgaggaagaggaatcatgagagacacattgtttccaaatccttcacctctttccccctcgcctgatcctcccacagggaatcctctttgctcctgtcaacagtgtttgagatgtttcagagtttttattggatcttcattgtagctctgtctgtgaggattcagtgaagctaagatttaagggccagagagagttgaaacttctaccaagcatcagccatggctgccctgctttccagagtactgtccacggacctctgggcctcagggactagagaatgtcaggggaccatctcatttcatacatgtaaaaactgaggcacggagagggcaggaccacccagcacaggatcagcacacctctccaacatcagtacaccccaccttttcaggcagatacaggaatctcctccgcagcaaagtgttgataggtgggaagcagtgctgtgatgcccttagctttggcatccaaatgcttgagttttaatgcctgacccaccatttccttgctgtacaagaccttgagaaagctaattaacctctcagtaactgttttctcatatataaaacagggatgaaaataaaagtatgtgctccattgagttgttggaagctttaataaacacaggaaaaaaattagaattgtgtctaccatgtagtaagtattcaataaatgtcagtgactatgcccatgatgaatatggtgaatatgattatgatgatcatgggcattatccctggtgctaagagtcacttctacaggagtttagcttgccctgacctagaacattgaggcagggcatgaactcaatgttgcactgagaaccagtctaacacaggaatgttttctctgtttcacaggtgtcagtcatgttctctggataaatgataagattgaaagtccttgaaggcaggagacagccccagatatcgttttgttgtctgacacaataccaagcacaaatgatgtgcctaaatcctgggtctttaacccaaggccatctacatatgccctgggcctgccagctcatgaaaaccagcctctgtggcagttggggtgctaaggaattgctccagttgagcttcactggtttttactcttggctgtcatgcttggatctcttgattatgttccatcagttcaccccctgcctctgggctgaaagatttggtgttctttctaagttttcttgcatgatttgtggcttagaacgtctttcccgtacatctctagccctttccatctcaaatgttgactcagattattggctcagggcaaagccactggctccagctcttaaccctgtagaatctcacctatccctggcacccaacatagacatccaccccttcaactccaccaagctagggagtagagagtagttgtcttttccatccattctctcccttcccctccttgtctaatttctaagagttaagagtgggcacttttccaacatttccgtggttacgggtaactatgtcactcaatcctggccacatgaggtgggacactagcccactggaagagttttcttcttaatagaagagagaaatctgtaagaataatcccccactgttcctaccttgggtgctattatgtgaggccttgatgcttgaacctgtggcaatgatcttgcaacatgaggaaagggtcacaagaattgcagagatactgactggagccctgagctgttaaataaaccaactccaaaccaatgggaatggggtatggaaccaccagtctctagattttctgtgacaaggaacaattaagcttccatatttcttaagcctattttagtcaagagctcagttagttgcaggcagaagcattccaaagttttatcaagtaagcatcaatttgcctatcacaaactttatcaaggtgttggtagattctaccttgtagacataatgtgatctactaggaatctatgtagaaaattcaagaatccaagaatttgggagaaaacttaaaagtcgtccatatctgacatatagatcaatggaataaaatggagggtccagaaacaaactctcatatttatggtcaactgattctcaacaagggtgctaagaaaattcaatgggggaaataataggctttttgccaaatagtgctagataacagaatatatccacatgcaaaatatgaattcagaaccctatcacacaccatataaaaaaatagctcaaatggatcaaatatctaaatgtaagcactaagactactaaactttaaaagagaatgcatgtataaatccatgaccttggattaggcaatggtttcttagatatgacaccaaaagcaatcaaagaaaaagacatataaattggacattaacaaaatttaaaaatgttgtgcttcaaagaacatcatcaagaaaatttaaaaaaccttgaatactgtatatattttctccaaaaaagttacacaaatagccaataagctcacaatgtgcttctctgctgagcccagagagagcaagatactactactcaactagccctttagacagccaccacaaacacatacgaacgggcacatgggatgaaatgtgtttaccattcccaatctaggacaacggtacccaaaggaaatgttggtgactatgcccatgatgaatgcttataaaccaacatttcctttgttttgtaaaacatttgaagccatgtccatggacacagaggaaaccatgacggcaccagaatgtctatttctgtccttgagatgatgctaagactaggatatccctgtgtctaggaactcactactattgtactggtgtagctcagtccatctttgaggaacaaaaagaagttctatttttttatttcaacttttatttcagattcagagggtacatgtgcaggtttgttgcaagggtatattgcatgatgctgaggtttggggtacaattgaactcatcatccaggtagtgagtatagtacccaataggtagtttttcaacccttgcccctctccttccatccctctcttgtagtccccagcatctagtgttcccatctttatgccatgtatactcaatgtttagctcccgcttataagtgagaacacgcagtatttggttttctgattctgtattaattctcttaggattatggcatccagctgcatccatgttgctgcaaaggacataatctcattattttttatggctgtatagtattccatggtacatatgtaccacatattatttatccaatccactgctgatgagcacctaagttgattccatgcctttcctattgtgaatagtgctgtgatgaacatacgagtacaagtgtccttttggtagaatatttattttcctttgggtatatccccagtaatgatattgctaagttgaatgatagctctatttttagttatttgagaaatctcctaacagctttccacagtgcctgaactaatttacactcccaccaacagtgcaaaagcattgcctattctccgcaacctcgccaacatctgttgtttttttactttttagtaatagccattctgactgatgtgagatggtatttcatagtggttcttatttatatttctctgacgattagtgatgtggaccattttttatatgtttcttggccactcgtatgtcttcttttgaaaagtgtctgttcatgtcctttacccactgtataatgaagttgtttttcacttgttgatttgtttaagttccttatagacctttgtcaggtgcataccttgcgaatattttttccctttctgcaggttgtctgtttactctgttgatagtttcttttgttgtgcagaagctctttagtttaattaagtcctacttgtcaatatttgtttttgttgcaattgtttttgaggacttagtcataaattctttgccaaggccaatgtccaaaagggtatttcctagatttttttctagggtttttataggtcgaggtctcagatttaagtctttcatccatcttgagttaagtgataagtgcacacaaattaaggtttttttaagtatttttaacttttttaaagtattttttaggtatttttaacccttattttagattcaagggtacatgggcaggtttgttacataggtaaattcatatcacaggagtttgttgtatggattattttgtcacgcaggtattatgcctcgtacaaaacagtttttttttctgctcttctccctcttctcttcttccactctcaggtatgccctgatgtctgttgttgccctctttgtgtccatgtgctctcatcatttagctcccacttatacgtgagaacacgtggtatttggttttctgttcctgagttagtttgctaaggatactggcctccagttccaaccatgttcctgcaaagggcatagtctcattattttttatggctttgtagtattccatggagtattgtaccacattttctttatccaatctactgtttaggttaattccatgtccttgctactgtgaataatgctgtgacaaacatacacatgcaggtgtctttatggtagaataatttacattcttttgcgtatatacccagtagtgggattgctgggttgaatggcagttctgtttttagctctttgagaaattgccacactgctttccacaatggttgaactaatttacactcctaccaacagtgtgtaagcgtccccttttctctgcaaccttgccagcatcagttattttttgacgttgtagtaatagctattgtgactggtgtgaaatggtatctcactgtggttttgatttgcaatcctgtaatgatcagtgatgttgagctttttttatatgcttgttgggcacacgtatgtcttcttttggaaagtatctgttcatgtcctttgcccactttttaatggggttgtttgttttgttcttgtaaatttgtttaagttccttacaaatgctggatatttttaggtctttgtcagatgcatagtttgcaaatattgtcttctattctgtaagttttctgtttactctgttagtttattttgctgtgcagaagctatttaattagatcccatttgtcaatttctgcttttgttgcaattgcttttggtatcttcatcatgaaatcattgcctgtgcctatgtccagcatggtatttcctaggttgtcttctaggggttttatagttcgggattttacatttaagtctttgatccatcttgagttgatttttgtatatggtgtaaggaaggggtccagtctcaatcttccacatatggctagccagttatcccagcaccatttattgagtaggttttccctcttgcttgtttttgtcagctttgtcaaaggtgtgcagccttacttctgggctctctactctgttctattggtctatgtgtctgttttttaccagtaccatactgttctggttactgtaatccagtagtatagtttgaagtcaggtaatgtgatgcctccagttttattctttttgctcaggattgctttggctattcaggctcattttggttccatatgaatttttaaacagttttttctagttctgtgaagagtgtaattggtagtttgatagaaatagcattgaatctataaaaatttcttcaggcagtatggccatttttacaatattgattctttccacccgcaagcatggaatgtttttccacttgtttgtgtcatctctgatttctttgagcagtgttttgtaattctcattgtaaagatcttttactttcctagttagctgtatccattctttaggtcttttattctttttgtggaaattgtgaataggatagcattcttgatttggctcagggcctggttgttgttggtgtataggaatactaattatttttatatgaatacattgattttgcatcctaaaactttgctggagttgtttatcagcttaaggagctttggactgagactatgggattttgtagatacagcatcatgtcatctgcaaacagagatagttttacttcctctcttcctatctgggtgctttttattgctttatctttcctgattgctctggccaggacttccaatagtacgttgaataggagtagtgaaagagggcatacttttctttttctgcttctcatgggaaatgcttccagcttttgcccattcagtaaatgttggccgtgggtttgtcatagattgttcttattattttgaggtacattccttcaatacctagtttgttgagagtttttaacatgaagggattttgagttttattgaaagccttttctgcatctactgaggtgatcatgcggtttttgtctttagttctgtctatttgatgaatcatgtttattgatttgtgtatgttgcaccaaccttgcatcccagggatgaagcctacttgatcatggtggattagctttttgatgtgctgctggatttggtttgatagtattttgttaaggatttttgcatcaatgttcatcagggatattagcctcaacttttctattttgttattgttgtgtctctgccaggttttggtatcaggatgatgctgaccttatagaatgaattggggaggagtccctcctcttcaattgttttggaagagtttcagtaagaatggtaccaattctggtagaatttggctgtgaatccctctggtcctggactttttttattggtatgctatttataactgattccatttgagagcttgttattggtctgttcagggattcaatttattcctggttcagtcttgggagggtgtatgtgtccaggaatgtatccatctcttctagattttccagtttgtttgcatagaggtgttcatagtagtctctgatggttctttctatttctgtggggtcagtgataatatcccctttgtcatttctaattgtgtttatttggatcttctctcttttctttatcagtctagctagcagtctatctattttattatttttttcaaaaaaaactaactcctggattaattgatcttttggatggatttttgtgtctcaatcactttcagtgcaatatgattttggttatttcttgtcttctgctaattttggggttgctttgctcttgcttctctagttcttttcattgtgatgttaggttgttaatttgagaactttctaactttttgatgtgggcatttaacgctataaatttctctcttaactctaccttagctgtgtcaaagagattctggtgtgttgtatctttgttcttgttagcttcaaagaactttttatttctgccttaatttcattatttaaccaaaagtcactcaggatcaggttgcttaatttccatgtaattgtatggttttgagtgattttcttagtcaaattctatttttattgctctgtgatctgagagagtggttggtatgattttggttcttttgcatttgctgaggattgttctatgtccaactgtgtggtcaattttagagtacatgatatgtggttatgcgaagaatgtatattatgttatttgagggtagagagttctgtagatgtgtgtcaggtccatttggtccactgttgaattcaggtcctaaatatctgtgttaattttctgcctcaatgatctgtcttatactgtcagtagggtattgaaatttcccactattattgtatgtgagtctaagtttcttcgtacttgctttatgaatctgtgtgctcttgtgttaggtgctgcatatatatttagaatagttaggtcttcttgttgaattgaacccttcaccattatataatgcccttctttgtctttttctttatttttgttgttttaatgtctgttttgtctgaaattaggatcacaactcctgcttttttcagttttacattttcttggtagatttttctctatccctttattttgagcctatgggtgtcattgcatatgaaatggatctcttgaagacaagatattattgggtcttgcttctttatccagcttgccactctgtgtcttttaattggaacatttagcccatttgccttcaaggttagtattgatatgtgtggatttgatcccgtcatcatgttgttaggtggtaattatgtcaacttgtttgtgtggtagctttatgatgtcactggtctgtgtacttgtgtttttgtagcggctggtaatagtctttcctttccatatttagtgcttctttcgggactccttgtaaggcaggtctggtggcaatgaattgcctcaactttgcttgtctaaaaaggattttacttctctttcgcttgtgaagcttagtttggccagatctaaaatccttggttggaatttcttttatttaagaatgttgaatataggcccccaatctcttctggcttgtagggtttctgcttagaggtccacgttagtctgatgggcttccctttgtaagtgacctgtcctttctccatagttgcctttaacatttttttctttcatttcaaccctggagaatctgacggttgtgtcttggggaattatctttttgtgaagtttttgcaggggctctctgcatttcctaaagtttaatgttggcctctctagctatgttggggaagttctcacggatgatatcctgaaatatgttttccaagttgcttccattctccccatccttttcagggatgctaatgagtcacagattcagtctctctacatagtatcatatttctcagaggttttattcattccttttcattctctcttctttattcttgtctgactgtctcatttcagaaagccagtcttcaagctctgagatttttttcttagcctggtctattctactgttaatacttggaatagcattatgaaattcttgtaatacatttacaattaccagccctgtcaagtcagttatgttattttctatactggctattttttctgtcagttcctgtatcattttattgtaattcttagcttccttaggttgtgtttcaacattctcctgactgttgatgatcttcatttctacccatattctgaattctagttctgtcatttcagccatctcagcccagttaagaacacttgctggagaactaatgtggttgtttggaggaaagaagacactctgcgtttttgagttgtcagagttcttgtgctagttctttctcatctgtgtgggctgatgttccttcagtctttgaagttgctgacctttggattttttttttcttttatcctatttgatgaccttaggggtttgattgtggcataaggtggattcagtcaactggcttcatttctaaaagattttagggagccaagtctcagctcaggactcctgggccacattctctaactctgggagactggtattgagccccagctttgttccctgactcctcgaggttaggaacctgatgcactgggggggccaagatgctgctggaccactggtcacagtgctctggtggatggtgccagccaaagcacttcacagggcagtggtagtgagctctgtcctcatttgcacatgccagtagcagtgcagtggcagtgcagcagggtgcatgctcagctgcagcagggtgttagtgggtactggggtgctggcctctgtgcaagtgttcacagcagcagcagtggcagcacagcttggggtgggccccactggacactgggcaactgtgcatgcattaacaccaatggtggtgttagcatggagacagggtgctagtgggggcaggactgtgtgtacccttgtgcacgtacatgagggcagcagtggctacccagggtggggacgggtccactgtttcagctggggtcaggcattggcaggcaaggctagcaggcttcatgcctactaatactctgacaacaatggcagttgggggggcagtgcactcaagtcagcagcagtggcatgtcagggtgcctgcacacacatatccttgtggagaaggaaaggcaaagtccacctgcacaaggtccacatgtgctggcaaagtgatgtggggagaccctgggtgagtatatacaggcaaagtggcacaggggaggctacagtaggggaagagcaggggtggagttagtgtgtgtccacgggtggctctgctggagcactctgccggtcaggtacagcctgccagccctgaagctatgatgcaggccaaggcagtacctgagggctgcactgcaagcagttgtggccaggctggggcctcaggagaggccatcagactaaggggtgctcagatcagactagtcctgtctcatgggcaagaccaccctgcagttccagtctaacagttcccctagggctatagtctcttatggcagcaagttgagcctaagaggatgggcatccctggccatgcttcactacagatgcccctacaccaaaccctctgggctccacactacctggagttcttccccatctcttctctaagcagcaattcctgccaattcaagtgtccatggtagtcgagtggtcacctcctggtggaattccagaggcccaaggttagagcaggttgctccttgcctgttgaactcaccccttcatgcaggcatcattgaggggcaggaacgagtcccagtgtgcagaagccccttgcagggttcccagcttcctcctgcttcagcccagcctctgtgtcttccttatattcaccctgaatgccttccctctgaagacatgctaggagtgcaccagtcttcctgatatcccagtctctcggtgagagatgttcctcctggctgtgtctagtcagcagccatcttggagctagtcctctgagctcagtttcattcttctgcatatggatagtcagttactccagcaccatttattgaatacggactttctccattgcttatttttgtcaactttgtcaaagatcagttggttgtagctatgcagctttatttctgggttttctattctgttccattggtctatgtgtctgtttttgtaccagtaccatgctgttttggtcactgtagccttgtagtatagtttgaagtcaggtaatgtgatgcctctggctttgttctttttgcttaggattgctttggatatttgggctctttttttttttggttccataaggattttagaagttttttctaattccgtgaaaaatgacattggtagtttgatcagaatagcattgaatctgaagattgttttggcagtatggactttttaaagaattgattcttccaattcatgagtatggaatgtttttccatttgtttgtgtcatctatgatttctttcagaagtgttttgtagtttttcttgtagagatgtttcacttccttggttagatgtattcctaggtatttgtgtgtgtgtgtgtggcgattgtaaatgagattaggttcttgatttaacgctcagcttgaacattattggtgtatagaaatgctggtgatttttgtacattgattttgtatcctgaaactttactgaagtcatttatcagttccaggagccttttggcagagtctttagggttttctaggtatagaaacatatcatcagtgaagagaaataattcgtcttcctcttttcctatttggatgccttttatcttttctcttgccagattgctctggctaggacttccagtactatgttgaataggagtggtgagagtgggcatccttgtcttattctagttcttgaggggaatgcttccaggaaaaagttctatttcacaagcaatcaaagaaatgtaaaacaaagcaatgaacatttgtttttcatccataatattaacaattagttaaaatataatattcagtggtggcaagggtatggtaagatagactcaagttctcactggaataaaatgtagtccatctgtagaataaagttgaacaatgtgctcttaaacccaggcattccatccttattcttatcataaaactcagagattaagatgggtgttaattatataaagtcattaatcaagattcttattgtacaagccagtaattgaaacaacttgtatatgcagcaagaagggaattgttgaccttatggaagagtagaatgatagatgccagcagctggaaatgggtggggggaatgaaaagaggttggttaatgggtataaacctacatttagacagaaggaataagtcctacatttaggtaggaataaacctacatttagatagaaggaataagtcctagtggacacagtaaggtgactatagtaaacaatttattgtatatttcaaaatagctaaaagggaagacttgaaatgttttgaacacaaagaattaataaatgtttgaggtgatggatatcctaaataccttcatttgatcagtacacatcacatgcatgtatcaaaatatcacatgtaccccataaatatgtataattatctatgaataaaaaaagaaaagaaagaggggaatggttacataagttataatatacctatatgctagaatggattttgaaatagttggatggcatcaccatataacgttacatttaaaaaccagggttccagccaggcatggtggctcacacctgtaatcctaacactttgggaggccaaggcaggcagatcacctgaggtcagaagttcaagaccagcctggccaacatggtgaaaccccgtctctactaaaactataaaaattagccaggtgtggtggtgggcacctgcaatcccagctactcaggacgctgaggcaaaagaatcacttgaaaccaggaggcagaggttgcagtgagctgagattgtgccactgcactttagcctgggcgacagagcaagaccctgtctcaaaaagaaaaaaccagggtccaacattaaaatgtacatgatttctaattacataaaaatctttgctaattcatagaaatgtgactggaaagaaatacaacaaagcactgataatcacagttactggacagtgggatgaacagtaatgcatatttctgtctgtattctttcctatactctccacattttctcaaataatcatgttttcttttttagaggaaaaacagcattattacaaaaaagaaaggagccaaagatcttaagtcaccatggctccttctattgcccgctgagctgtgtctcccaagctcactgaccttcagaggctttgttcataaaataaggacaatggtatctaagagtcttcacagaattgctgtgaagataaaataagaaaacgacatgctttgtaaattgtaaagcattgtacaaatgttagctgttactaacattataacacagaattaattccaataatctgagagaagagaaaagaaattcataataagatacctcaggctttgacataggaactaggaaaatacaagaataagctaagaatagaaagaagtaaaacatccacaggaatcctggagaatgttcactagcatatctcaggaagctcagagaaaacatttaacaagaagccaaaaaaaaaaaaattcacaaggcaaccaaatattaacagcactgcttggctaacaagccacacatgatattttgtctttaggttttttagctttctgttttgtttcattttgttttttcaagtcttctgaaaattgagaaatgatcaagttgggagaatggaggagttcactcattgtgacaggcagataaaaattagagataacttaggtcaaaatctattgaagaagcatcttgctccaaaagtcaaaatcagcacccagagggagaaaactggaggacagagagggcacttaatgatcacagggccaggactggactcagaaatgacaaggacccagcaaaaggattcaaattctttaccttgcaaaggaaaatgcctgtggccactcgttgctgcccactccttcctatacaagactctcctattcttgcttcttgagtgctcacctgtcccactcccctgcagctccctctctgacttcccttccctccccactccacactgtgcctgctctaagggtcctttttcactccctgctcttgcctatcctccctgttatttctccctgttctagctaacaccttcaaatctacatcttcatgcaggatcatttctcaacccccttaccatctctctaaatgcctctcagacacacacccccagaagccttgctgcccctggaaactaagcctgcagccaaatgcgtcttccttttttttttttttttttttttttattatactttaagttctagggtacatgtgcacaacgtgcaggtttgttacgtatgtatacttgtgccatgttggtgtgctgcacccattaactcgtcatttacattaggtatgtctcctaatgctatcgttcccctctcccccaaccccacaacaggccccggtgtgtgatgttccccttcctgtgcgtcttctaaaaaaaatgcgtcttctaaaaaaaacgcaaacaaaccagtgaaagtgggttcaatgtatccttacttgctagtcctaataacaattctgctagaaacaatttcctcttgtgcttcttcttctcatcccaaactaaactgatcatgtcccaaatactattaatacaatctttcatatttttttctaccaggcccttccacctgcccccatcccagtccagagattgataggtcactgtggcagctttctgattaccttctcatcactgcatctcctctccccaatcacttgtaaatgccactgtcaaagggagttttgcaagacaacactttctcctcacttggattctcccaacaaaggctttcaatgactaccttaaaggcctattagataaagaacaaatgcttttcctaacattcaagctcctgagtcctagctaagggctggatggatggaaatgtcttggccaagttcaagggttgggccaagatggtggccaacattagatttcaagcatgaaggctagggataccagttgtcatgagttaattgtgcatgggcagggctgttaatggtcaaaaaaagagtcaagtcttgggaaagaatataattgtcaacatttgagcataaagaacaacctcccaaagcagaatcattccagaaatggaaaggaacacagagatgagaggcaggagggtgggcttcagaaacaaggacagaagccaaagttggggccaaagaggcccttcccatgggcagatcagaagtgtgcttgctcagagcccaggaggctgaggttgggcaacatagtgaatgtgaagccaactctgtggagcacttgctccccacacagtgctcactcttctccatagaataaggcaagctgtagctctgaaaaagtcaagagtgtagcttctggaaaattaacctaaaagtatagaagccacccaaagcatagaaagcatccattcatcaactgatgaatggatagacaaaatgttgtatatccaatacaatggaatattattcagccataaaaaggaatgaagtatgttgcatattgcaacatgataataccttgaaagcattttatgccaagtgaaagaagccagaaacaaaaggccacatattgtaagatttcatttatataaaatgtccagcatatgcagatctctagagacagaaagtatcacagattggtgattgcttagggctgggaagattgggaggctaatgggtaataattaagaggtatggggtttccttttggggtaataaaaatgttgtaaaattgatggtggatgaatgtacaactctatactaaaacacattgaattatacactgtaaatggtaaattgtatgttatatgaattatatctcaataaagctgctttttaacaaaggtggcagttggttcaaagtagacttcaattctacacgaccaaagaaagaatcaaaaaataagtcagcaaggaaaaagtgaattttataacacctctatcctggcagcttgtggaaagcccaaagacgtgctatgtaatcttttctgtctccattgcgagattattttcttttctctgccccttggtgctacctctgcagcttatacatatttctgtttctccttcaatagcaatagattataactgttggccaccctggctgcttccctactgcacactgtggctctcagaggactgagactgttccctattggctcctatatctctagtccctggcacaagattgatgctgactaaataactgttgaattgatattaatgttataaatcctggtcccttttatctaaaaaatcttactatctgatgagaaactagtaacactagttgctgatgaggagaactcagtagttagggagagggatgggagagaagcattttgcacaccctttagtacctctggaatttcatgtatgtcaatatgtcaccttctccccagataaattaatttaatgttttaaattgtttaaaaatatatcatttattagcaaagacacagaattcatgcatttgacaaaacagagaactgtagaatgtgacaaagctctcaggagagcagactcagacagcaaactcttcagtgggaggcccaggggagtggaaatcaaagtccccaggagaccagagtggagagaattatagctctcttctcataattctaaggaagcaattgtagttctccattcattcttggtaatgacatcagggtttctctgccagcctcaacaatctcaccactgccagtctcaaggctgatacagattcatccacatcatgtggcattcacatccttgctgccatgcccacctgtccactcaggaggacagctgctgcagccagaaactgggagagaagacctcattgctgggcagaattactcactaactagtacagcatacgaagaccaccctcgccacacaaggagaggcacacctggaagcactggaagagaggctaacctcgtcccccatgccctttcctcctttctttgaaggtttttcccctctcttgggaccacttatgcaccttaagacccctggaccctcatgctgcacctcattgtccctaagcactgacgcacatcacagtgagaaaatagaaaataatgggacccaaatgtccccaaaagacaccagccctcacagggagccagcacctggttggggtacactttgaaatggcctgtagatgtctcagcctctgcctcctccaagtaagcaccctgaaagcagctctgcaactcctcaccattcatcaccagcccccagcatagtcccggtacatgacaggcagtatttgttgtttagctaacaatgaatgagcatgtagtagtgccatgcactgttgcagttcatttaatcctgacatcagccttaagaggcaaatgctattagtcccattttacaagtaagtcacagagaacttgaaatcacttgcccaagagcccacagctactaagtgacagaaccaggacacaaactcaatcggctacagaattctttagcttaactgaaatgctcatgactcatacaagagatattgaaagtgtgtgtgtgtcagggtgaaggtgggcaggggcaggggtagaaggaagaaagagaaagacaagaaaagaagggtggtaggcagggagggacagaggaggagaaaaagtgaggtggatggaagggaggccactaggtcccgggcacaggctttccaccttgagaggcagcaactctatacggtcagtaccctacagtccagagactgacccaggttgaacaaactctcaagtgactgatgaataagccagaatatcaatcagtttattagtttcagagagaactattacttccaagaaaaccagagtctcacgtccattggtgggaggtcaatgtacatgggaaaaggatcagcctcatctgaagcttgcgtggaaagcaaggactcggtgccagagagccacaggatgatgttaatggcttgtgtcagtgagttatgattgtctggtgctccctgctcctcctagacccatctgtcaagcagagcggatgtttctgtcagccagtcgggaccccttgctttggacaatgccggaaaaacactgacaaattactgctccgtggcatccccttcctctagaccatgcacagaccaccccactttggttaatacatttgtttcccagacgaggcacattgtgattgattagatttcacaattgattaggtttcacaatcccagatgtttaacttcattatgcatggattcttcttactaacataatctcagaggacaaccatgttctgaaaaataaaaaggggaaaaaaacaggacttattctcaggcctgttgctgctctcatcctctaagttggctctttgtctcagaaaagggtccagtttgtgtcttcacagtgtgaacaaattgggaactggttgggagggggacatgatgggatgggatgaaaaccaagcctggattaaggaggctgactccactgcagaggaatgagcttacagctcaaaaaactgtgatgctactctagttagtctaatttaatcctagctgcttgtgaaggccatgcataggctgcctagcttatcaaatttctctggtacagtacaagaccttataaccagtagcagaattttttggtgtcactactaaaagtcatatttaaatttaccaagcaccttctacattgtagatgttgtgtcaaactcttacacgcatgtgttagttaaccattgctgtgtaacaaattatcttccacgattcagcgtcttaaaacaacatgcatcgactgtcttgcagtttctgtgggtccaggcacagcctagctgggtcctctggctctcacaatgctgcagtctcatcttgaggctggactgggaaagactcacttccaagctcatgtccatgattattgtaaagatttcttccctcttgaattgttggactgagagttctcctcctcagggagcccccatgagcttttggctggagacctccacacttccttactatgtgcccttctccatagaccatctcataccatggcagcttgcctcattagactgagcaagtgagagggcaaggaacagtaccagtgacagaaagagagagagagagaaggagaacgctagcaagaaagaagtcacagactacagacttaaccatggaagtaacaaccccttacttcgctctattccatttgttagaatcaagtcactaggtcccatgcacactcaacgggatgggatacagaggggataaatactaggaggtggggattgttgggagccagtcagaagcacatgacctcctcaaggcaaccctgtgagatagatgctattcctgttctatgaattttccagatgtggaagctcagagaggttaagtcagttgtccaaagtcacatagcttgctgatggtggaatcagatctcacatacgaatctgattttataatcattcactgagttcagcttggtcaagtgattttcccatagtggtcccaatatcctatcaaaagaaggtcactcattctgtcaatgagtaaggttggttgcctctaatttagcatgagactaatttgaagggagaccaatttttggtggccactagcatcaggaccaagatctgggcctttccaattctggactttgaatctcagacttgctgcagagatgtcctgtgctcctcctccaacctggctctgtcaacacaaggcagtacctcactcttggtcactgcctggtttcccttccctattattgtagctgatgtttgtatatacagtattccccttagcaacctgcccaatgacataaccctgtagcaccaggcatagttcaataatgtctcataaacacttattaaacactactttgtaccatgaattgagtgatgcagagaaaaatcagacattgcacctatcctcaagacagtcacaaagtgtcttgattctagcattgtgccatccaatacagtagctactggttacatctggctaccaagtacttgcaatgtggctggtctgaaatgagataagttgtcactctaaaataacagtggatttcaaagacatatgaaaaaagtaaaaatatctcatcaatatttttatattgattgtaaaacaataatatttggggtatgttgaattaaataaaatatactattgaaattcatttcacttctttttagtttttttaatgtgtaatgtggcattccacatcggactcacatttgtggctcttgtcacatttcccttggaccaccctggtctagaggcagggagtcacgtgatacccacaattcccatttattgagggttcaccctgtgcctgtgttccacatactctctctctacatggaacacaagttatttcatctagtcctcataataaactcatgcagtagacatcattatttcctcttaccactaaagcggaggctcggtggactgaagcaccttgcctacagccacacagtaagtgggtgagcaagactgagaagctatggggctccagagtccatcagaaagaggaatacacacctgtgctgttcagagtgatggacgctggaatggagccacatggggaacccaggagaaagcatccaactccaccttggaaggccaaggaagacctccagatagacatgacgcttaagctgagtaagcccagaataaagatatccacgaagccaacaggcaggagagagctttcccagcagaggaagcagctggcgtgaaaccccagaagcatgaaactgcgtggtgcattcagggaacagtgtgggtttgacataagaaagtggagggagataagacgagcaacataagcagaaactttgcagtaaaagaactacacaccgtgcagaggggtttggactttgtcctgttgggtcagtagtctcaactctggccgcgcattggaatcaccaggagaactttttaaaataccaatgcccaggacccatgtcaaagcaattaaatcggaagatcataggagatggtgatgaggtggcccaggctccagaatttgttaaatactctctccagcgattctaatgtgtggctgggttgagaagctcttcatagtattaggaatttgcggaatagctttaagaaatgaagtcaaatgatcagagttttgtcttaggaagatcattctgagggttgcatcgaaaatgaattattttccattctccagtaactctggaagccgggaaaccaagcgggtttctactgaaatagtccaggtcagggatgctgaggcctgaggccacgtagatgaatggaatggctgtgggggttgaggtgcggagccccctgagagaggcccctgctatggttctgaccacctccagcctcaagcacttccaactgcctcctgcatctctcccactaggtgtcccacagacatctccagctcatcacatcctcattggaattattacattcccccagagcctgttcctgcaggttttcctaaggtttccttcattcccctcatggctccctagaaaccctccacccctccaggtccatcatcaactcctctccctctctcccctcttttcccacatccaatcaatcagcaggtcttgttgcttttatcctcaaagactgtcagaacagctcttccctgtcactccccagcccctctcttattcaggctctttcatttatggcttgaatccttgtgacattccctgtggcaatcgctactggatttggatgtccaaagccatttgaaactctgattcaataggtcgggtgtagggctcaggcatcacacacatgcacacacacacacacacacacacacacgcacacacacaaagagatataatctcccaaagttattctaacttcgttttagatatgtggttctaaaagtatgtccttgtaccagcagcatcaacatacctgggaacttgttagaaatgaaaattcttggacctccaccccaagtctactgaatcagaaccctgggggtaagacccagagagctgtgctttaacaatcccttcaggtcattttgatgcacattcaggttcaagaatcacctatccaaactactcatggaaatctcattcccacttgctaatgattgattttcagtgtgcacataacccagttctggccaatgaaacatgaaagaaaatcttccaggagggcttctggaaaaaaaatgttttctccctgatagaaaaagggagccatattttaaaaaaagctctttctccaatatgtatactttatgtgagtaataggacctgttctcatgtgaggctgtgatgcttggagctatggctgctatcctgggaccatgaggagaaagtggagaggatcacaggaaagctaatccaaaacctgatgttaaactttcaaattaatcaattctggaacttcccaatcttcatatctgatgcaagatcactgtcattcttatttaagccactcttagttatatactttcttacttgcagccaaaagcatcctgacttctatagcctcctgactgttatccatagttccaggctcttcccttcaaatctatcctactgtgagaaactgtgaagggtcttagattttaccctatctacaggctaacaactgagcatgaaccctggtgaaaggcataaaacttcttggtcagaggcaaaatattgtattactcatggtacagcaagcaccatgtttgcatcagttccccttcttctcaagtcacacagggacaacactgtgggcccatgtggtacctacacacccagtgggttgcattacaggagaagaaccccaagccaagggcccaaaaaagcagtaagcagcaaacaacaaataggttctcctcctgtcctcccaggtagggatggttaccttgccctacttagtcacctttatgaccagatacagaactgctcagtatcgagaaagagacaaaccctgcaatctgagacattcagcaaaaaagtgcagggaagttcagagctcatagtgaactgcctttccaacaccgtgtttatcttccagctagagctcccaaatgtccatggctgtagtcacctaagtccttgcctcagataccagcagagtctgagctagcttgagcccttaatcatcccttctcatttctggctgaaacctatcacaccctccaaaaaagactgactatgccccagcggctcaaggatactcaccaggcactttctcttacctccgcacagagtccacttcttgtctggcatcacagttttccagactttcatcttccaccaggcccctcctctcatctgcatctctttgaatttatgcttcagtgacagtctcagtcttgattccccttttggtcctacgtgcccagggttctgcattttccagggcagtccgagtctactttgttctctcaccgccagcaccctggacttccaccagtccagatgagagttcagacaagcggctccctgttgcctcctaagcacataacactcctcactctggaatcaaagccctacatgccctcctccaatttccttctctgaaattatctccaactatccctctacagtctacacactccccagggttcctggactatgtggttttctccatcccatctgttgtttttcccctctagacctttcctcatgatctttgctggatttagaatgtgctcttcctccccactctgctcctggggaaatcctatccctccctcaggcccatctgaaatgaagactttggtaaacctctgtacggttctctccctgctggccaggccctctgcttcttttcaacccaggggctgtgagcttctcttacagttctcatctttccagtcttctgtgacgtcctcccaggctggtctcattcctgctgcaaaataaaagctcacaaaagcagggactacttgatactcccttttgtctccctttctgacctgagtactgttgctagctctgttactaatagtgttctcccctaaatgcgtttgaacaccatgactgctttttcctaactaaagcaaatgagaaagccctgctgtgaactgcatccccgccatgctagtccatttttctgctgccttagataccagaggagggatgaagccttcgtgtcactgaaactgatgtcacttgttgagtccgccaaagggcaaataggcaaaatacaactctataggggaaatatgttgtgattgggggtgtgcaaactacacaatctcccaaacagtgtgctgagaattgattccaggtatatctggatacttcagcccttgcagtagctaggtggggcctggattgggctgagcctagtgggctgtaaaaacatcacttttgtgtatttatgaaaataaaaaggattgaaagcctagctttagggatgtggaattcctagcaccaaagggcctagcatcttgagggtctaatcctgcaaaggtttagactgtttcactcataagcaccaaataaagggaattgtcaatgaaatgaagataagaatgaggagttgagagggggacaggctatgctgaaaaatgtgatgaaagcttgtgtatggattgggactaggatggaatggctcagaagaaacgagatgggcataggtctagcatgaattgtggtaagaacaggaggcaatgggttagagagggagttaatggaatttgcgtgagctggaaatagggtggatggataggggagtaaggctccacccagaaaaacccacctggcttcctcaatgtttcctttcctccatccttcccagtaccctgatggatagctttgcacagataaattttgttcccagcccatgtccaaacaatatcacaaaatcagccctagccagttgtttctgtttacagccctgtctgtgattgatccagctctggaaaagcccatttatcatgaggaaccaaagcttcatggcctactgtctattttgttgctttattccctagcactaaatgggacttcaggacctcccacttgttccagtacccaatgacatgcctatatttccacactcagtttgcccttcccttcagcccctctagctctcagccttcctgggaccttaaataagtcacgcagctcctttcaccaactcttttcttgttctcgttacttctgggctcttctgcctttctatctcgtctccttctctcagcagctcactgtcctttccaatttcagctgaaatcagattccttctcccttgcctttgctttcccacctcccatggcctctcttatcatttattatttaactcagtcaccatattatgtatgcacaagagccatttctgaacatggtcggcatgaaaaaaataggacccaaagcagaagcaaacacctcttccctatcagtctcacagctccattgtcatcctgctccagtcctgagcaaggtccagcgaaacagccagatctggccaacacaccctcaagcccaattaacttcttaggttggacacagggaaaatttccagatggctttttacagatatccttcaatttatgtaagagatgccttcctggaagtggatgtttgaatgaaattccaaatggaatatcaggagggtcaggcacacaggatgtgtggttcagagacccaggttctattcttcttgagatggagtctcgctctgttgcccaggctggagtgcagtggtgcaatctcggctcactgcaacctccacctccagggttcaagcaattccctgcctcagcctcccaagtagctgggattacaggtgcccaccaccacaaccagctaaattttgtgggtttttttttttcttaagtagagacggagtttcaccatcttggccaggctggtcttgaactcctgacctcatgatccacccacctcggcctcccaaagtggtgggattacagacctgagccaccgcgccctggcctccagcttctattctttaatagccctcattaacttacttccagaacttgggcaagacctgtagcttctctagatctcaatttccccatttataaaacaagggagccagactatatttcctcaagtttctttcagtgtgaaaattcaaaaactcctattttacttaatgatccacatgattccattggagatccttcctacagttaaaattcagctctctcctcatcaataggtcattacggagcatgtgctatgctgctgcgcctcattagaagggaatgtagattaacctggtgaagccctccttttatagatgaagagaccagagcccagagaggagaagcacctaatcctggggtcacacagccagtgagaggcagagtcagtctaaaatgtacaagtcctggcctgagactactctttttttcctgtgtggtgttttaagcatgactgcaaatatttttatcctccttccatcaagaggtagatctatgtcccctactttctttttctttttttttttttttttttttgagacggagtctcgctcttgttgcccaggctggagtgcaatggcacaacctcagctcaccgcaacctccacttcccaggttcaagcgattctcctgcctcagcctcccaagtagctgggattacaggcatgtgccatcacacccagttaactttgtatttttagtagagatgaggtttctccatgttggtcaggctggtctcaaactggcaacctcaggtgatccgcccacctcagcctaccaaagtgcttagattacagctgtgagccaccacagcagaccttgtcccctactttttatttgaatgggtccttggcacctcccaccaatagtacatttggaatgaatgctatgtaacttccaaggcagggtgcatagaaggccatacagcttcagcctagctctcaaaggacatttattttctctcagagccttcatgtaagaagtccaatgggttgggtgctgtggctcacgcctgtaatcccagcactttgggaggccgaggtgggtggatcacctcggaggtccggagttcaagaccagcctggccagcatggtgaaaccctgtctctactaaagatacaaaaaaattagcaggatatggtggtgcacacctgtaatcctacttactccggagctgaggtggaaggatctcttgaatcccggaggcggaggttgcagtgaaccaagattaaaacactgcactccagccttgctctgtctcaaaaaaaaaaaaaaaagtctaacaatcctgagaactccatgctctctcagctgagcccacccgtaagccagcccagcccagctgccagacatatgagtgaaaaaactattggaagtggatcctccagcccccagtggttgaaagcacccccattccagtcctcccctgaaagatccacctctgtgcttttttctaacttctgacccacagaatttgggatcacaataaaatagtggttgtttcatgccacaaagctttggagcagttttttacatcgtcatagacaacctgaagaactagtaaactctcatgttggctaatattcttgggctcccttcccccaggtgaccaatgccaggagtgtgtgacttgcagcacatgtgctgaaggtggagagaggtagcctctgcctcctcacactgcacatcccctcacctgcctccagtgtggtcagttcacataggctttcactcctctgcccaggcaaagttctcctctctcctgccacggtcctttgtttatatcgtgagtgcaggcttgtcacacggatagcaaccagattatttatgtttgtcttcactagactacaggctctaaagggacacagctgtattctatgcatttccctgtgctgaggcctagcacctagtgggcgtgaaataaatacgtgtggaatgaaactgtcaaagaccatgtgaccagctggccctgaccccctgctaacaagcagcagacccagaacccctttctggttctcctccaggcagggcacagttgtttcctatctgagcaggctccatttgcttcacatcagcccaagaacagggaatgggaaatgccttgtgctgcaggagggaagacaaagtaagccagagagcacttggccatctggggctgggagcggaagagaatggaaccattctggagagccagacatttgttttgtagttgttgcctttgtgaatgtacatgtcctgaaaccctggttaattttcttgttcaaacattggtttaaaattgctggctctaggagagatactgtccttcagcaggttctgttataaactttgcaactccaaggtctgattcagcagcaagctggaaaagttcctggttgctaagagaccagagagcaaattagcagctcacaaaagacccagctaagaccagtaaaaaataagacaaacgaaaacaaggtaggaaatgggcctcctcaaaatcaaaataaggtaaacaaactggctaggaaaatgtctgattggaaaagacaattataagtattcttcatgctgaagtaaaatgcactataggtagctaaactctatctttgtctttttgtcacttgaagaaaacagcaggggagcccctttctagtcctgaaattccggatctatgagtcagagggaaaaacaaactgtcccagttgataaggaggaaagaaaaaagtgaaataggctgcctcttttatgagctctccctgccaggacggtgaatgggctacctggggtggtggcccagaaacattcctgcaagcaaacaaaagcctccccccaggaaaggtttctgatcactgctggtccaaggctcagccgcaacagagggctctgacccccacaggacttggccagacacttcaagatcccatctggcaatcaagcatgagaattcaggtacttgtaataagaaggggcaaagagaaaagtaccaaataggtcccaggtattaaatatttattttgttaaagtgcctctatagctatgatttttagtaatttcttttctggtcagacaatctagtaaaatattatattaaaattatttttaatcaaaaacagaaaaaagcatgccaatcacttacctctgatggaaattcattctccaagacacacagttttcctaagaacctactgcttagctggacaaaatagtaggaaaatgctccaagtggaaattaccagcctcttgagggaggagcttgaaaatcttaagtgatcacagaaaagtcacagtcatctgggttttggagaccagagaagaaatgaagaagggcaaaaaaaaaaaaaaaaagaaaaaaagaaaaagatggggtgtggggaggaagatggggaaacatggagctacaaattgggagaaaattaaggcagccagtaggcatatgtcagggagctatggcgtgatatgcctaagaactatgtgactgaatagcctccacttatcaatatttgttggacagcaaaaggatttcagaatatgatggatccaacaagcatgaaataatctttaggggaaaaaattacaattccccacatggcagcttccttcagatcttttctgacaatcctgtttgtcagatttctaaatcgcatgcaactgctatattttaggcagagctggtatcttcctggaaaaagaccgtcccaaatattcagtgcccctccctgcaggagaaatagacacctcctttctgatatatgcagctctggccaaatgacttgctttggcccatgaaatgtgagcagaagtcacatgtgtcactttggagtataagttttaagagctagcacgtggttctctggcttttctcttgctgtcacaatgaccagaacatgttccagatagtgccttatccaacaggcttggtccccaagagaagaaagcatggaacagagctgtggctggattgcagtggacacgtagcccagatgaaaaataagttctgttgtggagttacctgcaattgcagcaaaacctagcctatgtgactaatatacatggcccacgggactaaaaggtggccagagttgcccctcgccctcattcacattttctcactagctggccacagtctcaccttgagaggaaagtcattatgctccaggtggctttcttagaattcagatatgttgcctgactgacccaggaaatcagggctggcagccctgctgctgagcgtggttcagtacccaagaaacaggcaaagatggcgcacggagctgagaggagacagaaccatgaacttcgagttggaaatgccaggttggagctggctcaccagttctaatttaacccaaaaagaacaaacaaaaaacaaaacaagcaaacagaaaaaaaaaaaaaaaacactagaccttcttattcctacctttagaactttagagagtgttgatatttaaaaaaaaaaaaaaaaaaaaaaaaaggcaaacaaacaaaaaactgacccccaaagccaaaagaaataacatgtctttattgaagaaatgtccattcttccttcaaagcctctttcccttaacaaacgtggtatgcacagcaaaatggaaaagatgtcagcctccacagtacagaggaggtgagaagatctgcttcccagcacactgtggaaaggcagggcctggagcaaggctgtgacctcagctgcacatctgggtcctaagaccactggagggagctgtgctgagtcaaggttagagagcccttggcaagcagatccccggcaaggcagccaagtcaaagaggaagtttgaacacttaatgggacatcaaatgggattttccctgcaatctcagaacttctgctaaaagccctaaagtggatagcaataagtaaaagtgcccccgcagtctaaaaagaaagtgatcagaggatacctgcaggattttctcaaagatgagtgatccaatcctcccatcccacctccaccaccccaagagaatactagaagatttgcgagtccattgaaataggcgcatttctaagagtagggagttgtcagcctagtaggaaaggctagggtgtttctccatccctccctttccccatgaaggcaggaggaagatgtttctcccatcctcaagtgaggcacaaagatccaagagaacagcagggaggtcaggaggccttcgagagggagagagtgagtccaatacccagctgggtgctggctgagccacagaaaccagtaggctgacatggtgctccccagacaggagcttggggcttgcccttgcccccaggttctggaacagggaggctggcacctgctttttgtccagagaattgtaaaggaatgtaggaagctggctgggctggcttgcagtggcaagtacagagagggcatgaggtgggcatccctctcatctgggccacgtgaccactacggaatgtgtccctactctaggtctgataagacttcctcctaaaagggaagcccaggaactagaggcaaggtgtgggggaaggtggtaaaaagcagactaggccacctctccaaggcagacctagctcaggcttgagctgagggatggggaggggagaagcatagtgctgggtatgagattgaagttttgatttagcccggccacgacctttcaatgcttgaaagtgaggtgaggcagccaaaataaaactagttattataactgaaggtgaccaaaaagctgtgggctgtgcctgaaacaacgtcaagggatggtccagaaataaggaagagaaatgcaacagagagctagaaaacaatagttggagaaaaataaagccacctcctgattgtactccatggagtcacatcggtcaaaaaaccaattacaattggagggaaattcaccagagagagaagtgctgtctagagagtaactatgattggggagaactgcccaaagacattccattctccatctcattagagtatgcattctccagggtgtgaatgctcccaagtgctcccaagggggtggaaattggctggggtgggggtgtgaaaaatcttagatgtttcaaagttttatgaccctccaaagtttaatcctgcccaacaaaatagtatgtaattatttcttaatttatgtttactatacatttatttatcaatacatatcttatctctctataaatttatattattttatgttattatttaaaatagtgtttaggatagggaaaaaatgaaaggaagggaattttttttccttaggggaacaatgctgaagaaaagtctagaaacattgagttagagagaaacacaacattcaacctcaaaccagaactggtgtttggataaaatttttctggctccaagtagaattgctttcactgaatttgttttgatatcctaccttttgagggctttatcctctgcttcacaaggtgtccttttcatagggacccagaagagaacgttctttcaggtttcactgtaaagaaaagcagtgcttcttctggataaatggtttgtttatcttttatgttttatcttttatgagatttgttatgcacatctcaaattagatcaagtttccctctttgcttcagccacaggggagctcagggcaccttttgtaaccactgcaggactgggccatatgcatatctgggactttgccttatctgtgcttttagtatttttctacttttaactttgccccaattccctcaactgtgttttaactctttcctatttcatgtatttttataagccccctacaatcctttgtggaatatgtgggatataaatatgtaaagaggaacactacctctccttccaaagttttctttccgcccactcttattaagtctgtccttatacagttgcttttctttttaactcaatgcacaactaaaaggtattctattgggttttatctttttcttagttttccaggatattaagatcatcttgaaaactgattctgtaacccaacatgtttgccaactttgtgttatccatagtgttgaggaccatacctcccatgtcttcatccaagtcattgataacaatgttgaatggaacagggctaagacagacccctaaggtatgccactagagaccttcttccagccaatatcaatgcactaatcccctttctcttctgatatggttgaaccaacgattagcccaccacatttctgccatctgtcttctggctaagctacttggtcaaacatctctctgaccaaggagcctctgcctacagcattccttagacctgttactcttaatatcgctccccaaaaggaagtaggctgacactggatgccgggaactcaactctactgcaattgtgtggctgccacctctgcactggaaatttgatactggatcccaaaaataagaagcctgagttgccagctgcatgagtaaaatgaatacaccacccagagctatgtgtttccaaatcaaagtctaatgtaggttctcctcaccggtggagcctgggtcacatgactggcaccagctgcaaaaaatactaaaaatctcagttctctggattctgccttggagcagcagttcccatatgtcaggaactctaacaaggattagaatgatgctcaaaaagtgctaagcagtcagacatgacgaatgtccctagagcccaaatggtggggggacatggctgcccaatgagcccaggctccatcctgcagttctcagacccttctccaagctcctaggagaggaaagccagtgggctaaccttggacggggtgctttccagagacagtctcagctagtttgcaaggggtcaggcagtgctgtgaaggctgtcggtgccctcctgatgtcccctcagggcatttgatcccctcctggtgtgcttccacctgagtcagcaggcacctgagtctctgtgtcagaggactgttctcgggcagcctcagccctgggaattcacatcccctaagacaaccctcaatcaatatgattgacaacataaggattaaacattctccagccttctccatgatgaaacaactctgaagtgtgacttacaccattaacagacatcccctgtgggactcttccaaagttaccctcggggacactttgcttcatactcacttctttcccttctttcttccagttccctacgacctctggattttccctgggaacacacttcctaacactttcacacaaacctttgcctcagggtctgcttctggaaaccaacctaaaacaggaaaccatggctgccggaagtccatggtggtaaatcgggaattactagagaaggaatgaagagaagaccccaaacgtgtccgttgtccccctggttggaccccctccagaccaccttggttctgaatgtagaaacttaacctctaaatatctgcccaggccctgccctggtccagaagcagagctggaactcaaaaccagttttgctgaaggtgtgcaccttcccaacatccactggtgagaacatcccagcacactgctctgtaacttccagaattcattcctttcccctttttgaatgtcaagagctcatatgcccatctcatgtcattgagcgcaaatccctcccctataatttatcaaagattgatgacagtgactctgaaatctcatgtcaagtccctcccaggctgcacgacataattcatcagggtcagagccctgagtttatcacagctgctgctaccggctttactgcctcaatgcctgtccttgacttcaatcccctctttgcaatgtttgttctacccttttcaattggaagaccactttccttactggaaaagaaggaggtaaaatcatagttaggcagcacagccctcactttaccttcggcgaatgttaaatcattttctccacgcaaatctttcccttaatttttgcatgtagaacagagaacaatggggttcctcagagagttcagaacccctagctcatttgagacagtagattttcctaccccacttcttacaggtggggccacactgctggattcagcccttgccctctgtcacttaggggacgctgaaggctgttttacaaaatgtgaaccttcatggccacttctgaatcctaagccaactgttttcggacccaggctgcttcttctcctgctgacagctgtcactcctttattcccaaccacctctctacttaagagcctgactaaaagtttttttttttttttttttgagacggagtctcgctctgttgcccaggctggagtgcagtggcatgatctcggctcactgcaacctccgccccccaagttcaagcgattctcctgcctcagcctcccaagtagctgggactacaggagcatgccaccatgcccggctaatttttgtatttttagtagagaccaggtttcactatgttggccaggctggtctcgaactcctgacctcctgatccacccacctcagcctcccaaagtgctgggattacaggcgtgagcgaccgcgcccggcaagagactaaaagttcttaattatagtccctggcccatactttgaattctcttggcttttattcctgagggcaggcctcatgaaatcacccctttccatcactttaagggaaggaccatcctgcctcatcctcaggaagtaacatttttctgcaaggttagccaccaacaattgcctttagggtcatcaaatttttgagactctcaagcccagaagatgccctggttccctggcttctaagcctcttgcgtccctaatttcttactacaacttacccttccattcttgcactatttttttctaatctagctataagagagattcacttagtttctttagctaaatttccatttttcctcttcagctggatcaatgctattttaaaacaacaacaataccaggaagagtaaatgagaatctaacgaaaatagttatctgcagggtgtgaatagaaatgtagaaatgtagcaaaagggctagggatcggagggagacatcttctagtataccgtcttatatatgtttgatttttcaatcatttaaatgtttttacatgtttagaaacaaaattaaattaccaagagcgaaaaaaaactaaacctaaagatgagttttaacaaaagcaaatgaaacctaattctgtatcaaatcatatagaaaaattctaattcaaagaatttgggacacagtaccctgactatacacccttaatggaatatattctaaagagaataaacaccacaaagatgccttaaacctgactgagtaggtttgttcttagtagtataactggtgcagtaactctgaaatgatttgtgtgtgttgtagaatagagaaagttaatgaatatgttggcattttgagaaccaagttctcactgtgagagaaagaacacatgaatagggattgtgggaagggaaggaagaccctggggtgttggatttgaattggaagtatcaaagtaaatacaagatttctttttttgaaaaagtatttgctagctctatccactgaaagagcctagaaataacaatgctccaatggaatgagtgcaccaagcacccagaatttggttttttaatagtgttctccattgaaaggagccaggagccttgggagaaatgactgatccgattctggagcagagacagtacagggtaagcctaggatgtcaggttgcgctaaaaatcaagaaagtgctcaaattctaatggtgacatgtcaaaggagcacgggagccaaactgaaagggctcccaccaggcaaattttggacaatttgagttttaatatttgtaattaattatgacacatggattttttttaagttccccagttcatggtgatattcaaaagggtggggaaactcttcttcatgaaagaatgcctgttaatgaagtagaatgatagaattagacaattaccattttacaacgtagtgagttactcggctaagaatcatcggtgtattctgttaccattgaataaaaggttggtgagatattcatgcagttcaaatataaccccttcagattacttagtaagtaaaaaggggcaagggtgcaatggagaacagtggtggacaccacttaaccaaatgatcaaactcagcatctaataacgggaccaactgacatgaaatggcagccaatttctctacaatagaaatggcacggattcttcaaaaatctcaggaaggaccgagcacagtggctcacgcctgtaatttcagcactttgggaggccaaggcgggtggatcacttgaggtcaaggaattcaagaccagcctgacatagtgaagtgaaactccgtctctactaaaaatacaaaaattagccaggaggtggcgcacgtctgtggtccctgctacacggaaggctgaggcaggagaatcgcttgaacagggaggaggaggctgcaatgagccgagatcatgccactgcactccagcctgggcaacagagtgagaccctgtctcaaaaaaaaaaaaaaaaagaaagaaagaaaaaagaaaagaaaaaagaaagtcaagaagaattttaaaaaatgatctattctagactcaaggataataaagacacatgcaatgcatgatccttgaatcaaggagggaactacaaaggacattgtggggacaatggaggatatttggatgtggatagtatatgaaatagtgctatatcaatattacatttcttgaatgtgatatggtattgtgaaggagagtatctttagaagagatgtgctgtagtgtttaagagaaagtattatgatgtctataacttaaatgattcagattttttagaaatatatatatgctaggtgtggtggctcatgcctgtaatcccagcattttgggaggccgaggcgggcagatcacctaaggtcaggagtttgagaccagcctggccaacatggcaaaaccctgtctggcaaaaccctgtctgtactaaaaatacaaaaattagcccagcatggtagcacatgcctgtaaccccagctactcaggaagctgaggcctgtaaccccagctactcaggaagctgaggcaggagaatcatttgaacctaggaggcagaggatgcagtgagccgagatcacgccattgcactccagcctgagcaacaagagcaaaattccatctcaagaaaaaaaaaaaaaaagaaaaaagaaagaaacatagataaatagatagatagatagatagatagatagatagatagatagatagatagatgatagatagataggcataggcatagatagagagagagagacatggctaatgtaagtgaaacgttccaggtgttcatcgtactcttctttcaactcattcatagatttgaaactttttgaaattaaaaattgaagtaggagaatgctctggcttcacctcaaaccatttaagtcaaaatctctaggggtcagcccaagtttcttttatagcatttctccagaagtgtttactgtgcatccagggttgagaactactggcctacctgattcatgatgatgtccaggccctcagaccctgcctcagcccccaaggaccctgaaaataagtctcttaaaggtcacaggggcatctgagtctccagcaggcccttgcagccctgagtcagtagcccaggctaaggaggagagagtaaagagtcttcatagaagtgtctgcttagcataggaaccctgactgcttttaggtccttctggcttcctcctgccaggcctctcccttctcagaggcccctctgagataaccctcattctgccccttcaggctgcctctgaaaacctcaggcctctcttcctcctcccttgttcataaggcctccagcaagggaccttgcatggcacgccctcaataaatgagtgccaggtgagccgaggtgggctcactcacactgtgcctctctcactgtcaccctcaggggggaggaggaaaagcccatatcaaacatgggcaaagggttttactttgtccaaaaaaaaaaaaaaaagcagaagctgaaggtcaaagaagcaaagagagtgggaaggactctgttctttacaaagaacagagtcatgacacctcacactggacccttgctaggtgtaggtgctgtggccgcactgaatctgtgttatctcataaaatcaacagcctagccttatggggtgggtcatactgtcattgtcacttcacaccatgtgtccccagcatcacacagctggaacctcagcagtctcggaccaaagcccacacctctagccatggtgctagactgcctacataggacttaaggaggagaaggaaagcaagagccaatattgatgaggcgcctactaagatgatcttgttgaattctctctgcagccctgtgaagtcaatcttatcttcttttgatgaagctgagcaaatggactctgagataaagtaatttcattccatcatgttgaacaagcctaaaatgtatcatgatctgcattgtcttctgtatgaatggcaatctctggagttgtgcaacccaggatcaagagtgacttgcccagggctatgctgccagtaagggatggtctctggatttggaagcaaggtctctcagactttggcctccctggaaaagccctgctgtcccctcacccccaccacctcaagtgttctgttaccagacatctctccgcagggatcagaacctcccttctgcagggagaagtgagtcttccactgcgctgccatcaaggaggtgtcagaaccctgagctcttctagacagacctcagctgttgaacatgtgaagaacatgcctttctgcagatgatgaagtgggatgttggggatgagaaagcagaggcagaaaagtctgaggcatgccccccacaattcagcagactgtggggtagtggcactcatagctaggatgaccagctcatcccagttttctcaggactttccttgttttagcattgaaagtcccacatccagggacaaccttcaatcccagtcaagggagatggttaatgtcttggtcagcttgagctgccataacaaaatcccatgatggaataaaacaacagacaaatttctttctcacagttttccaacatcgaggtgctggccaatttggtttctgttgaatgctctctccctggcttgtagaaagcatcttcctagcgtgtgctcatgtgggctttccctggtgtgtgcacatggagaaaaagtaagaaaaagagggagaacaagagacaggaagaaagagagtgcgctcaggagaatgctccaacgtctcttcttaaaggacattaatcctgtcatgggggccctaccctcatgacctcatctaaccctaaatacctccaaaagtctatctccagatacagctacattggggtttcaacatttggattttgggtagacacagttcagtccacagcagttgaataacctacttgcagccaaatccctcttctcaacccctggtccccgagatgcccaaggggagaaggctatctattcttccagaaacccactcagccacaacagctagtagatgaataccttgcactggagtttctggttttttccagattccaggcctaaggaaccctaagtggtgcctggctttcgtttccaaggcagagtctcctaagagtgggctgggtagggagggtgatcctcaaaactcctagttgctatggataaggttctgagagaccacacatctgtacacaaagtcacacccaaatgcttcttttgtgggcctttccagatgccccagtcaagagggagaaaaggcaaggaggctgtgcatagaccagggctagaatcctggctaacactcacagcctgcataacttccccgtgcctcagctttctttcctgtaaaatggggatgcattataagggttagaataaaatgggtttcaagtgtttggcacctagtaattgttcagtaaatggtaatcatctttatttctctcctgcctaccttgcattccctccattccccctcccctacctttcccattttttcattcattcaacaagtacttattgaataactactatgctgtagtcactggggatgcaggagtaaataaaacagtttctccctccaagaaacttacatcacggcctgaaaaaactaaaagaaaaataaatatgaaaataaatatgaaagtgacattatgtgatggttcactttaggtgtcaacttgactgggctaagggatgcccagatctttggtaaaacaggatttgtgggtatgtctgtgagggtgtttctggaagagattagcatttgaattggtagcctaagtaaagaagatccgacctcaccaatctgggcaggtatcacccaatcccttgagagcctggatagagcaaaaaggtggaggaagagcaatgtccctcctctccctgagctgggacaaccatcttctccttcctttgaacattagagctcttgatccttgagccttcagactccaaaacttacaccactatccttccttctccctggtttgtaggcccttggcctcagaactataccactgggtttaccagtgaattattatttaccagtgaattataccactggctttcctgggtctccagcttacagacagcagattgtggaacttctcagcctccaaattgcgtgagccaattcccatgataaatttcctcttatatatacagatggtccccaaccttcaatggatcaacttataatttttcagctttacaatgagtttataggggtgtaaccccatcataagtcaaggagcatctggacttataatggttcgacttttgatttttcaactttacaagaggtttatcaggatattaaatacattttgacttacaatatttttgacttacaatgggtttaccagaatgtaggcctattgtaagccaaggaacagctgcatctaaatatatcctattggttctgcttctctggaggaccctgactaatacagactacgatagaggtgggaatggaggccagaggaggcaggagagtggatgaatctgcagcccagattcatctagaatggataaatggaaagggatgaaagggatggaaaaagatggaagccaagagagaaagagatcagaaacataaattttggaaccatcagagtcaagatagcctttaaagccagaagtagatgagatcaatgagggagcaatggtagacagagagaacctctgaggtctgcagggctccaaccttcagaggttgaggagacaaggaaggacccctaaaaaggggtcacagctagagacaggacattgagggagagggcatcctagaagtccacactgcagaagatctgaggggaaatgggaagagaggtctggagagagcagtgtagacagctcccctacagtggagtgtgtgcctgggagtcggcatcccagctgcaaggagaagccccaaacggtatggccatgtttcttttatctctgggtctccccaacacacagtaggttctcaatcaaaatctactgagttggcatcagttagatgtcctgtttatggctgaggcaaagtctggagatttcccctacctctcaggccctcgctgcaggcctctgacactccagggatagctggcaagcccacaaggcctccctgagggtccttctctctcagaaaatatcagcacatgtgtccagcagggcctttgatggcttcacacaagaggagagtcatgtgtgcattcctggctctctggacaagaaataaatgttcaggcggagagggagaacttggctgaagtggaggagggaattgaaatcactgaacaaaataacagcaacaccaataacaaccatttattgatctcctgttctgtagcagacgctaggacaaatgcagggcatttgttgacattgtctttcatctcagtccagttcagtccatctccagttacctggtgagggaggggctgcaaaccccaccctacaatgagttaccctgctgcctgaggccacatacacagtagctccaaggctgatgttcctcaaccactgtgtgaagatttatcattgaagaaaggagagatggaggtaggaatagcaaaggctaaagacaaagctaccccaagcagcagcatctccttccatgacttcaactccactgacaccaggctgacctgggctttccctttgcctttcccaccatcacctttgctagctggtgggactttcaggccaatgggttacatgtttagaaacaaaattgggcagtgggctggggccagcaaccacagaaccttcctcctcagccattgtcattaagtaggcagagatttcctgaccttgtcagtagccctctattagtccattttcatgctgccaataaaggcatacccaagactgggtaatttattaagaaaatgaggtttaatggactcacagttccacatggctggggaggcctcacagtcatggcagaaggcgagaggcacatcttacgtgacagcaggtaagagaggaagagagccaagtgaaaagggtttccccttataaaatcatcagatctcatgagacttattcactaccatggaacagtatcagggaaacagcccccatgattcaattatttcccactgattccctcccacaacacatgggaattatgggagctacaattcaagatgagatttgggtggggacacagccaaaccatatcaagcccctcagccaacattttcatggtggcagctgctcatgaagtgtaatctaaaaggacataaaaaacattcatacacacatacacacacacatacatacatatacacacacaaacattcatcacacactcaaaaaatctctcccattggctcacctcagcacctgaaattctgccaatttaaggtcctgtggagaccagagtagttgttatgtttatcaatatgtgtatactcactgcacttcagggaagctggagtttaaaggctggaggactaggaccaaagaaagaacagttgtgctggtggagagaaaaggaagtgagacaagctgagccttgccagagaaaaggcagccaggatagtgcagaagagggaaaggtggaggctcccgaagggatggaagccaagcatggaagaggaaaagagtcgggtctttttctgctctcctaagagttctggtttggtatcgtggttgcgagtgtgagatcaaacaaccaggccgggagcagtggctcatgcctgtagtcccaccaggctggtcacctgaggtcaggagttcaagtccagcctggccaacatggcgaaaccccgtctctactacaaatacaaaaattagccaggtatggtggtgggcacctgtaatcccagctactcgggaagctgaggcaggagaattgcttgaacccaggaagtggaggttgcagtgagccaagatcacaccactgcactccagcctgggtgacaagggcaaaactccatctcaaaaaaaagaaagaaaagaaatcaaacaaccaaggcccaaatcccagtggtgtcacttgctaattacgtggcttaggaaattactcaatcctcctatctgcatccttaaaatgggaagaatgacagtacacatcttgaagggtgatcttgaggcttcagtgaggtaatccatgcaaggaccttagcacagttcccagaattgaataaacacacagtaaatgtttaatattattattaatatttaactgaagtctgcggcctgtttccaccatcagctcctccagccatgagttggagtctgccaaggattttagagttcattgattctctggatgtgaatcattgtaaacagatagattggtgtcttctgtttggagacaatatctccccttcttccaatggcagaacatctggtgacttcccaggagataaaagggtggagtacaataaaggccagaaacctggttctccctgagggagcagaatgagaggaataggtcccggtggcatatgctgctttccttgaccttggcacctgttccaagctggcagagtgcagaggagggagcactggggacacagaaattggtgtaactcctacagacagcaatgtgctcatagctcaaaattttaaacgcgtgtccccttgaccctaaattttggtttctaggatttttttttttacagatatgcccccacatacaaaatgatgtaaatgcaaagttattcactgcaggatttgttatgacacagagactgggaaaaaaatctaaatgttcacactttactgaatatattatggtccatccatacaatggaatattatgcaacagtggaaaactgtgaagaaatgtctataaactgattatgaaaagatctccaagatccattgttaagtaaaacagcagggtccagaagaatgtagaaaaagtgagaaaaagtaatatgtattcaatatgcatagactatatattcaatatgtatagaataacaccaaaagaaaactcaagagatgataatattggtctctgaagaagggatccaagaagccaaaagacaagatagtcactgacttttctttcatatattttgaattttaaaatgctgaagacaactaaattttgtttacaagcacgggacttggagtcagacagacccaggttcaaaacccagatccactggctatgtgatgttgggcaggtcacttcagatcactttaatctctttgagctttgtttcccatttgtaaaacaaggatgagaataatacctatatcacagggtggttgtgagcattcactgagatggtatttttaaaaatatcctatgtggagacaggcatggtggctcacacctataatctcagtgactcaagaggctgaggcaggaggatcgcttaagcccaggagctcgaggttgcagtgagccaagatcacaccactgcactccaacatgggcaacagagtgaggctgcctaaaatagaaaacaaaacaaaatggggaggtagctacagcaaagatgacttttaataaatttttgatgaatctgcatttattcccttctatatgcccaggagagcattataaggtaaggttcaggattgccagtagatggaataaagagaaatgaaagtaaatatctatcttacaaggagtggagggtggcaggtccctcagtgcatgtgtgctgaggaattcgcatcactcacatgtgctgaagagtccatccagctcaccgtttataatgccagggtttgcggggggcagtccccatcaccaggtcattggatcctcactgaggaccctatgacatgaacaagctggagactcctggtgccattttacagataagctctcccagggagctgcatgatgggcctaatgttattaatcgaacagacatgagtggagaggcagtaggtcagtgtgaagtgagcataggttctgggaagaaaacaagttctggttggccatttaactgtgctgagcctcagctcctgcagccacaaaagggagatcataacaccagctgcaaaatgttgtgtgaatcagagcttcaggcactgtgaccaagacacgggaaagctcagtcaatggaagctatgattatttgtgtgggattatgattggaggaaggcagtggggctgtgtgcccccaaaagtgccttaaccactcaaaaacagaatctctgccatgaaggagttcacagtctaataagagaaagagacagatcatctctattcaataaagttccccctaaataaaaatatggtttacatcagttagaatgacgatcattaaaaagtcaggaaataacaggtgctagagaggatgtggagaaataggaacacttttacactgttggtgggactgtaaactagttcaaccattgtagaagacaatgtggcgattcctcaagaatctagaactagaaataccatttgacccagccatcccattactgggtatatacccaaaggattataaatcatgctgctataaagacacatgcacacgtatgtttattgcggcactattcacaatagcagactttgaaccaacccaaatgtccatcaatgatagactggattaagaaaatgtggcatatatacaccatggaatactatgcagccataaaaaaggatgagttcatgtcctttgcagggacatggatgaagctggaaaccatcattctcagcaaactatcgcaaggacagaaaaccaaacaccgcatattctcactcataggtgagaattgaacaatgagaacacttggatacaggaaggggaacatcacacaccggggcctgtcatggggtggggagcggggagggacagcattaggagatatacctaatgtaaatgatgagttaatgggtgcagcacaccaacatggcgcatgtatacatatgtaacaaacctgcacgttgtgcaggtgtaccctagaacttaaagtataataaaaaaaaaagaaaagaatgttcaaaaaaaaatacggtttacacaagtgtattcctgtatatcatggtctcattataggtgtagtgccaggtgttcccatcggccatgattaaaaatatcaagaggtgggtgtcaaggagtggaagggtgggaaggccggaagcaaagcagagaagtttgcaaagatccctgcaacgataaatgaagatggggaggagtcaaatggggcctccaaggagcttcctttgcgaggcattggtgaggagggagtgcagtgagctgtgtacgagaggctgaagcagggacctgggcctagggcaccacagcaagcatcttagggagggggctgacaactgcagccccaggtgtgctgataacatcacatgctagtcctactttcctactttatttttcttgcgaaccttaattattccagagactgagtcaacaaacaaccctgaatcataaagtcaaaaggccttcacaaaaggatgctgatattagcacattgtgaacttactctgttgggaatgcgatctttcagaacaacccaggagcagggtactattttcatcccacccttctacagacgaggaagcagactcagaaagattcattcatgtctgaggtcacacagccagccaggggcgaagccaggattcaagccaggtgtgtctgatgaaaacactcctgctcttcctcacttcactgtaggttttgaacatactttttttgctgctgtgaaggaaaataaatgcagatgtggcagcagtagtatatgaatctatgcatgtgataaaacgtcatagaattatgtacaaggcatactaaaaaaaaatgagtacttgcaaaaactggggaaatccgaggaagatctatgatctagttaattgcattgtgccagtgtttgttttctggttttgataatgcactgtaattagtcagatgtcacctttagggcaagctgggagatgagtctacagaagctctctttttgcaatttcttgtgagtctatgcttttttcgaagtagaaatctggaaaaaatacatgtagaaatctcctgttgaaaatacaaacagggccagagtaggaccaaggagactcaacagctcctagtaagtaaagaacagcaccagggcattaccagggcagtaggagccttcattccaaacgttaagaattacaaaatgatacagctgcccccttacttacaggactcttgtatagctttattttagggtaacccaagttttccagattcacctggctacagggggggctcacctttacagatatcactcatgtttcaccaatctttcccctccttgctatgacagagcttccagcccaccccaaacctcacccacccagtcactgctggggccctctggaggtgtctcacacaagcctactggccagatgctgtagtctgctgctcacctgctaccctgtctgcaggtgccctctgtgcccagaaattccagggtgttgcgtcagcagggcccctgtgccaggcacagaggtgactagggtctgtgcccaagaatggcctctggatcttagcaaaccccaacccaattccactggactcccctggcctgaagcttctctgcattccacacagaaagtgggtggatgcccactgaaggtcaatcttgattgcctggcaccaaagcagggcagcatatgtccaacagagccctcatgaaaactgctcccaaatcctccactctgaggtttagagatgtgtgcaaggttttgaaacacaaatgcagttacagtaagagctaacatttactgagcatttactatgtgccagaccaagcaattcacatgggtaaacttgtctaattctgatagataggtaagctgctgccacaaagagacccatcaataataacccagtggcttaaagaagatagaaatgtagttctctctcacataatctgagggagtccccctggtcagcagcagctttgcttcaggcagagtccacggcccaggttctttccatcttgtttctctgccatcccccaaaacgtcctcagcctcatggtggcagctgggtcattgccatgcctgtttgcagaccaggaggagagaggcagcaggcacgaggcatgctgatcgccccacatcactgggcctgggactctcatgcaccactccactcacattctgctaatgagaacattctgcaggtgagaacttagttacacaggctcacctaactgtagggagtctggggagatggggatatgtgtgcccgagcaattcttttacagtgaaagaagagaaaatgtgttctggtggaccattgtccctccaccacacttcctcacaggtatgaccaaagatgttcagaatggttaaatgcttgccctaggtaaaaactatctaatctgataagttaattttaaccagtgaagtagacctggacccctttcagataaaatatgcgttttgtgtgttttaatagggatccaatggagatgcaaaacttaacccagaagcatagctctagcgggagatacagggtcgggggtttggcagggctttttgagtggcatcatagtccgggctttagaacggggagtcttgaatgagtccaggtccttcatatgggaaaaccactaaaaatctcagccctcagctctgagacagaatccagggtgataatggatgtggcacagctagtgagctgcaagtggctgtcacatgtagggggttattttttatctaaggggatctgcacatcccaccaccaaagctgccttttgggaaggtaacaggtgaccctgtccaaggtctgggctgaggatgaacaagtttccaaaggtgagctgcaaggagcttgacaggagtgtgtgtgtgtatctgtgtgcatgtttgtgttcgtgtgcacacatttgtgtgcatgtgtgtgtatatgtgcaaatgcacacgagcagcttcagccagctgagcagccagtcatttattcatatggatgacttgatttttgattgagttaacaagtacttattaaacacagttttgcaaaggcctgcagtaaattggaagctatacaggaaccctataagtttttacaaccctgcattcttcaaatattggaataatataaaagataagtagggagtaagaggaaggaagagcaaacactagagaaggaggagccatgggaaagtgggttagaagagaaggaggagggttggttgtccttctggtttcgaagcaccagtgggtccattcaccaatgaatacaaaccaacctattgtgcaaattattaaactacatcatctgtcctagtctgagctaatattcactacaatggctcatgttgctgagtgcttactaagctccaggcactatactaagtgttttatatattctatctcatttaaccctgactaccctgaggactggcactattattgtggctctgttattagcctattttatgggtgcagaaatgaaggcagacagatgttaagcaactgactcaaggtcacacagctagtaaactgcagactcaggcctgtctgattcctaacctaaccaccatgtctaacacttgttgcccataggcctcagtctcctcgtttgtgaaatggaaccactacatccagctttgcttgccctatgggctgttgcaaggatccactgagaagtgattgccaaggtgcactgtgaacttacaaaacctaatgtaaaagaatcaaaccacattgctccaagttttgctaagatgaatctaccttaggatcatctagagaataaaacagttactagcaaccaagattaaattaagcctcctctgtttggaaacaactttagaggaaggatgttgttgatttgcctggcagagaatggttccaagcctaagagctcacagttgtttttatcccaaccgccttatcagaatatttaggaatcaataatgtagtggcatgctctgaggattctcaagaagtcctatggcgagccccacatgcagaaaaactaaaaacccctggtcaataatcaacaccaacttgccagccattgactgggtcactgtggaagtggatcctccagccccagtcaaaccttcagatgactgctgcctcatggagtccctgaaccaggaactgctcctgactccttgagccacagacacagtgagagattataaatgactactgtgtgaggccactaagttggaggggttggtaatttgtaatacagcaatagataattcatacagcacctatgataccttgtgacttaagtacaaggttattgggtattaaccaaaattctagttttcaagcaagagaaactattctggtacatgtaagccaaaggggaattttcagggagggcgtcagggctcatcaaatccaagaaaagactggagactcaagtgtaggatcctctggcaacagaactccagctccagttcagggagaggaacagccaggtttccacacctccatggctccagagagccactaatcattccacacatcttgatttagtccgttcagactgccataaagaataccaaagactgggtggctcaaacagcaaacatttggttctcacagttctggaggatgggaagtccaagatcaaggttctgacagatatggtggctggtgagggcccttttcctggttctcagaccaccatcttctcattgtatgctcatgtggtaagaagcagagagaaaagaagcaagttctcctgtgtctcttcttataagggcactaatgccattcatgaaggctccaccttcatgacctaattacctcccaaaggccccacttctgaatagcatcttattgagggttaggattttaacaaatgaattttgggggcacacaaacattcaatccatagcacaacctccgtgtactcactgaggattcagtgtctagagtgacagagacattgatcatgttccagccccctgactgcaccaagggtgagagaaagcatctgccccttggtattatttccctctgagacaaatcccactagggaaagatgattcttgaaagcaagtcatggtgcttttagagaaggggatgggatgctctgcagccaacatcaataaatgcccagccagtggtcattagatggtgttacaaagaagaaggccttgaataatactgaaccaggctacgtgtaggctgtgggctttatagtcattaatcctcacaataatcttaaaaggaggatgatattatccccgtcatccagacaaggaggcagaacctcagatacattaagtaacttgccagaatccacgtggaaagtgatgaagctggcttctaagttaaagtctatggggttccagagtccttacttgtcccacataaccaggcttccaagaagggcctcaagggaatggaaccacattcttgctttgatgaagtcaaataaattaaaaagagtttattaagggaaagagacagagactgaagtaaagggttcacctgatcttctcccaaggaagaatgtgcctgagtcatatctgactggcttgacccagaaagaagagggtagtcacaggcagaaaggaaggacaacacaggcacacagagacgggcggtctccagaactcaaaacttcccaagggtttacaccctgtgtactgaacatggtccgcttctgccacctagccacagatggtctcctcagccacagcacaagaagcccaactgtggtgaaagcctgtgggtgggtatgcagcaagcacaagccacatgtaaaggctttcctggtaaatttccaagatgaccaatgccactgagtcctcttctctgtcatgtgccttcttcatatttatccgagattcccagggacaggatggccagctcctcctttagattagggagggtgggtccttccccacccccatctatactctctgccccactaaagaacttttctataatcccatcttcaccatactcagcatttgccaaatattattcttcattttctaattgtgtcttttctagtttgtttggaaatgaaatctggtttcacctgaaggttgagagctaatatgaagcatattcctgcccttgggctaatatctttatgacatcatgacactaaccagctagaactgacttagtttttgttggccagaagccataacatctctgccaacaagaaactagcataggctggattaaagtcagcatgagaaagattacctgaagataagaaaataaatgaaggcccaccatgcttctaagcacatagtaaatagtcaaatatgtgcagaggagatgcataaacatatctgtgcaaggctttcaaaaggatcaggaagacaggtctcacaaaaaaagcatttccaggctttgtattttacagaccaatatttttgtgttttgttttttattttggggaggaaaatccacacaggattattatctttttactttaccaagtagagacattttaataaagctttaccatcctttcataagataatagacctgttaacacaagccaagtatgaagtataatcacagaataaaggacagtctttccagggaaaaatcatcggcacactggatacgggtctttgttttacactatatagtccctctctggctagtttaagcacaaacaatatattatggagcccagatagatagttcacaaatcactggaaaggctgtagggatatactccaagttgaattccatattaacaccccaaactatgccacgtaacttaccactgagggagctgctgccacagccgctgaccactctagctcctcaaaatgagcaccagctctgtgccctgttcagctccctccattattccaaattacccctccatattccaaatcaaagtcctgcatgagtcccagctgattggctgaacctaagcatatctagatccccatctgccaaggagtctgggaaacgtagttttagttttcagcctctgcagtacagggaggcacaggggctggagaaggcatggagtgaaccagttagccactgttggtgagctttttgtcagaccacagcacttctaaaacatgtcaaggtctaagcctgggttacagaatcacatttgggtgtactggcatgagagccatcctaaggaatgtgtgcagtcacgctttattgagaagattctgaaggtcagtggtcttacacaggcaccttatcaaggttctgacagatatggtgtctagtgagggccctcttcctggttctcagaccaccatcttctcattgtgtgcgcccatgtgataaaaagcagacagaaaggaagcaagctctcctgtgtctcttcttataagggtgctaatgccattcatgagggctccaccttcatgacctaattacctcctaaaggccccacttcctaataccatcttattgagggttaggattttaacatatgaattttaggggcatagaaacattcaatccatagtacatcctcagtctactctgctgccagaaccttgatatggcacctactgagtgaatggctgttcttaagaagggaatttgctgcctgaggctacagcatgaccacactctgactgtagtagacatctgtcatatttgtggcttctcatcaacttttgagtagctttcccgtatctggggatattctcatgtaataagtctcatctccctaatattgaagtcagagatcgagtcagagttcagagcgttcaggtgtctttgcagctaagattcagggatgtggtctgagctctcacaacccaaggcctccactagagatttgattcagaagtgagtagcataaagagcaggcagtgcacggagcttctgtttttgctggcatggaaggcagcagaggccttagctttcagaagtggtggtgaggggccgggcacagtggctcacgcctgtattcccagcactttgggaggccgacgggggccaatcacgaggtcaagagagcaagaccatcctggccaacatggtgaaaccccgtctctactaaaaatacaaaaagaaattagccaggcgtggtggcgggcacctgtagtcccagctactcagaaggctgaggtagcagaatggcgtgaacccgggaggtggagcttgcagtgagccgagatcgcaccactgcactccagcctgggtgacagagcaagactccatctcaaaaaaaaaaaaaaaaaatgtggtggtgaggtctggttcctgcctcagaagtagcatcagtggtggtggcaagagtggctgcaataaagtcaagttcctggtgtccagtgctcagtagcagcagccatagtaataccagtttccctccatgatctagccctacagcacagtttagggcattgttcttggaaactttaccccaaatctatttctccaccctccaaatgattgtttgtccttcagtttcctttattaaatcccatctgcctcaactagccagagtgaatcctgttgtcagcaaccaacaacccacttgatgtgctagataagccaggaacactgaccctgaatctactgcctctacaccaggctgcagtgtgaaccatttctgcaacagagagtatcggcctgaacctcatctcccattgccttcttgagtcaggtacaaagaaggatgggaggaaagcgtacttccttctgactcccagctttccaggagctcctacagaacaagaatgtttcttcttcactggattgttatcaccaacaatttgtgcagggcttagcacagagtaggtattcagcaaatgtttgacgaattaataaataagtgaatggtaaaaacactataaagttatacccagctggattcctaacccagatctgtgctgtccattaacagtacccactagccacacatggccactaaacaactgaaatgtggctagtgcaattgaggaactgaatttttattttatttcagtgaactaaaatttaaaaactgatacctaatcccatttttggaaaacttttggctcatttgtgtatgtaaatgtacattttagctataaattgtataaaagctgaatacagatgaaatctttccaatgaaaaattagcatacaaattgagatgtggtgtaattgcaaagtatacaccagattccaaataatataaaaaagaatgtaaaatatactattaatgttatattgattacatgtggaaataatattctgaatatattaggttaaatgaaacattaaagttgacttcacctatttctatttacaatttttgatgtgactactagaaagtgtaaaattatatatgtggctttcattgaatttctgttagcacagatctgaacattagcataaatattgctcagtggtcaaaggggatgccaaggacacacatttcctctgagcactagaggctccaaccccacagacctaggcccaaccttaccctttcatttccccatcgcctttccccagactccaaatccagcaggaggaagtgtagacgtgggcctctgcaacatgtgaaaaagcagaaatcacaaacgcagtgtttttcagcaggtgatttaggcaactcttcatcagggaaagggctggaagtaaggccacaagcagtgatcaattgtttgctatttgaaggcaattcaaaaagaaaaaaaaatccccaagtgaacgttccttgggtgaccagtgtgccacctctgcataagtctatgaaatcaaaggccctgggacagcctctaatatggtagcttcattccaaggaagagtttaaagcacaaagaagagctgttctagttagtatgagtcagggctaaatgttaagtctcctgatgctcactggggcacaccatctctcagcattaggtgccaatacataacatgccaaatgggtttgatgtgagaaaggaagtgtctgccttataggaatcacttggcctgcatctaccccaggatttccaagcctccctttgccagcactggaaacgcattttgagaaattggagttggggccagaaagcattctattcccatcactggaatctgtgtggcttctatttgcaactccagtagatgtgaaactcttaaaatgattttttccagggtaggaaggaacacaatgatgtctttggctaaacagtgccgggctactgcacagttcaatcctgagctaagtgaagggggaaaagtccggggcactaatctggcgtgactggcagcacccgatggggtaaggaggacagatgagaagggtaggagaggactggtggggataggggaacagggaagggatggaaaggcctgcttctgaaggcttgcatctaacagaaaaggaagggaacctccctgacttaccatgcgggacccaggtaattttcatactggaagcacaatctacaaaatgcttccctccaacccatccccataggtacaattttaccaaataaaatcattcatactcacatccaaatttgccaatctgagcaaaatatagttagtaacaaaggaaggcaattttcatattttatcattcatcatagaaaaaaagctttaatattttttaattaaatacagaagaaaattgtgttgccagagagattgtttgcctgcctttgaacaaattaacaacacctgtttgcaaacaaaagaatttccagaatggagtcaaaccctttattctctgttcaggacccagcccattcatgtcttttgtatacagtatcaaacacatagtaggtgctgaataagtatctgctgactgaatggggtgcctcttttatccctatcctttatttcccaaccctaaactggatcttgatccatggggaaaatatccccacccatccattcctagagtagccctgtctctttcaacagtctttgatacataacattggtttagagacatatgcctgaagggaaaagagggagggtttcaggcagagaaagaaacacacaaagacagggcacagagactaggcagaaacaaaaagatctaagacagagagagagagtaactgaaacacaggtgcagagcgggaacaactgtgggagacagggacagaaaaaccaagtcagagaaacttaaaacgcacaccattggagataaagagataaaagggctgggccagaatgatcatcttgaagtttctactcagctttaatgttttctgatagagaaaatggcagagagagaggaagacacggcctaagcaggaggataaagagacaaaggaagttagtagaggcagaggcagccagccaggcgtgcctagccgggaagcctggtcctaccccggcctcacacccacggggatgggctcccatgcccactttcggctcctaccttaagtccagccaccctcttcccctacccgcccctaaagatctccaaaccactcggcaaatcaaatcctctctccccaacatcctccgtgaagcattctcgctgctccagcccgcactcagctcttcccctctcaactcctaaagccacacccacctcccctaaccacagggcagggctgttttcgagtttgcccttggctcctatgagcacatcttgactcctgcaaaagaactgtgtgcttgtcagggctccagaccctacctcctatattccagtattcttcatgacaccagcccaatgcccggtcttcctaagtgctcagtgaatactttagggcctgaccggccctaaagtgcacgcggggaccgtggccgtcccctggtcagtttggcaggctggccacgctgaggccatctcctgggctcctgcgccctctgccggccaggaggggacccgcacgcgggacagctcgcggccggaagggcgcgcctgctgctgggaggctggcgaggacgcgggcggccctggcaccgtccgagggttctgggaagggtggtgggcacagccaggaacagctgctgtgttcctcttaggcgtaggagaacaacccctctcgcccctacacctcctccggccctgcccgctgggcgctcagagcttctcgtccagctccaggccctggttatcccgggcgcccccgcgctcggggcctgggctgccgccgtgtgtcccactcaggtagttctggatggcggaggcgcagtctagccgctccatgacggtcatgaggtagtgcagctcctgcaggctgccgttctgctcctcaaacaactccaggatggccgctgcggggctgcgctggcaggacaggaacctggcccgaggtaggggaggaagagaagggtgtaggagcagggaggggctccccccctgctgcaggctccctgggctgcgcagcgcaaggtccgtcccttccccatcctgtagcttttgtccttgtcctgctcttgcctgccttccagggcacaggaggtgggaagccccagggctttgaaacttgagattgtcctggcttggaggccaactctgacccctactcctctctaggcttcagtttcctcttattaagatgagggcttagacaagaggacctctaagtttgctacagttctgatgttctgtaattgccttctctacctcccccactccaaatacacccctagcctccccctagcctcctaactccctccttcctccctctctcctaggccacaacatcctgctcactactaaggaaacagttgctgtaaaccatggctttttatcacgactctcccgtccactaaaaccttccagagtctctcacctcctaaccagcccacgctccatgagcctttctggctcatccagcacctggccttgccctgtctttatgctttctctcctttctcccatcctgaacccccttagctcaggcctctctctttctcgccttgcacacactacacccacagccacctctgctactccccaaaacaaaatggctgatctcttccccatcacttcctccctgaagccctttctagttcacccctcccaggtggaagagaacattctgcatccctcagttcagacttctggtcataacgcccgcagttcattattattcttgcttcagctgttttctgtctctcttcaatgtgttatacaatactggattcttacaggaaggcacaaggaacacttgcctttatttttcaagctctctgaaccctttactagtgtgtgcgctcctaggcgccgggaccatgcctcattcatcttgtatcatagtgcttagcacagtttccagggcataataggtacttgataaatgtttaaatgaatgatttaaaaatccaccctgtagtttgcagaccagcctggccaacctggtgaaaccccgtctgtactaaaaataaaaaattagctggacatggtggcgtgtgcctgtaatcccagctactcgggaggctgaggcaggagaattacttgaacccgggagatggaggttgcagtgagccaagattgcgccattgcactccagcctgggcgacagagcaagactccgtctcaaataatgataataataataaataaaaatccaccctgttttcagggtccagctctagccccatcaccaggataaagtcttccctgaccgctgcactcatagtgtagtttctggagcttagctcagtattctcctgctttctgagttccttgacagggatcatgactgcactgtcaccattattgataacatttattgaattaacaagtgtcaggcacccagctacatgctttacacacattatcctataatctgtcttgctcctcctcagggcatagcatggcaagcactcaacatgtaccaaataacttccatgttaatggattcactgttaaatgttaattgagcacctactatgcaccaggcatcattctaggtactgatgatacagtgattaatagagctgcccttttatgggaaatagggtggacagtagccattctctgacttttaagtcactcccttgcctgtgatccagtctccagagtgtcctgaggaaccccattccagcccaccctcctctaccatccacagacctcacccctcttcctaccggatcttcatgccgcaaagccccaggtgggaggccagtctgcgccagtcattgccggtgatgctgtttggctccaataacatccgcagctgctcaaagagctctgggggcagccttaggcagggaaaagggtgttcttggaagaaagggacaaacagacccactctggttctcccatatgcaccctaaatgctgtagtcaccctgtgggtgccagggtaggaacccaacatcccccaggcagcagcccaagcaacccccgtctcacctattgcatgggggcggctgggaaacaggtggtggcgctgcccaggattcctcctctgatgcctggaatctgaggatttccatatacttggtctccaagccctgagtcaacacagggcagggaacacacttaggggtcacaagccatccccctgagtaagaagctggagtcctacctccattcctcatgtctctccttcagtctgtcactcagagccaccttaccaggagatacaaccctgctccacccagcaccctctacccactgtctccctgtgacttcagaaccgcaccttcagccttatgtttgcccctgagctctttgggaactgggacatgaagaccagagtgcagcctgagccaccaggggaagtcctgggtggggccgtggagcagtgggaggtcatccaaccatagagacactgatctcagccatatgtgtaccttcctccattccaaccttcccttcctcttctccaagtgacaacagggtatctgcctgccctccactaaggtgccactatggttccccaaagactctcaactccgatttcttcgcatcttcccttggtgcagcaggagaggagagatacctaactcccagcctgcctactcaagaccctcttcctggtcacttcccacactgaaaatacaaaacatcatctctcaaatcccacactgaagataccaaacatcatctctcaaatgtagacaatcagcctagaaagaaaccatatcaacttgatgccccagttctctgagttgggagaaggggttaaactagggtttggttcttttagcttcctgctggattcatccaccgatagacaaggagagtcagggatgagggtaacttggagcccagatgatctcagcccctcaaagagctggtatgggggctctatggaaagtgccatctttacctatgtgattaagaccatagttactgggcaccagaccctgtgcccactttgcctaggatttcccccaggccctgcccttcctctgcccctcagctccaactcacatcctggaaggtgtgcatggtgacaatgatctcattggttagtgctgaacagtcctcattctcatcggctataaagagaaggtgacagcgtggccagtgagtgaggaaacggcctggggtaagagcaggagaaggtaagggactctatagtaagacttgggaaatctgaggaagctggggtccaacactccatttttctctctgcaaagatctgtgtggctcctggcctttcagggaaggtctgtgtgcatggctgcatgggggtctgcagagctccagggttactgggagggaaggagaggagacaggatgggaaaagagaggggaggaggtacacacagggctcccggactacctgcttttctccggaagcagaaggagcggaaggggcactttccatgccagatgtggagatggggaaccagctggcaactgctgtcatccacattctcccaacctggtgagtaggcagacagcagagggcctcagagagtggggccttaaacaagtattgaagggggctgtggggaggcatgaggacagaacaaaggcaggagggtctcaagggaatgggaatccccagagcctgggctgggaccccaagagggcccttgcactataaaagccttccatcctttcctgcttctgtggggtataacccctctccttcccacctgccacctggcatcaccctgtccaaggagtgagtggcaagggctcagtagacagcagagtggtcaaagccctgggggctccatgaggctactgctggcccagaggtcacaaacagacttggggcctggtgtggtggctcacacctataatcccaacactttcagaggccgagacgggtagattacttgaggtcaggggttcgagaccagcctggacaacatgatgaaaccccgtctctaccaaaaatacaaaaaaattagccaggcatggtggtgggcacctgtaattgcagctactcaggagactgaggcaggagaataacttgaacccaggaggcggaggttgctgtgagccaagatcaagccactgcactccggcctgggcaacagagcgaaactccatctcgggaaaaaaaaagagagagagacttgggatccccagatctccagatgtccaggggaggcccagaacccttcattcctgtggggctcccgatcatcctatcccacaggccactgcctccctcaccctctgagatgtacgtgagcttcaggcactggtcgcccctagccccattgaagtcgaagagctggcagggcccacgcaggcgcccaccatggggctgctcgttggtcagtgcccactgcagggcgcagggcgtgttgttgaggaagtagatacgcagttgcagatgggactgtcctggcaccagcggtgagcagaatacggccagctgcagccatttgcgggcttcgcgccccacaggtgcctccagcacacaggtgtagaggctgcagagggagccagtggcaggcactaatgtgcagggaaggctaagacaccaacacactgccaccagcctcctgccacctgaggggcctctgtggggccttcaaggaggttcagagaacactcgaggggagcacttagggaggaactggtaggttggggatgaaaagtgagcatgtcacagtgactggtgactgaatggggaggagagctggcaggggagagagggaaagtgggctcagggtgaccatgcttgggagggcacccgcacatggccctattcctgtcaatgggtggcaaggaggctgggaggcagaggacctaggactctagaaagacaaagagaagaaggacagagatggaatggagtcttagagaactggtgctaagcctggggacagtcctgaaaggggcacagtgtagagagagataatttgaaagacagagagagatgggaaagacaggtccctcttagatggagagatggtgctgagtcagacacttccagacagacagagagacagcaatgggatttgcagtcatggacatgattgatgtgagaaaaactgctacaaacattaggacagaggggccagaaagagacaccaggggataaaggatttgcagaccatcttctatacagagagatgaagataaggcagacagagaaagtgggcaggaaagacagtcctcagagagatgggtgtgggaagacaggccaatggcatgtgcctacctgaagtgggagaggtggatgcgacactcatcccgggaggcgtgggcccccggccgccccaggggcctccataccttggcatccagcagggtagtgttgctgctgtaggtgcgagcatggctgggctgctcggcacagtgtttgaacgtgagagtgcaaggcttcaggaaggaggccccatgggggccacatgccaccacagggcttaccagcccctgggcttgggacagcgatggggcgtccgacaggtcccacaccaggatcaaagacacccgctcctggcggcccacagccacagcacctggcagggagagggagagctgagatgggcctggtaggcaggcacacccctgcccctgaaagaggccaggccagagagaaaggaggtggggcaggagcccaggagagacccccagcagggcacacagggaagtggtatgaacaagagtaagacgactgtggagctgacttgtagtgtaaccctaagcaagacacttccctttccacccaggctgctgctagcccatagtgtgccttgtgtgaatttgcaaatggtgctcttccctccctttactagagaattgtcacagcatactgattcattagaacaaggcactttacttccacctgccaggaagttgtcccaaaagatatgtaatatgtccatccctgaagtcaataaagctatactcaaaatataaacaattatcagaagtaaaaggtgtctatgaacattgctccctcagatgtggtgacctaatgtacagtctgaccaactgtatgcggagatgagagccaggagctgttacctggtgggatgagcaaggagatgcctgtatcctggagcatcaggcaaccgccgcggtgatccacctctcgagccgaaaacaccaacagtttgtgcatcaactggcggaccatggtctggccttgagtgggtgtgtgtagctcctggtagaaggcaaccatctctggcagtgtggctggcaggtgctgccttgagacctcattttctagttggggggtaggctgggacactggttcctcttgaccattcagtgtccagcaggcccccagcagccttctagggcagtgccatcgaaggcattgggccagaaggaggacacttgccactgggacccccaccagcagtaggaactgggagggttggaatgaactctcctgggggcacattcgcctggttactcaatgccgctggctctccttcacccctgtgccagccaaagccaaaggcctggtggggaagaaggggtcagtgtcagggtaagcccttttaagttgtggaggtcaaggcttggcttacacatagctgcaagttgtcttcattccagcgcacactgcacactttagtcacaccaattcttttaacctgtctctcttactcgagaacctaccctggctccccgtgacctaatacatcaaggtaaactgttctgaagcagagtgagcttgggtttacagttagagaacatgagttcaaatgtcaccttggtcactgtggctgggtaaacttatcatattgatgtaaggcaggagagccccaaaattggggcttagtttgggagggtttgtggcttcacctaggcaagaattcaagggtgagccagtggtgtcagacagcaactttcactaaagtggcagagtatagcagcagcagaggtatgctccttacagagcagagctaaccctaggcagtgtgcccagggtagcagctctggggcatttctgccatcatatttatgtccacttttaattacatgcagtaaggggtgggttattcagaaatttctagaaaaaggagtggtagcttcgggtcactgccatggaaaggggcagtaacttccaggcatcgccatggcagtggtaaactgtcatggcactggtgggcatgtcttatggagaggtgcttttggtgccttttccctgtttcagccagttttctatctggcctggaatcaaatcccacctcctgcctcaatactgcttaatgtacctcagtttcctcatctgtccaaatatctaccttgatctacaagtgctgatacaaaaaaatctataagtggaaaaagcaagtcgcagagagataaaatattctgagctcattaatgtgaaaaacaaaactgcatataaatagatacatatttatgggtgcatatatggaaatgtaaaggtatagagaaaggtctggagcagtggtgtacaataaaaatgtaatgtgaactacacatgtaattttaaatttcctgatggccacattaaaaagaacaggagaaattaatacattttatttaacccaatatattcaaaatgttatttcaacaggtaatcgatataaaattatgagatatttttactttcttccttcatacccagtctttgaaatccatgtgtaatttatatgaacagaacagctcacttgggactggctgtatttcaagtgcccagtagccacgtgtactaatgaatccggtcttagactgtgcaggtctggaaggacacacccccaaactattcccatgagtcacaacaaattgagaaggtggaaggtgtgaataaaaactttgtatttttttaaatccttttctctgtactttgaatttttcacatcaagcatgtagtttgtattaactttgtaattcttttctgaagctattaaaagtggggaaaaagtgcctctttgtgtaatggtgaggatggcataaggtcatgtgaaaagtatttgtagatgagaaagcactgtccaaatgtatgtgtttctttatgcccctccttctgccagaaaggcctgaaggtagctcacagggataggcaacatacaacaagaacaacaaaagctaaaagtggaagcaaaaaaaaaaaaaaatgaagaagacaaaacacaaagatgcagccctacagtgaagctggaatgaggcagggcaaaagcatacactcacctcctgctcacctggctacccagccaggccacaggctgagacttcccagtagctcttcctgaggccctccagaacccacctccgcctcctcctacttcccctcttccagcccctacaatttccaacacgcctgccctgtagcctgcccaggctccccacacctgcttaattctagcctctggcttttgctcatgctgttttctgtttctccactcacttgctctccccacttgtttcctctccctacgtggatcctcccattcaatagtgcctcccgctggtgcaccggcctttgacagcctccagctcgcgaaatctctctccacagccatcccaccatactgagtcactcttgattatgtgctgtcatgtgtgattttcccactcaaatgaacattttctaagcaccggctgtgtatcggacactgtgggaagttcaatcctgccaaagatgacgtcttattccgctctcaaggagcttctgcaggaatggaattcattggcttggtagctgagttctgtgaggcacaacgtcctccttcagagccctgggaggcccctctggttgactcactagaggctgcactggaagagcttccagtatccagtcctccccacgcccttcacttgcactacccacctggaactgaggcttggcccaccttcttccttccaacctcaggacccatgaaaactgaagccccttcctagtgcctcttagaccagggcagaacctccactgtatcctcaggattgaagactggggcagtacctgtttctcccatgtcctcactgaaagtgtgaataagaagcgggggttggcattgttctctttgcctaaagagccaacccagcagacaatgcaccagcctttttcaaccaggcatcctggagggcacacaggtgaatcagtgaattggcagtgtcccaaagctgatgggaagggggttggagcagcaagctaccgttgatgtcccatcatttcttttggttctttcacattagtaataattataattccaactgtaataacaatagctaacattcgcagagctttactcaatgccactgtgttaaagcactctccatggcttgtctcatctcatcctcacagcagccttaggagcgaggtgttatttttatctccatttcacagataaggaatccgagctttctccccacagtgaagatggatagggaattactaaacaactgaagacaggcaggaaggaggagcaaagacgaacaaggacttccagagataccccctttctctctccaccccttcttttccccaagtatcttcctttccttctctagaagaaataaagttggaagagaaagaagcaaaaatgaagtaaagacaaatagaaggacctaaatttacatcctcagttatgtggtaatacccaccccactacaccacacccccacctaccaaggtaccagtggcaggggatggaattgctaaagggatgaaaggaggggccccagctcgcttacacagcagtaaccttcctggggccaccaaagaccagagtccagatccccagtgaggtgcacctcactgggtggtgcagtagagtcccctggctcaacctccgaccctggagaagttggcatgcaccactcccaaagccccactgggcctctcccagggtgactgctcttccaggctgccctggccctcactgcatcctccctctggctccagaatggggaaaggtccggagtcttgctgaatggcaactatagcactgcagccattcgagtgtgacttggggcatcccaaccccatgcctggactcctcattacccactcctccagtctgtcttgctccagaccccagatcaccctgggtagcgggtccccgaaacgagagtcctttagaatgctgccatcacctgtccctaggcagttgcatcctccagcacaaagatccaaactcctgctgcaaagttctgctcataccctttaagaaaactctcaacctttcctccacctcactggttctccctgtgcctccccaacacctgatagatgtccagttactgcagaacataacaagtactgggatggatggtccaaacccaagtcatgaatggcatttgttagtatagtagacatttccgcaggacacagaatcatcccagtggtcctcatacccattggccaagtcccattttcctcccctcctccagcagagggtccctacactccagcaggcaggctaagctggcctggctcctcccccgaagctccaggtaaccccatcacaatgcccatcccctctccagctgccccaagggggtgctcaacttaccgtctaggagctcttagaggctgctggctggtccagttccttctccgagaaacaagggtcagccagattcagtcggcaggccagcagacaagtggaggtgggcggggaatccaggcaggagtggcctggcatttcctggcagagccctgcctcccagctgtctaaagaggggtgagggagagtgtccctgtctattggcaaagtccagcccaggtaagggattagctgaggatcccagaagtcagtgaactttccagtctaggtctggaaggaaggagggaggcagggagacaacctgggtgtaggtgctgcaccttgaaacccctccttacagtgccctctgctggtgagtggctgtccccagccagaggctattattaaaatagcagataggaggaggagggaaccttcatctgagtttcttaaactataatgtgcacaacagtcacctgggagatcttgttaaaatgcaggctctgattctgtaggtctagtatggggcctgagattctgcagctcaaagaagctcccagctgatgccaatgcaaccggtccaaggagcttagagagcatctagttccacccgctccccacacagagaagacagtggagccactgagacggttaatgactcaccagttgctggtggacctgagatgtacccatatttttccttacacaaggtgctttctacttcccccacccaaagttggcagagacactgccggttgggagacaactgaactttggggccatttgccattctgagttcttaaaactctgcctaggagcggtggcaccacaagaatgaaaactccttgtggaacttttcccatgttttcggctgtctcctcagctcctggtacagcctgatagatagaaggtgttcaataaacatgtcttgaatgaatgagtgaagcagttgagagggaaaaggatgcattttggctccaactggccaacactgagcccaggtgagccacacgttgggtatgtaatattgggcaagctacttaactcctctgaacctcaattcccttgtctgtcaaatgcagttaagaatatctaccttgtgtgagataataattgtcattattgagctaataaatgtcaaatgcccaccacagaatgggtggtcaatagatggtaaccgttgtcaccagggtctggcctcctgcagttgaggaggcatggtgaacgcccccccaggcccctagttatcatctcccatagaaaataagtaacttcctctgcttttgtctcagttaataattctctagcctcttgtctctgactgcaatgccctcccctctgcttccttccctggtggaggtgagagggtggaataaacctcccaggggagcccagtaccccaaagtgcagagatggtagagagcgggcaacctgggaagcagacctcatgcctaaagacaagccaggaaggggtgctcagaactttgatagggaatgaaaggagtggggtaggggtgtttgtctttgttgaacaaagctctgtctgagtcacacaggaggctggactttgccaacagacagggacactctcccctacccctctttagggcggctgggaggcaggactttctgccaggaagcgccaggtcactcctccttgactccccacccacctccacttgtcagctgccttctcctctgagtcataaagtcctaggggtttgtgaaagatctgtcaagctagggttctaagccaggaaggtcatgccaaccaggaggctataaccaggggctgtgttcatggattatgaactcacttcccaagctagttcttgccactcttggggacaatcccaattataaggaggctctgaagaaatgtgaaggctcctaccactcactcccatggccacagagctggttcatgggatgcaaagaccacaggcatcaacagcattataactgggggctgagctgtcacaggagggccagtgtcaaaccctcaccacaagccctcaaacattccatcaaggggtagcctccagaggccaggcaccaaggagggtctggcagaccagaggggctcctcctgagaggaactctttggggccatgaaacagcaacttggacttcccagccagtgtcaccacccttctcatctgagaaaggcagatcagcagggagcaccactccaccctcctcccagccccaccctcctcccagccccaccctcctctgccttccacacatcatatgtcatcaggccccccgcctgggaggtgtgctgccagaggtaaggggagcacaggcctaggaaccaggaggcactgggagaggcaggtgtcaggagaaaagaggatgggggcagggaggggcagggagggggcctccaccactggacagaaatgtagaaaaacaggaaggcagaagatgagcaaacggacagtcaggagcacagaaagacaagtagaaatatgcacaggtgggcatgctgctcagctctgtcccagaacctccaggaccagtgtccctgacccttgacagaaaaggatggattagggccaggcacagtggctcatgcctgtaatcccagcactttgggaggccaaggcgggtggatcacctgaggtcaggagttcgagaccagcctgaccaacatggcaaaaccccatctctactaaaaatacaaaattagccgggcatggtggcgcacgcctgtaatcccagctactagggaggctgagacaggagaatcacttgaactagggaggcagaggttgcagtgagccgagattgcaccactgcactccagcctggacaacaagagtgaaactctgtatgaaaagaaaaaaaaaaaaaggatggattagatagtcagtccagaatactgaaaataatcagattgttttctctccttcaaatctggttaatcatggggggaggctgaaatatcatgaacaaatgagaagaatgatatttgtggggccttggtggggccttggctggaggagggtctgtacattgtcccacatgcaaatgacatgcaaagcaacatgccaccttggcagctttttaatcaaagaccaggcagttgtttccttgaaaagtcaggccacaagaaacctggatgcttgtgcttacatcctgacactctgggaatggaaagatggagcaggaagctcataccccatggctccaggggtagaagagagctaaaagttcagaaaaaggaatccacggtgtcaacaggccaagtttgaatttgggcaggagatcagcctgggtgggccccatgagtgtgccagtctgatatggtgagataagcctgggacagatgtgctgccgcattcgtgactagaaaagagtccccaggaatttctggctcctgccttcagattgtgaactttccaggttggtagatcagcttaggtagaacagttctcggtgagggccagctacatacctggctaagcgctgcccactgcagaaaagctcatcacccgggacctgatctccaggactcagaagcacttggaggaaggcctattcacttagaagcagttaccagtgctgggcagtgtcctccaagtgccagaggagtgctgtggagaaaagaagtccatggaagccaggagatgggcaaggtgtggcctggggttggagagagctcagaggtacaggactggagctgggccagggagagaggaaggacctccgtgagtagaccttctctgaggggctcaggccaggaaatgagtcaggttaggaggcagagacagacgaggagccgcaggggaaggctcatcactagcatgttctctgcctccccagattttgcctcttcaaggtgaatgcggcttcaaggggctatctttgtgctcctgccccacctggggcccatcctggtctggctgttcactcgtgatcacatgtctggttggtgtgagggcccgaggatgctgtcctggtgcccattctacaaagtcttattgcttgtacagacagccatctactctgtcgtggggtgagtacttgtttctcacacatggccctggtacccaatggggtgggaacaagtcctctatatctgaattactcccatatattggcctccaaaggtaggcgctttgtcttgcctctcaccaccatagtgggtcctccagaaagtaagaaaccctctatgcctgcctggggttccagttagcccttcttccaccctctctaagtctccccagcccctcctccacctcaccatgcccagctcctcccaccaactccctccctggcccttacatgatgcctaaacccatctgcccccatttcagcccacaagggtatccaagagtccttatgccagagagcctcctccatttgccacggaacctcctcccactgaatgtttttgccaccatgtctccacagctatgcctcctacctggtgtggaaggacctgggagggggcttggggtggcccctggccctgcctcttggcctctatgctgttcagctcaccatcagctggactgtcctggttctctttttcacagtccacaaccctggtctggtaaggcacacagtgctcagtagcagaagtaatgtgggagagggtgaaaccacctggctccagaagcacataattcagcagagcaattgagtgcaggcaggtaatgggtgggcagacttctctgcactcccatggtgtgcacagagccccagggactgagctcgttgctgggctgggtactgcagaaaggtggaggtgctggttctcgggcagccagctgacccccggcctctatgcccaggccctgctgcacctgctgctgctgtatgggctggtggtgagcacagcactgatctggcatcccatcaacaaactggctgccctgttactgctgccctacctagcctggctcaccgtgacttcagccctcacctaccacctgtggagggacagcctttgtccagtgcaccagcctcagcccacggagaagagtgactgaggccctagggcatgggagaggagggacgcccagggtggggaggaagagtctgcaagcagggctgtggagttagggttcaccccaatgggaccaccctcctgggtcccctggtgccgtttttccttagaaatcagagaaatgggaaagggggggaaactgattttacacttaaataataaaatcctattagtaactctgaaggtatgatgtgaagtgtgtatttgaatgcataatatgatgactagggcggcagagtgggatagaagcttctggacctctgtgtgagtgtgtgcgcgtgaatgaatgtgtgaaggcccatgggggaggggtgggcacaccagctcgcctccattcacatgcctccccacctggcataaagatttagcactcagatgtttaattacctgaaaaacaaaaggctttttaaaagtgacaaaaaagccaaaacagaaaaatacaccttaaaaaagggtactagggggccaggagtggtggctcacacctgtaatcccagcactttgggaggccaaggcgggtggatcatgaggtcaggagttcgagaccagcctggccaacatggtgaaaccctgcctccaaaaatacaaacattagctgggtgcagtggtgagtacctgtagtcctagctactcaggaagctgaggcaggagaatcacttgaacccggggaagaggaggttgcagtgagccgagatcatgccactgcactccagcctgggtgacagagtgagactccatctcaaaaaaaaagggggggatactaattatacatgttaaggttatatagtatatattatacattaatttatatatcagatttatgatgcaatatctagttataacatatactatggttgtatgatatatatgttatacatctctgataaataagattatagaccttcttttttgctttcatacattcctatgctttccttattttacatcaattaattactattagaataaggcaaagaagattgaaaaaaagagattaagcctcagggtgctgacaggtgaatccataggagcttcttgttcagccttctatcttgcttctctttttctaaaccttcttagtggctttttaatttttgactcctcccttctctgattttcttctgtccttgtttcaaagccctgatggtggcaaggagtgaccgcccttgagtaagcctcctcaaatctttaacaaggtcagctggaaggcccagacaccttgcagtagggggtctccacctgctgcatgatggggatcaccagaattgtttaaaaatcctcatcagcctctccaggaaggaggcctgggcatcaacatttttaaaacttcccaagacctcctcaggtgcagccaaggctgtaccacagctgtttggagctatttaaaaaaatgcatgttcctcagaccgcactcaggacccataaatgagaacgttgcgggtgggctcttggcatcttcagatttaaaacctcctgagcacttctgtcagctgctagctagtttgagtgctttgggcacagatcgtttatcagggcccgtttagccttgacactctgaggttttgtgagctgagttttagagctgaaacaaactgtatgctctcaggtgagaagccagtaaggcagcataatttgagaagaggagtggctctttccagagctcacccaagagagggagtctgcagcctcccctcctccaccaagggcatgctcagcccagtgggtcaggtcacaggcaccccaggaggacacacacagtgtcccacccacctttgtatctccagccccaggacagggcagagcacagagtaggtgcttgtacgtttttatttgttgattaattgaacgaataaatgaacacattgttgtactttaaaaacaaatgctgaccagcacctgccgccacccctacccccacccctactctggaacaactgaaaaaagaagggaaaggctttaatcattttggaaactcctggttctaatgtgcagccaaactgagatgtgctgctgcagggtattgcttcttactgcttctcaaagtgtgccccagagacctcctgagacacttgttgggactccagacccatgaaatcaggtcatcttggggagtgagagcaatagggtatggtgatttgcagttctggccatggagtcagaccaacctggggttggatattgactctgttatctattaactggtaacctggtgcaacttctagctataaatactgatggacagaggataggctcggaacccaaaatacatgggttcttacccagctctaccaccattgtgtgatcttggcaagtgggcaccccagacattatcttccattatcattattatcatctcataataatatatgcattgtaatatttgctaccaattttattcattaccagctaattctagaagttaggtggaacctccaagaagatgtatgatgcctagggtattactttgacctccccaaggcaagctggagccactaacccatgcctctagcttaggacttagccctagaagaaagcttaatttgggcagtgtcccaagccctgggctagcacgaccgcctgatacagcatgagccaagctaaagagatttttggccatgtgcagaaactcagcatgaaagggcagaatcccaactccaaactcttatcctctaactccaaagttgtccttaaaatcctcctctgccccagctccttggttcctgggtgaagggagcccctaatcccacagtctccaacctccctggggctcttatctttccccttaccccacttcccagttcagagcccagcctagtggacacctgcctttgcccctcctctcttgttacttaagagctgtgcctaaatagacttggagctgcctcttctctttgcaagtgtatcccaagcttccaccattcaaattatgtgcacatttttgttctgaggcagtatttttccatttgcctctgatttggttgagtcggagacagacaagatcataaggctctgcagatctcccgtccagcggctagagaggcactaggtaaaacagcagacccaggaggtggcatatctcattctattgtatcctagttcatcctttcctcttctaaaccttcactcttcctcactttgccaatttctgcagaatggaaacatagagaggctaggtgagatggcagagtggtaggtgtatgtctagtggtcaaagattggtcagctgggctaggaacagggcagagtgtaggatgtatttattctgcacatctctggcccctcctacctacaggcaggtagagctgctgcgcaggagatgcctagaggcccctgaatgttgtcagtcctgggccagggctccaaagtctcttttcttttgtgaatggccactatctgctctgtcgcttggggctcccctgtaccccaagcccagtttcagagtcttcccagaggtcccctttcttgtagttccagaaaacaagcacacaatccttttgttttaaggattttactgctgattctcattagcagcttacaaggtactcagtccaaagcccaactttgctgagaactccctcagatctcgaccttcctcttgtatcctcaagtagagcccaaaaaaacatttacttgcctcccagactccttctccccccacccccaaatgttgaggacactccatacatttaggctcttcttctggtatggaagccaggggaagccatccctggtcacaccagggccttgatcatgttcatcagggcctcatttgtccctttcccaggtcgcccagcccacacagagattatccgctaagacaagtaccagaaaaatccccctagcgtccacttgcacctactctaacacatttctcattttaagggctgaaattcccctctcaagttgattgtagtttgtcacctcttcccagtaggttctttggccttgcaaacaccccttcaaagaggaatactattagtcaccttaatgtacatgatccttatcagatcactttctttaaagactgaaagtgccagccacgggagctgggcagtgccaggagtagccactggaatggaaaccatggtgaccaggactaaagtcaccattttacccagggtggtgtgtcccacatggcaaagcaagcattgtgtcctgtacagaagactgtaaactctgtcctgccctgtgattctggtgccttctccaatcccagcctcagactctgggagacccttggccccctcccctcttcattggccaaggctgctcaaagccctggacacctcacgtttatatcaacagagcagttgctagaggaagcagcctcccgccctccagaggggtgtctggtgcccgagccctgttgtttgtgtaccttgtctcagtagtgaccagaggggcaggcaggcctgggctgtgtctctggggcaacgtactgttggggtcccagctgtccctgcacataaagcaccgactccatcaatgcacccctgaggtatcctctttcagggagtgagaatttaaaccttcctctggtgaggcttctattttccaccagccctgctcctggcctctctgctcccttcccaatgagggcagctccacatccagccaagatccaaggaacaaccatgcctgaccctgtcctctccttctcagccacctcctagaatctctgaatgttttctgaaatgaccgtgggaaacaggacagggagaggcatgctgcagcgtatcccaggcctaacccagctcctttcagccactgccatcccaacagaagggggcaagggcctgcagagacaggctgggaggattccaattttggtttccatccccagatactagctgtctggtgtctctttacctgtacccccaaaacacagatacacacacacacacacccctcatgtaccaattactccctagagtctgtttttcctgcaagaactccttctcagcttcttcaactcccactggtctctgtccttcccttctcccagagctgggcctcatgggtgctggcagcagttgagactgaatggtgaaggaggtaaaacatgactctggaagcacatggctctgccctctctagctgcatcaccttgggcaagtcacttaacctctctggtctcaatttcctcaccagaaaaattaggataataatagtacctaccccaaacatccttgtgaggaataaatgagttaacctacataatattttagagtaatgtcaggccagcagcaaggactgtgttaatgtcagctctccttgttactaaattccagggaatatgacacagtaggagaagcatggaacttgggagctgacagatatgggttcaaatcccagcaccccactgactccacatgtgaccttgaatgaaataccttactgcccagtatcctcctgtgcaggagggggactactgatagaaccttacccaatagggttaacactgggtgtggggtgtgccagccctgaagagtatagaggcagctgtagggagaggagtcaagctcctggaatctgatcccccagattagttgctgcactctggggtgagcagagtaaactggtctgacttggaaagaagagccagagaccagccaggaattcaggcccccaggaggtgccataaatagctagagcagatcagagggcctccagggatggcaggctgggagacggggaaggctcaaaggagcagtgaaaaaggaagctgtcagtcatcagtctgggggcagacccaggaccctctcccaaaggtcgaagggaaaactgtctataagtaagacagaagaaaggggtcaactcttaaggaccagcctgagaccacctgggcaccattcactctgagctgttgggagaggcaggaaattctcgacacgccattcacctgtggtcttcacaagcccactcggcgccctattttctgccctttgaccatttggaaatagaaatcaatagcacagcctgtgtcacagatgggaaaacggaggctcagagatgtcaagtgatttgtccaagatcacacagtgaatcgggctaagatggggatatgaacgtagaatattttttgcctcctaatccagggttatacatgacagccaaaatagaaggccctgtcctcagggaggaagtctttcttgcaggggaacagtgaactgaaaggatccatcctccttgctttcctccccaagacattttactcttcctccgttgatccaagcatatcaccctagctgggcctgggaagtgtgagagggatgcacatttataatgcttcagagatgtttcatcaaaggtagctgtgcgcagccctgggaataggctaaacttgaacttgggctctgaagacctgaactcaaagcccgtgtgatcttatacaaatcacttcacctttctcagccacaagtccctaacttgcaaaatgaggcccataattcacacccatgtgagactggtgtaaggactaaatgagataatgcatgcttgaatgcttgattaatgccccaaatatgataaaagctgggatcccctggtgagccagcaccttatttatctctgtactcttggtatttaccaccgcacctggaacataggaacctctgataaatgttgactgaacaagaaaatgaagtaaactctttacatttaaacgtggtatgtttgtgtgataacaacattctttgcagtttatcagctgccactgtctttttattgtggacacaggcactattatctctactcagtgctttattccccccgaaaaatgtttgaaaaaataagatccagataaaaatgctttcagtggctgggcgcggtggctcatgccacccagcattttgggaggccaaggcaggcggatcacgaggtcaggagatggagaccatcctggccacatggtgaaaccctgtctctactaaaattacaaaaattagctgggcctggtggcacatgccagtagtcccagctactttggaggctgaggcaggagaatcggttgaactcgggaggcggaggttgcagtgagccaagatcgtgccactgcactccagtctggtgacagagtgagactccatctcaaaaaataaataataataatccttttagtagtaaatccaaaaggtaggggaccatataatttattgtccacagcgggacacctttgggagtaaaggggtgctattagtaattatgtctggacaacaggaagaaaccatgactggcaaaccaaaatgctgggcatcacactaacagagcactctgctgctcagactctctggaggagtgagccctaaatcttccaaaccatcttgactcctcttctttagtcagaccctccaaagggtgccctaccctctcatccccaccagccaaacccatttggagctgttttcagatccgttccccagtgttcttaggttcctcattttcaacctacaagtgaccctgaccccttccttctgcttccctgagaatggcctagagtgtttgcactgctccaaacacgaagacttttgcctctgctaagtacccatcatgagagctgcaaaaatcatctagccatcctctgctgctgttccggctcagggtcttttctatgggcccccatcatctctctctggcctcagtaggcttctcactggtcccctgcctctgctcttcccaagtgctcagaccacctgtctcacctgttcagagacaatggcttcccacctcagtctgagaaaaagcaaggtacttatgacagcccataaggccccagtcccttttacccttgttatctctctggcttaatctcttagaactcttcagtcacccagatgtatgtcctcgctagttcctcaaacaccccaggaatgctcccttctcagagcctttgctcacgttgttcccttccttggaacgctttcctcttagacaaccaaatgattagttcccttgccttcttcacgtcttcttcaattgtctccttttcaaagtccttcaccctggccatcctataagtacgtaaccccacctcttagcacttcctgtttccatttcctgtcttttctccttggcacttgtcatcacaaaatagaccatgtattttacttaccttatttgttgttcagttcctcaagctccacaaatcatcacagcagggattttcatttgctttgttcttttgccatattcccagtacctgaaacagcacctggcatagagtagatactcaataaatatttgttaagaagaataaaagactgactgtgagggcacatagcatggaggttgaatatttggcctgaagtacaaaagcctgcattttaatcccggctctgcacacttctgtgactcagtttacctgtaacttgggataatacacatcgcctcccatggctgtggcaagcatgcatctgatttcatttaaacccctaaacccactgcctggcctgtttcaaaatctctgagctaagtaaatggcagctattgttactcagggaggctcctgatcgatttgacattacattatggctttgtaacaggcaaatcagcacccaccgcttttgagtcataactcacacacttactccccaaattgtcagttttgatcccacctctgccaggacccctcctttcctgaacccacgttcccccaaagcaaatggcctgggtctttttgcagtcagcccctttcaacacacatctcctcctgtttaaatctcagaaggccaccctcctaaatctcaggatgcctgccctggggccccttccacactctcccccagtggagctagggaatttgggtgggaaacaaaggggagaacataaggtgagctgagagggagagggagaagagagcaggccaagccatacccacctgccaggttcctgtctttgcctactgataaataggggatactaatggccagattttccattcccccaccccagcacccgctgtcactcaattaaaaaaagatagagggagagagcctgggggaggggcaggaggccttggctataaagcctgtggctaagtggggaaagcacgaagcctggcctgctgggtccttttcccgtcatccccagccagatttagctgctgacagctgcttgggactctgccgccagggcctggcccagacctgcctgcctctctcctctccctcagtgactcctgagccacagcccctccatggcccagaaggaagaggctgctgtggccactgaggctgcctcccagaatggggaggatctggagaacctggacgaccctgagaagctgaaagagctgattgagctgccgccctttgagattgtcacagggtaagcctcagatgtgggtcagggttctgctccctagaagagtgcagccttgggttaggctgtggaaattcaggatggttatattaggcgtcagggacagctacaaccctgcagcagtgagagtgcaccagtgggcccggcaggggtggtaggggacccagcagcaaattctcttggcttctcagggtgacaccttgggctctctaatcagggagaggtaggaggagctccttggaggcaaaagcccagagaataaaaccacccttcaggcctcctggtattgggatggccacctgcctctctgggtagaagcttagtcccagggagtttggcgaggacagaggatgagactggcacatctatatgtggctccgttcaaagcaacccttcccctcaacttctctgttcctgagtgggtctctccgctagccataggcctctagccctttctttagagcttcttcctggagtagatgctcccaagacaggaaagatagatccatcctttcccaagactcagaagcagcttttttcttattaaatcttttgagtctcctcaggggctgtcccacagagaaacagagaaattacatgcagataacgcagcccaggagcttatggacacaggagctgttccaacatgctcaggcattgcctggaggaactgggacccaaagaaaagggtctacagactgcaaggagggggctgtgtgcagggtacctctgtcttatccagattatgccatctccaggaataaaactaagtagtcttcttcctcttccctttctattcctgtagtggaagacccttctaaatcctgagcaaagaataaaaagagaatctatgaggccatatttcctccttgaaccaaacgttcccttcatggggtctccaggaatgaccacaggcagagtgggtgcgagactaagagaagtttcaggaagaaaggaggcatgatgctttcaagggggaaaggaagccctgagtggcaatttggacttgatatttcaagcttgacaagtgattttccagtcagccacagttttagcacttataacatgaagatctatagtagtaaggtcccttccagctcagatgttttctgattttcaagagaacctaagggaaaatgcatcctatttcctgaggcaagagtagcccctgaatttccatttgcccatgcccacccaactaatctcaccctcatcctaggattaagggagcagctgggcacagattaatatagacacagggaaagcctaaggcagcctggccaggagagtcctcaattccagtggctttcttatggaaggagagcctttttctaacacctaagcatgctggtatacgctatccttagtcatacacacacgcgtgtgcacactacactcttgtgtggctttccaacacagagggagggtaggtcaagaacagaattagactatgtttgttcagctgaacatgctttgggggtcccagagcaatggatcctgaagggttaagtccactgatataacttacatttgtccagggctttataatcacaacatagtttcatgaacatgagaccattcaacactcagcacaaaggtaggagagggagatatattattgccactttacagagggggaaactgagactcagagagattgaatggtatgtccaaaaccacagaactggtaggtggcacatcttcttactcccagcaaagtatcctttctactggtttcttattcattctggatcccaggtttcccagagctccacgttatctctatctgggaggtagtgaggacccaaggctcagaaaaaggggcacagaaggggcaacgttctgagcattctgtgaacagttcaggtgggagcagagcgctgagtgtttcctggccacaagtaacagctgtagagagctgtctcctgggcccctctgggtaaacagatggcttaaaatagcccagaggtgcagctgggtctgtgcagggagagggtgagggaatagctttcctctccttccctcttgagatgcattccccccaggactccctcctggagtcaagggggtcagcaaagcagcttttctagcctggtctcctatagggaagatctttagtgctccttatatttgggccaaaaactagcagaagagcaggtagcttttccggaaacagtccgacatgaggagggtagctggtaggaaggagagatgcccagctcatagcgattctggttgaatagggcattcaggatagaaagcggaactgagcacattaacaaaataacatggtagaatgttctggaaaagggcctaagcctgccgtagcgtgctgaagccagttcctgttggttcacaagtctcttccctactctgcatccagtgatatcacctcgggagcttgaaatctctgtaatgggagtacttaccttatggaaatcagcaaactttagaaattggggattcttccttctatcagagagatgagtgttacacttatcagcacaccattgaaaaccagaaacctctgaaagtgagaggaagagcagtgggaaagggatcaggtttggtaatgcttaagacggagctctgaaggatacaatttgaggcctggagaaggcatcatatgtatcatacatcaatttcctttttcttttttggagatggggtcttgcttcttgctctgttgcccaggatggagtgcagtggtgcaatcacagctcactgtcgtcgcaacctcccgggctcaggtgatcttcctgcctcagcctcccaagtagctaagactacaggtgcatgccaccacgcccagctaatctttgtatttttatagagatgggttctgactgtgttgcccaggctgctctcaaactcctggcttcaagcaatcctcatgcctcagcctcccaaagtgctgggactattggcgtgggccactgtgcccagactagctttgagtgtctactgttgtccaaaaccttagaagttagattactcactctttcaggtgaggaaactaagcctcagagggattaagtcatatggccaaagcttgttgatggagtaggatgtgaaccccaggactgtctgactccaaatcatcacactgcatccaaaaaaccagagaggattctttttatatttactgaataagagtttttcatttactgcctgtttcccctgttagtatttaacctctatgaggacagcactttgtctttttcactgctttatctttagcacctagctcctgataggtactcaatacgtatttgttgaataaatgaatgacctaatgaataagaaccttttgggtggttcttaggctctctgtcagacaagacagggaatgaactgggggagggtttcttgaggacagcagctcagggtgtatgacgatccagcaacactagatttaggtaagaattcccctggctcatgcctgcttctggacacagcacgttttagtagagctctggggcacgagagctggttgtctccccagctttccaacccagtgagaagtgactgtggctctgcctggcagcacccttgatgtgagcttggctttgtctctagttatgttgtatatgtttttacagaaagcagaacctcctatcccagggattattatggaacaaagataaatggcacacagagtgattcttcttctaaccacttctttagctaccagtagtttactctagccatgtaaggaacacagagaggcagtgtccagaggagaagggtgagataaggagtgaggggacttcgacaccagttaacaccagccacagccctttaccctcaccctggcctctggagcacgctgggtggtgtgtcaccaagaagagaaggcagcgcactgactctggccaacctgccttccacagagggttgggggcaggtcaaagctcaggtgtgaagaccatgcctaccagggaaaacaggcaagttcagggtttcccttgggcaaaatcccatccagtcccacagtctggagttcccttctcagctctagggagtcaggctgctagaaccctctgctcctgctcttactactctttctgattatgcccactccttggtatccgctttgaaaagtggtctgagaaagcagaaggccaatgaaaccagcaatcctccctctttcacgccagtcaccaacaggtctagtgagggaaagctgaaacaagtcaacacataattacctatgagtagatttttccactcatggattattctggagcaaatgtttaatctcagtccagcttcaactgccctctgggttgcttcctttcacagtatagatttacgcttagaaaattcaaacgttttgaatgtgaacctgagaaaaatgtattacatttactcacatcccttctccctccatcaagcagattatcttcccaattttttttctagatatttggactctctgtttcctcccaagtgaactgaaatgtccagtagcctgggtctaagcagatgaagtgtgactggtcttgtttggagaaagtatgaggaaatggtgcttaacaaggtgctatcagaggctggggagagggaatagaaatcaggctgtaggtttctacgcatgaggaagtgactggatcagggaaagaaatctactaccagcatctctctcctgaccaccacccaccaccaccaccccaccccacacacacacacacacacacacacacacacacacacgtttctacgcatgaggaagtgactggatcagggaaagaaatctactaccagcatctctctactgaccaccacccaccaccaccaccccaccacacacccacacacacacacacacacacaggtttctacgcatgaggaagtgactggatcagggaaagaaatctactaccagcatctctctactgaccaccacccaccaacaccaccccaccacacacacacacacacacacacacactcacacacacacacacccccacccctttaccagtaaaatattttctgggttaaatgtaaagggctatagttaaatatgatacttaggcctatcatgctacttaaaaaaaactgctggtgatgatttaacaagttaggtgtcattatttccttccttccactagtgggcataatagtgttaatttattctgtgagtctacaaaattgcccaagatggccatgttgtctagttccctggagaaattccagacttctactacctctgttctcctggtttccccccaggacgtagctatttcggtctgtgagaggcctaaagaatctcatctgacctttttgctccttctagaagaccaagaaacccattcagaaatcaagcaagtttagtctctgagcaagcccaagggaacgactaggaaccaaaccttccctgcctttcctttgctccttgaaagcacttcttttcctgaggcatctagtccagaaggccctgctgagggacagagtagattctagggctgctggccagaggggttggaaacccgtatttatagagagatgacctttcttcctctcccttgggtttcaggtttctttgggtcttctcctcttgcctagggaagaggaggaggggaaaatgtcagagcttaagaagggcagaaagaaacagtcacctcacaaccatcaaagccaatttgcaattgcatgctgggccaaattcacactggcctaaattcatactttcagctgagctatagggagctccagaaggaaaagagggaccacacagcagctactgtttaagcttccaagctatttgagtagccatgaatacttgccagggttccacctgataatccatcatataggtggccctggattagacttggggagtggggcaaaaggtcttgaagagcaagtttgggcaggaacggtaagctctgagcttctcaaaagcaaaaagccactccaggaagtgaagggaccatttggcaactggtaaagttgaggagtggtctggtggggtgagtacctttggggagcactcactataagtgaacgcctgacagggattgagaagaggagcagggaaacatcaggcgatccattctcctaaaatgttaagtaaacaataaacacctccaactagggacacaggggcttagagagctaagtatagtacctgatggaatcctggggctgggtcctcaaacacatccatctccacagtggaaaatgaacctgacagcacgggacatggaaacttgggtggatacattttggtgatgggtgggggtgagggaatcctgcagggaaataagtcaagtttactcatatctttggcatctgctgctcatccctaggcagccaaggccctgggataccagggattcccctgcagcccagggagtctgttgacttctttggggaaagagaagaggtggagacaggcaatagtagaattaatggtgccataggtatctcttggggcaggcagagagattacatttttaaaaaggaaaacattgaatctttctagctggtactcatctcctcctctcttgacatttttcatctctcctattaaaaattcattttctttggacttcaaacttgaacaaatcttgcctattttagaaaaacacacacatacacataaaagtaaaaacaatcttcaactctgatgtcttctctggcccttctcttttttcttctccttgttattaccaaaattttcaaaattcctggacttttcctgctgttttcatttcctaaccatccatctcctcctcaaaggcacccacacaattcatcaccaagtttagtgtcctaagatacctactggacttgttcaatttgaggcttttcctcagcttcacactatctgcctattgccaagactgtaatcttgcatggacatcatttttattgttttccttctcaagaacctgtaacaattctctactgcctcccgaatcaaggccaaactttcgagaaccttcataatacttcctttactgtacctatccaattttagcagtcttataatgttctcagctgttttatttacatcttctctgtccagctgcaatctagctgctaaattataagcatctggagggcagagaccaagtcctttaagatttggaggtgactcaatactaaatacaggcttaactatcccaagatacccttgagtagtctgtcctcacagataaaaattcttggacacttagcatgtgacaatccctttacctgaaagtaaacagacttgagaagtagtcacttgagaaggagagcatgttattgcaagttttaggccatttcatgccaagatgcaatttacatgagttacaaggaagagaaaaaagcataaaatgctctgcaaaatctttgttttgctctgtcatgagaaattttatatgcttgctacttacctggccacttattggaatcatccagagagctttttaaaaatactgatgcttggaccacctctccacatgttctgatttaattggtttggcatgaggcccaggcactgacattctcagtcttctaggtgattctaaggtataggcaggttaaagattcagtgatttagaaatgtaggggtatgttgtgctggaagagtgatggtggagacaatgtcctagtagggtgaccaaaatgcacacctcagtccaaattctcctctccttcagataaacccttctggattttttaatgcttttttttttttttttttttttgtcactgatgttaccacagacaagacctatttatagtaagagtgaatgcatttctgaagtactgacctggaagagctacctactctaggctggttctagaaacaagaacttatcattctttcctgtccttttgtctccttgacctacagagaacggctgcctgccaacttctttaaattccagttccggaatgtggagtacagttccgggaggaacaagaccttcctctgctatgtggttgaagcacagggcaaggggggccaagtgcaggcatctcggggatacctagaggatgagcatgcggctgcccatgcagaggaagctttcttcaacaccatcctgccagccttcgacccagccctgcggtacaatgtcacctggtatgtgtcctccagcccctgtgcagcgtgtgctgaccgcattatcaaaacccttagcaagaccaagaacctgcgtctgctcattctggtgggtcgactcttcatgtgggaggagccggagatccaggctgctctgaagaagctgaaggaggctggctgtaaactgcgcatcatgaagccccaggacttcgaatatgtctggcagaattttgtggagcaagaagagggtgaatccaaggcctttcagccctgggaggacattcaggagaacttcctatactacgaggagaagttggcagacatcctgaagtagggcaactgggctttgcctcacgtgagttttcctggtgccatggcaccaacactttattatgttaactccagtagaaggtgtgaggtcaggtagaatctgtgatatgtctgattttcctttggaagggtttcatttctctgcttttgactggttgcaaaaatagtttagaacatgtctctttcctctgaatccctctctaaacttttccctcccacacttttgtatcaaagtaactttcccctaacttagaatactcaaggttgacaggaatcctaaaactttcatgaggcaagatgacgttctttggtaagatttagatggtgcaagcacctgctactgaaccacagcagagaagatactgaaatcctctgagtatgcccctgtgtacatgtcagggattactaattccagacatcttctagatgcctcactcccatatccactggcaatcttaccattccatttttctctaatgaatgttttttagtccttcagggacaattttttcacttatggtaattttgaaattccccaaatggactggtatttaacttgttttaagccagacctgctttcatgttttcaaacaaatggctacactttgaaggagaccaacaattgctgtgtgaaaatacaatacgggaacattttccttatgttgagaagacctcagtagaattcatggaggatgtcgaatgcaggaatggggataatatagcaacaagctagtccatgcaggaacatttaaagagttaaaaagacatttgtaaagtaggcagcagctcagaagtaacctcttacagatatcaagaggtgataggagaaagattagctatttaagcaaataattaggacacaattaaggccaatttggcctcttgctgagggtaaattaaactctaacagaaacaggctaattaccctcaggaaagagggctaaaggatcctttactatcttttttacatttagtctgattgagtttgcgcctacagaaatgctatgacgaagccccctttgcaaggccccagttactgatcaaaatcttccagtaatagaggaggggtactcacgacactcttacccaactttaatcctgcaacaactcacatattactaaaacatgaaaacaacaagcttccatgaagataatttacttttggtctctctcactcctaacacccttaagagaagatgtcgcttcatagacacgtttaggaaatatcaatgttccagagcttgatgttggcaggtgttttctattagacatgcacatgggcacctgatcattctcaagctgagcatttgccaacccatgaagatacaactttcagccatttcttttaaaaagcaggacccagtcactgaagtcagtgagcctatgatagggtatactgtgtggtactctgctcacataaaataagacactttatagtggtgaacagtagtcaaaacagatttctgagggtgccctctgagaatataaaatttaacttttagaattccttgaagattttgttagtgtatgtactatcactgtaattataaacccaacatagattctacagactaaccggcagcttaaaatttaaccccagtatattttcctttcagacatctttcagagtcaagggcccaggtgcctaactagcaagtccttagagcttttttttttttttttttttttcagtgatttcaaatataactgtattatctggacccattaacatgcttccctgtcttctatttgaattgctcatgtttgtgaagggaaaggttaagatatatcaagttaaaaaaaaaaaaactggcatgagataagagtgtaatctaaaagcccaaaagaacaaccctgcttaattaaaataatcttgagaaatgagcatttgttaaataaagtgtcttattttacatacttatttcatctttcttttttttttttttaatgacaaaatagtatttaatcctatatttagtcaaaagaccagagttaaaccagatctcttctggggctttttctgtgtaaaccacatcaaaacatgaacgaaagactggcttctggtttagtcaatcctggtaaatttacccaatcctgcaaaggaaactatggaggagaaatccagggacttgttgggaagggcacacagaaaccttagttcaaaaagaaactagtcattgttcggggccagcagagctctcagtaacacattttctttgtttgttttaccaaggtattcctgctgccaccaagagacagcaatgacatgtacagccatctgggacatgcctgtcttcctaataccatttggagctggacaacatttgacaccaaccaatcatactggacaaggcccttagaggacttgaaatatacttctcatgctgtagtttatttaggctgtgactctctctctaatgctgctctcgggaaggacgaaagtgacctgcaaggagagaaatgcaaccatacatgggctccagtcaactatgggactgaaggtcctaattgctcacccaagggggctgcttaacacaaacagcctcagacccgaggtttagatttctgaaatatgcattttatgttaagttgggtatttttttaaaaaaagaaaaacagcaacattaataaaagaagtggtgtgtttttcccgtggccagatttttaagaaacttgaacatctggaagttgccacagacaagcgagctagtccagacacagggacactccaggctatgaaccaagccatggttaaaccaagacttgcctagacaatgcagaataactctcccatacagacttcttacgacaatcaagtgagggcctttcccttctctgaaggcaagtaatagggcagaaggtggaacaaaaagcatgagaaatctaaggtagccacatcccaaatgccagttaataagcaactagcttctttattagagaggagcgggtgaaaagtagtagtttaatgttcagatatacaatcatttaaaagtattcaatacatggtgtttgatggtaatggcaggatgatgtcaagtctctctttttttttttttaaaggtttgtttgagtcctatgtggaagcaaaaattcacaggtgaatttccgggtgtttgccaaactctaactaggtttccaggaataatgtgttcactctgattaccagggcatgcctcctttcctcaggcttcaagtgtgataagtcgtcggaatttgacccaagactactatcggcaaatgacaaagtgctttatcacattcctgctaagtcccagaattccacttacagccaatcctgaatgagactaggttttgtctaaagaatcaaggctcaaacgccaagaaaaaaataataataataaccataatctctttaaaagtaaaggaagcctagaaaatccatgttttgacttgtgttaaggtttacagatggtactcaatttacaatggtttgtcttgcaatttttggactttacaacggtgcaaaagccatacacattcagtacacccttcaactgaactcaacttaagatggggttacccagacatagacctaagttgaggagcatctgtaattgcagagttaagcaaaatattttaagtttctttaagtttcttatcccccactctcactttcaattttgtgtatttagataatctctccttcctttttcccttcaactttatgtggacaaaagcaatgcttcaagaaaagcctcaatctaaaagtttgataatgaacttgaccctccactgcccctaccccaacaacatgaagaacttgtctgttccacctagaaatacaaaagtgaaatacttttttgaaactgttgcctcttatcaggctgatatgtgataagaacacagtctaaagtacaaagattatatttaaccagtactttcctggtgttttaaccagccccttctaaaatacagttgttcttttatacttgggaaagcagcaagtcctgtgacagacccaaagtcactctagggagaaaatcaatagcaagtctggctgttttaactctcaacaccactgtaagggaaaacaagaaaatgtctagtttcccgaatagctctgatactgaaccattggctaaatccatgaactttattttcctaccatgaccacaatagacgactggtctttgcagcttcggaagaaaagaggactaatatttagaccccagctggctgcacatccaaatcttctatggaggttaaaaacacaaaagtggccatcccactccaccaccaaatttttttttttaattgagatagggtcttgctctgttgcccacactggagtgcagtggcacaatcacagctcaatgcaacttcaacctcccaggctcaagccatcctcccgcctcaacctctagagtagctggaactacaggcctgcaccaccaggcccagctaatttttaatttcttttttttttgtagagacagggtctcgctatgttaaccaggtttgtctcaaactcctgggctcaagtcatcctccagtctcagcctctcaaagtgctgagatgacaggtatgagaattttttgagaggaagtggcctttatttttttaaagaagactcataaggatttttgacaatcactgatttattgggtcactagtctgtgctaagtactctgccaggcatttaacatacattatttcacttgttttcatgattaaattcaggcaggttcaatcacagaaaccatgcagtggacaaaagagagaaaaagttcaccatgaggagattctaaaaacctgccttttgacttgtctatttttatctcttatttctcactttgcttctcctcccgcttggaccctttgtctgactgtttgaaattaagttgcaggtgaaccctccattacccatgtccagaacaaatagacataagcacagaacctcactaactccccaaatttttatttttccatttttatcaccacaaatttcttggtaacaatgtagaatttaattttgtaattaaaacaaaaactctcccctaggaggaatctgatgacataaggataacaccaagttatgtgcacaaacgacaaaaaatgccaaactaactggaatgatcatccttcctgaaatttctcttaaaaagcagagaagtagaaccaatgctgccacctagtggccagccaaacaaatcaggtagcatactggagaaaaaggtcatagtcccgacaatctggtttccctgcctattatcaagccacctaactccttacttttccacaaaaaaacacaaccacatatcttaagcaagccctcctccacagtcataatccaaatacttgaatacagcaaccaaagtctgtcttgttaaacacactacttctcatgaaactttcctctgcctattttaaggtaggtttgcccggtcctatggcccagtagagatgacacaggagaacacggaaacatccaaaatgttcactggttcagagtgtgtacacagtaattttgatgtctgttgcctcaaatacctcctcgatcatcgcagatacattttcccattgcagacgatcaagaccacatccaatcctgaaaaagacaaaatatctccattgatggtaacgaaagtatctaggaaactgctcctctcttttaagctatatccactcaaagcataaaaacaaataatctagtctgacacccttatgggcaaccatggtaggagtttggaagtcaattcttgttgtgagtcaccgaagaccattcctagacagctctaacatccaaaaactatcacttctgtttgcctaataagatactactttccaactatttcatgctacatttagaaatgtgtaactgtcatgacattagagactcattatccctctatgactactgactaaaattggctgtggatggatggtgaaaggttggtattttaaaaatgcacttatggtaacagaatgttaacgaaagtaaggagaagaggaatgaggtacaggatctgcaaaaaagaaagtcaagagggaatgctgggaaatggtaagatagttgcaatccaggagtaaggtctttgcaacaccctggtaagaataaactcagtccataaaactctactacttggcaccttccaagatgttactctagtgatcctcaacacgcctagggaaaaaagagacctaaaattggtaatttcatgtcataatgtgataattaagtccataaggaattgtgattaaaaaaaaagtttctgatatgtatgtacaccataaatatatcaaagaccagtgtaaaataagggacatttgaggccatatgcaaagtaatgtggggcgcaagataaaactgcatgtatgctcagcattgactcaaaactaccagggtgacaggaagaaaagaggtgaggcccatttcctgaaaagaaagcaaagggactactgaaccctcaatgtcattccctaaattcccaatagctaaagtctaagaagttacatcagggacagatcctctggctattacccatactgaccaaaacaagtgtgcagtataaaagggaatgataatttacaactttcttgacgcaaagtaataggtttgggagatgggaagtggtccaagaggaaaaccaccattgctcagtcttgattctttagcttacattgctttaggaataaaggccaagcttcaagcagagggtgctgagaattcaacaaatgtagctgaatgacaatggtcgctctctgctaagcaggctgaggcagatgtatatttcaaggtaattgtcctgattcattcaactcaagctagaaaatggctgtgccttagtctaaagccagacaactggttcactggtggttttacaaaattttgacttttgtccacctttaaatctatattttgggttaagcttttaagttgtttgtctttgggtaagatagtaaaccccaccaatcaattaaatctccatttaggaccatggatttccttgcctgggcatggagaggtcagtgactccattcttcagacaatgagacttcattgcctctaaactcttctgtaagttttcataagttggcttgtgcgaagcccttttctttgtaatctgaacacaaaggattcaaactttcatcatcccaaaatgatagccaaagaaaagtcatcacattcccccaacatcccaataattaaaagagtaagcacatttttatagaattagtctagagcaaggatgacaaatgtcatattgccctttccacactgttatgggagaccttcaagaaaatccactaaatagaggctgagaaacccagactctgccacgtagcaatctttccttttcctaggaaacccatgagattagcagatgatgcctattgtcaatatttttaagcaaggtaggtgaagtctctgtgccacttccaagagataagctgcatatctctaacagggaagaaagcataccacctgaaaattccctgctaaaagcctctacttatttagaaactgtgcttgcttgctttttgtctctctacataaaacaacagaaaaaactggtagggtcccaaagtaaaaccactggaagccacataagctttaaggacagaattcaaaggggctaggacatctccccactcagtttgtcatccagatcaggcttgtagtgggttagctgtaagctacccaccaccaccactaaggaagccacaccctttcagggaccaaatgccatcctggactgttgaagaaccccacattcaggcagtagttaggagaggagctaagtattatttgggactgcacttattattttttgtttttattcacccccttgctatcagtgtgctatttgacatggaataagagaaaagctcctttgggaaatctgtctcttgagacattattgtttttatctcactctgcctaggaaatatagtatggcaggcattcctaacttttgcaagtcttagaacaggcctatggtacatgatacacgactttcccacagagctgggatgcagcctcacatttctttctaacccagtgctccaagtagccgccatcactggactggagttgtcataagataggaagctttttgacattcttagttgtctagaatagaacatcatgatcaacacaaatgcagtgcagcccatctgttcacaaatccttaaaatgtattaagaactggccctgaaaaaaaaaggaattggccccatcttaccaagtaatatatatatcgcccatctctcttcagaacagccacttctccagatttcttttctaagaaaaagttatttaatagtagaaatgaaaaagaaaaccaaacactgatctctaaagattttaaaatgtttacagatctgagtttacctcagaactagaattttcaacactgaagaagggaatagggaagacctattgtctcccacaaacactttgctttttatcagcattcccaaatactatattccttaacttaacagctttcttacagtcatgtttcctcacaacccatcttttgtaccactactacttttaaatatatcctcatttgtccacaaactttctctattgccttgaaattgttttatagtgtgtagttttttacttgccaaatgtgtatttactcaataattatctttttacatacaaagagctgtataaggcattatgaggaatacagatatataaaaaaggaattaattattacagagttttcaatccagagaagatatcatcattccaaataactataatacaaagcagtaagaattgcttttgtctaaggctaagaatcactgtggacactgatgctgttaagcctggaatgtggtcggagaaactgttgcagaagctttacataggattctagtgcacatttctggtttaaagtggcccgtagaaagtgatgggaggggtctgtaaggaagaagaggtttctaaattcctctttgaagagaaagcagaatattggtaagtaaaggatcttgaatgccaacctatagactaagcatctcagagttatttcaagtttcagagaagtacagtaatatcgtcaagaaagtttcatgatacaagaggaagagattaaaaaccttcacaggagttgggttttgatatggtaaacgtctaaactagaggccattcttggggaggaaaatcttaaaaacatttggttcttaggaatcccctctttacacgcatattttattaaagtgtaacagattaaaaggtgctctagccagggcaaaccaggtaagtggtttccaaaactcacgttgatttaaaagttcttgcacccctccaaatttcttcttaaagaggacagctatcccagcgcccatgcgacaatcctcactgatacagtgggctaaagagtctgttttcgggcatgcaaaaaggtctcctttcacataagtgatctaaaaaatgtgcaaaggaaaagacaatgttttattagatacagtaaaatactaagctatttttctgtattttgtgtcccccacgactacctctcccggcaccccttcctccaatctgatttaaagccaaaccaattacagcatgtgtaaaaggaaagtaatggatgatccctgcctagaattttgagcctttttaaagtaaatcagctagagagaaaaaaagataatgcaatcattaatttaattaaaaagtgtttatgcttttgacctccattattacgaatttcagttcaccaataagtcaatagttgttacgcactctgcttccttctggatcttcattaaggctgctggccatgatactgagtcgctatttccagaatttaagtgtttcttcagctatgagaagggaaaaggaagtaaaaatgcttaggcagccttagtatataatattctgattgccctgtacaaccacttaataggcttttttccccaacgtttatcgatgaatgtgagtttgttcggcccctgggacgtaatacaaaacccttctggggcaaagaggaagaacgcttaggttcggaggctgtctcgacccgctctcatttcgtgctttcctggagcgccccgctccgtcagcggaagcaaagcccatccctaagacacgcctcctcctttctccagggccactccggagcaaggccgatttaggacggtctccttttctctgcacgacgcaaaagtatttccccagtgggtctggcttagaagaaaacagaagggacttggccacagtcccgttaagccgcaaccacagagtgtacagggtactggcgtgctgagccccaggcgtggggaaaggaaggcggcctctcaaggaacgttcaccccccacttttttggggggtgcgtgggagaaggaaagagtctattgaagcctcccattctctgtctcctaccctagggcgggtcagcgaggacgcagtctgtcctggggtcctatgggagggtgcggggaggctcgctcaaagccccaacgtacccaagtcacccttcacctggaaaggagtcggttgtttggaggtccccgccccgcggggaagggctccggatccgaccctggtaggtggggagcagcggaccagcccaaacgcggagccaatcccgccaaagcccttaattgcacgcatctaagatggccgcccccgcccggtagcggggcggaaacgagcccctctagcttgctagccgagcccacactctttggcgaaggccgccgaacttccggcagtaaattccgtggtttcccgccgccgcccgcgcatgcgtaacgaaactgccccacgagtcgggaaaagtggcgcttgcgcattagccgcaggggtgtgtcctagtggccacttggaaaggggtgggcagctggcaaaggggctagttagcgcctgcgtagtactaagctcaaggcagcgttttgagttgaagggtctggcgcgtctggaaagcgcctgcgtattcctttcactgggggtggtgtcaaagcgggaaggtgggcgtggcttcagggaacgcctgcgcgttgctcctccgaaggggtggggcgatccctgaactggagttagtgggcgtggcctcagaggcgcctgcgcggaggcggttggagggaggcccgattcccctttgttcgggttcgccattttgctaggcagcggcagtggcggcggcagcggcggctggagcctctgattgggtttcggagtccggtactggagccaatcagcgcgggcagcgaaccgggggagcgaggcacggtgagtgtgaggagccaatatccagcggcccagagccggccccagcgccccgattggcgggtctcgctgaccactcaggagaggcccaggcgcccgtcgagcccggggagtcgagctgagcctagccgagccgggcggccagcggccccggcccggggcctgcgagcgcctcggggcactcccggccgaggcctgcaggggccgccccgcgcggggatggcgcctcggggagcaggcacctcggggctccgaccctcgcagggtgccagggccagttgggaatgcgtccctgttccccgactcaggcccaggttctcaggccccaggcctggggccacgaatggccctacactaggggacacatgcgcgccctgggcctcggcgatttcctcctggtcgttctggccgcaaacttaaacctgcccttgcactctccactctccggcccttgggacaggaagcctccccggggcccgcgccccccgctccccgctcccagcgagccgggtctgtcttatctgcagcccctctaggtcgggagggaggcctggggagggtgcgcgccgcggccgcggggtcccgtgtgcggctggcaacggggctggcccgcccacgcctcggagccctatgggcccgcccccgctgtctccctggtggggagagggggccgttagttcgcccactccccctgctccgccgcgcccctcctcccagcccgctccgcccgggtctccggcccggcgccgttaccaccccttttggctcgtcatttcctctcttccccgccccgttcgcagtggcaggaccgcacacctccgtcttggagcccaaccaagcggtctccgtttcttgtccgggctgtaagaccagtccattcggtgcctggaacctcactcttagaagattgatacccttgcgcattctttccggaggctgcacaacttgctgttcatattactaatcttatccactgctcattttgtgaaatctccctcccttgggaatatagtacagttttgggggttttttttccctttgtttttgccttcgcctttctatgttactttgtgtcaggcttgacccagtccactcatctcttggtttatgtttttctgatacactttcaagtcctgtgttaacgttttctcagcagatgtttagaaactaacagtgttgtggggttttccttagggtgagaggttgctgttggcaaccaattatccagcagttagtatatgccaggtataatccgtgtgttagggagggagtacgtagaggtcaataagaactgtgcctacctgatggaaattgacaggtgaacaggtagttaatacctaacggttagtgctataaaggggccaagttcagttgctgtgaagtatccatgcgtgagctagcctccgtgaaaggcttatcaccaccgcacttttgactggccttgaagaatgatggtaattcttccacaggaaagatggaagagcttgctcgaagagaagaaaagcatgtgcagaggaatcaaattacactgttggaggcaggaagatgggatagggaagtgggcagtagttgtgatagtttaggggggaaagcccagttggtaaaatacttgtatatcttgctaaggaatattttggaaacagttattattttgtatggaggttcaagtagaagggatctagagctatattttttcctaagattgaaaaaacgagtttctgacttgtttatgggttctgccccgtgatagtggctgagttctttggggatgaagaggagacttgtcctaggactctgaaaattatttttactcatgtgaatcatctagtgcattccctggcacataaaggtcttaagtatctggtgcccatttctaaattcacatttaatgttatacaactaataggtttcagaaaactcgtattccagtgctctttcattactaaaacttcggggacaggttttattttcactttttagggtgagtttttcattgttgcttaagtgattttcttaattcatttgattgtcacgttatccgcattagcagatgagatgatagagcttaagtagtctaaaaaacatgtatatttgcctttggaacgtttttttgtttgtttttggatacagggctttcctctgtcatccaggctggagtacagtggcgcaatcgtagctcactaacctggaactcctgggctcaagccatcctcccttcttgttctcccaaaacgttgggattacaggcatgagccactgcgtcctgacctgaaatagatgttttaaccttagtatttaaaaataggtatgttctggtcacttcaaaatcactaaatacttttgcttggcatctttctaaaaggcattataatctggtaacttttttgctaaataccttacaagcttccaccagtctgcagaagaatttctttgtctgacattttgagagaaagtagtgtggccccaagctttttttcctgtttagtccactgttcacatgctgaaatatttctgttcttgtttttatgctctcttgatttgtagtacttcaccttcctccacatcatcacatagctaaatctttctcacacttaagaccagttcatcctgcaggcctctgatagcaaagaaaaaaaaagttcaagtagtacctttttttttttaagccttgttgatttatccccagctggaacaaatctctgtcctccaaattcccatatcactttatctcttaggattccagtataggtttttagtccattactaaacttaaagactctttgaagtttgaatcttcgtcagagatttctttttatttttaaaaccttcagaacagtgtctggcacatggtacataattagtggagagaagtgcattagaaagctccaatccagaaatctgtaggatgatggggaagctggacagccctttgttgtagtctagtctttcatcaagcgtctatcaggacccacttgttgagttgtgaaagaaattgagtgagccaatgctgggaatttttaaataatagaatagaaaatatctgccaggcatgatgatggctcacgactgtaatcccagcactttgggaagccgaagtgggagaatcctttgagctcaggagtttgagaccagcctgggtagcatagggagaccccctctcttaaaagaaaaaaaagaatagaaaataccaaagtgcatcttgtgttgtataaaggtaaatgctgtttcatgaaactttcatttcagttacatgctttatacatgtgtgcactgagttgtgataatgaaatgtgtttcttactaagggttgtggtcaaaaaagttaaaaagctactgttctaggctttgcctggtagtgattatcaactgtgataatcctatggcttttcatatgcttacactagttgagtttctgaagaggttttagctttggagtttgtgtaggtccacatagaatgggttcctagtaagtggttggctaagtctcagcttttgcaccttggaatagtggggcaaagagaattgcactgagaagagaatgcactaggaagagaattttcatgctagccagaataaacacttattatttgtttctctctctttgaggaaaaaccattcaaaactttgtgttaagagcaagagctagacagactaaatctggcttagtttgtcataatcttgggcaaagaggcactttgggaaagactatcgaattgtattgcagtcttgctaactgaagctcacagtagtaggaacatatgactttactgaagccagttgcttatagcattaaccattaacagtatcaatatcatgatacaggctaaatcactctgtcattaatgtgagagagaattgctgctagatttgaagctgctcttcaaatcttgatactcttcaaagtataaatttaaatattgctaaattggttcatttgtattaccagaataaactagttaagaagaaaatctgtacgttacatatattagtcattatgtgcttcaagttatatttagtcttgtaaagatgtaaacttctggatattagtcaaggaaaaaatctcatataagaaggaaatttggagttggggaggcgttgaaacctaaaagacattcctttcatgatccttattttttaaaatcaatttattgagagatactttagaaacaaagtataataattttaaatgtgtattttgatgagttttgacaaatttgtacacctgtgcaactgctaccacaatgaagatataaaacattttcatcaccctacaatgttcctaaggctccatgccagtcaacctccctctttcctgtctccctgtattctccactcccaaggaaccactgatccattttctgtctctagattactgatgtcttttggagattttatataaatggaatcatatatattcgtttacatcataaccttaattttattagtttatagccataaatgtattgtgtattagagacaagatagaatttagggaagcctgttagtgcccctaacagactcacagtctggctgaaaacctgattttctattctatacccagaatctctgaggagcagacttagtcaaccaattccaaagagactggtgtaaaaatcagaaaaccggtttgtcatgttgctgattatatttgctccctgttggccaatctatatgtaaatccaaattatagctagaaatttacctagcgagcattccattagatcaagggcagtgctttggagaaccatatggccacaagtcctcttgctgtgatgacatagcctgttatttatggctcatagattcttatgttgtatccattttggttatgagtaatggggttgattaatttttattttgattaaattttgttatatttttcctaacattccaacattcatttgggaaataagaatttctcaaaattcttattctagaaataagaattttcaagtgtgcagtgaaatcaaaggaatttgaaaataaacacctgtatacctgccagttagggtctattaacatcttactataattgccttaccagatatttctccacccattcatccattttttgatgcatttcaaagtaaattttagatatcaatacacttctttctaagtacttggacatatagttgcacatattttggtttcttctttcacactgtattgagacaccttgcaaatgattaattccaccagcatgtgtggatttatggagagtggtactgtactttgccacgataatgagcagctcagttaggtcacgtcattttattattcagatgttggaatttatgagggcctagtgaaaaatcagagagaaagacctatctacatttttgtttatatatctgtcctccctcccatatttccaagatgaattgccgattgctaacttatatcattttaattttttaatgaagtctttattaaaggttctcagatatcattcagtttatctaattgtatccttatttttaaaagtggatcttcaactcttaaagtctatgagaagggtaaattttgcctaccatatgtagtggacctgagtaacatgtttggtgggaagcaattacgtgttacaacttaaagaagctttattctctaaagtatatgtgcaaacctgaaaatcagtgttaggtatgccttgtatcaaagtgatgtagcttaacgagtatctcttaggtgcaagtattgctctgacagtattgaaaggtaaggttgccagtatactgaaagcattttagaaacgtgaaaatagcattatgttgttatgattgtgccatgtaatcccagttaaaaatgatactgaatataagcatttcctattctcctatcctgttttcttgcaaataaagtacagtgataaattatccaggttaattgtctggtaaggcctttattgacaatctcactttagtttctttccccacctttctaacaggagtgtacctcacagccttctaggatctccagagtggacaggaatctcacttggagggaccatggagcagtatacagcaaacagcaatagttcgacagagcagattgttgtccaggcaggacagattcagcagcaggtatggaagcaaaactgctttaaacattacagcaatgaaactgataacagcaccactcaattggttggtctattgccctggggaattatttgaaagataccagatcttgtgagatattgggtctgatggcttgtgctgaaatgccatgtctagcccatgaccacttagaatctactcttcatgggtgcctggttatagtaaattgcctcttttatctcattttaagtaaaaacatctagtctggttttcagatggaaatttggactttaaaatttttctggattctatttggtctttttctcttcttgtttgagctaacttgtgatttagtaagtctttggccacaacagacaaaccaacatagcttccaataaatcttctgttttttgatttggtctgccacattttttattcagaaaagctctggtttaacattaggataatatttagacagccattcttatggataagacatactagaaaggaattccctgctgctggtttattcctaattaatagattgctttcttgaatttatacacaggttacattttctgatgctttatgcttgggtttattatagtaaaatttcacttttttccccaccccagaagaaaaaaatgtattatgtttctatttgaccttaggccaagattgatattttggaaatactttgttttcaaaatggaatttagctaatatagaaaagtagtagggaagggaaaggtagtattgatgatgagtttttcccgtctaatgatcaaagacgaactcccctgatagctttcccttccatacagctgctgtggctctggcagtttccttcaactgcctttttagaggaagggattccacaaagggccctccattcacaccagtgccctggagggtgggtttttattctttcagaatttgccattagtggatgtaaaaataaggttgaatcattgaaaacatggctcttaaagcagtccagttgggtagaaataatcttagttttgaagctgggcatggtgctgcatgcctgtaatcccagctactctggaggctgagacaggaaggttggcttaagcccaggaattcaagaccagcctgggcaaaacagcaagaccccatctcaaaataagtacataaataaagtttaaaaaaaaaagaatcttagttttgggacatgagagcattgacgtcatgaagatgatttcggttcatagtgattaattactcctcctttcttggtgattgcatttaagcccagaattttttatggtagtttcagggctattaaaacctaatcatttttttcttgtgaactcatctgaggagataaaaagggcattaaacaattgtgtaagtagaagtgtcagattcctgtttctggagggaaagattgcattacaaatctttgtgttaatgatgacaactgttttgagtttttgagtcaaatttttgaggtccactctggagacaaagggctaatatctttaatcctactaccttcaacaaaacagcttcaatatagggagtctgtacattttgaaagtccttcaggcttccgtctctctcctccaagaggtaaggtgatctgtgtcttgaactacacatttccttcctgacatatttcaagctcttcctgttcctgttctcagcagcagggtggtgtcactgctgtgcagttgcagactgaggcccaggtggcatccgcctcaggccagcaagtccagaccctccaggtagtggtaccctctctgattctctgtgagcactgcatgaacttctcctctcctcatgtctggtgctgtttgtgttaggatctccagtaggaatggcaaagtcagttgcatgtctttgatgctgctaacttgtctttgaggcttataagatgccagtttcctaatatttcatgccaagtcatatagagaccccgtatcaactttctgagaattggatttgactagcatgtttctttgagaatgcctggaaaagaaatggtataagtgacaggaagaaattcttataagtgacattagaatttattcagggctcggccgggcgcggtggctcacgcctgtaatcccagcactttgggaggccgaggcaggcggatcacgaggtcaggagatcgagaccatcctggcaaacatggtgaaaccctgtctctactaaaaatacaaaaaaattagccgggcatggtggcgggcacctgtagtcccagctacttgggaggctggagcaggagaatggcgtgaacccaggaggcagagcttgcagtgagcagagattgcgccactgcactccagcctgggtgacagagcgagactccgtctcaaaaaaaaaaaaaagaatttattcagggctcacactctgatccaattaattgcatggtaaaaattttgtgtatttgtgttacaatggagaaggaaatatatacatatacagacacacataaactaggctaggctgtgctttatttttattcaaggggcaactcaactgaaaaataatcattgcacttggcaaggtttatctaagcactgaatcttgttaatctcttgttaactgctattgtttccactacctttcctgggggaatagtgacctgtcttattactagatctgcaaagattaccccagatacctcttggttaggcagaagcaggatgtgctttctgtaagtcttaggtgttaaagccactgtgataattcttggttaatcaatacagttctttagcatcgtgtatggctaagtatcctaaattgggttctaatttggccagttcctataaaacacaggagtagcagcactagtctactctgtgtatgtaggttacttttattaaaataactctatttttgagaaattggcaagatttgggtaccctactttttccctccattgaattagaaatgattcaaagtagaatctagaatgtagaactggcatctcactttattgctagtgctgctaagcatccagcagataactacctcttattgtcatcactttatcctttcaatcccacccctacccctgccaccaatagtgtttggtaatgatgtacagccaactttgaacataaattaagccgaaagaaactgagcttgtaggcattccaaaattgtgttcaaatctcacagtccaacagcttgttaatgtttttcatgcttgcttcatcttactcatatataaaacagtattttggattgtcattaaccccttgtggaataggaatgtaacatgctcttaactgtatggcttcttgtttgatgcatgtgtctttgtaacatttttctgttgtaaatacagtgagctctttggagtctcaaatcatttatcatgtgcacgaatagcacatcaattggggaggaaattaagatgatgaatagatagaaaattattaatagctgtatcttaaaacttgtgtttcctacttacatagattttatttaaaagaagtggaaacactttatggaaataatagaaacctttcctctagggatctgattattttgggagaattttaaatagttattttggttattcttgctatatgtattctgagaaatctttcttgatacagaatatgcaagcatttggtgtagcaaaggggatttgatttggaatggggaaataagggaaagagatagcatgagagagtcaggctgtaaagtccttaaaaaagtaaagtaaaggttctcaatggacagtttaacaaaacttaggatttcaatgttcctggtgattctaatacattagtggtggtggcagtggcggcggtggtggtggtgattgtaggaggaccttactatctaacctactcatctaggacagaatgatctgttaactaattgctgttacttgcacatactttcattaagtgtgaatatttcagtcatgaatattctgttctaagtaatttctgtcaaagatagagtctgaaaatgaaaattttggactattccatggatcattacagtttacttctaaagcacttttaaagtgcttccagaaagcattctattaggtatttttgtattgggacttaagatgtgacagagcacttgtagtgacctggctcctacagtagtctgtttactcataggagcttgaaatttgtacacttgactgctctgtgtaatttcaatatttgttgttgcttctgataaagctaaaataaccatgtggatattatagaggccagtgaggaattccaccatggagactgcaaactgaccagaaagtgcttttaagaaatctttagtagtgagtttaaacaacaaacatatctagaattcacagagtaaaatgagcaggataaaggtatacatttgacatttcattttagcttgagagactgtagggaaaaaagggtcatcctctacataagcttccagagctgcttgctacccagcctcctagagtcattgctgggtacagtttgatttaccttcttcactttatttagaatttgtactcaaccaccatcaccaccatcacctttccctctcattgccttctctccagccttcactacagaccattcctggattggtttaaacaggcaactaaccttgccattatgattaaatgtttgtcatggatttagcccgtgtttggtgacaaatgccttatatctattgagacttctcaaagactctggatattctccattatgtctgaccttaaagtattgagcttggcatttagtaacaggattcatagatatttaaagataacttgaggacttgagacatatattttcttagtcttttctaccttttccttttctagcaaggcagcagaatagttccagtgattgtcttttggtaaaaaccattttgtgtcttatgttatttcattgttcttattttatttcattctaggtccaagggcagccattaatggtgcaggtcagtggaggccagctaatcacatcaactggccaacccatcatggtccaggctgtccctggtggacaaggtcaaaccatcatgcaagtacctgtttctggaacacagggtttgcagcaagtgagtaatatttaaaaatattgagcagtatatcagaggagaggtttcaaagaatagattattacaacctatttgataattgatattgcatttaactgcttcctaacccacattttgcattcagttgattttctgcctttatagtaccagtgatataaactagaactatgcagaaattggacagctccagtaatgactaagatattaggcatgatcttgaattgctgtaaagtatatgaagaggttagaatctagtttatagtatattttattttaaaagaaacaaaaatgagtatttagaaagttagaaaaataacaaaacgagcaaaaagtgggtccaaattaattaagtagaaaactgacgtatagaaaggataaataaaatctagattgtttaagcagaccaataaaacaggtaaatccagttgaaacactgattgagaaacagaaaacaaaagtaagcaaagatgtagaagagattaaaggaaggccaggcgcagtggctcatgcctgtgatcccagcacttggggaggccaaggcaggtggatcacttgaggccaggagttcaagaccagcctggccaacatgacaaaaccccatctctactaaaaataaaaaattagccgggcgtggtggcacgcacctgtaatcccagctacttggggggttgaggcataagatatcttgaacccaggaggcggaggttgcagtaagccaagattgtgccactgcactccaggctgggcaccagagcaagattctgtctcaaaaaaaaagaagagattaacagaaatatgtagaaatgttacatacaactctgtggcatcatattttaaaattagatatttctcatcgagatggcaaaaaaaaacaaaaagtcattatatccactgttaggatggatgtggagaaaaagaattaatcattatttttggtaatttaaaactgtagagttattttggaaaggcacctcactatctgttaaatacaatgaatatttgagctagcagtcccacttctgagaatctgtcctataggaagaaaagcatcaatagtagggggaaattacaaagacacttttcatagcattgtactagcaaaaaataaaattgcaatctgagtgtccattaataagaataaggaaatggttggaataaatcataatatattcatagggaatattgcatcatcattaaaagaaatgaactgttgacttggggtgggttaatattgaaatatttttagtggaaataatttgcagagaaatagtgtgtgatctcatctttgtaattcataaccaaccccccatgagtatatgtttatagtcatggaaaagagagtatgagataactattagttactctatctaaatgtttatattgtttcaacagttacagcagtcatattaatgtcttagttttctggaggaatttaagttgaaaaaagcagccatgatcccactgctcataaatcaaacttgtactttttgtgtattcttttgtgtttttatgcataatttttgggcataattgtaccatgcatgtggggttgtgttttcattttttttttttaattctttcataatgttcagtcaacttgatgaatcagaatttctaatttataaaatatagttaaggattttggttttcatttgcctttgtaggtaaacatttgggcacgatagttttatttttcaactgaattctcaggataatttctttggattggggattgcttgggtaaagggtaagagtatatttgagcccactggcatatttttgccaagatagaattgtacttgggattaaaaatagttttcacatttctctttgcataaatatatgaggctttaaatatcttttcagcatgtgctttccttgattccctattgctatatcctttctgttcttctctctttgcttcctctccagtcccccttgctgcgccttctccactgttgagtagagacaatgtggtatagttaggaacagtatactgtgagtgtagtggtccaagctttcattaccaggtctgccattaaataagcattctgatcttggccaagttatttaattgtcggtttgctcatccaaaaataaaatttatatgagatgatatctagggttcattctagctctaaattctgtgatttttatggggttttattttgctataaggaaccttcaaatagttatttccctgcttccaagtagggctataactaaccaagctgaaaaaaatatattctgttacgtaaataaagctctctaggtgagattccatagcctcccttacaatacttaaggctttaatcccctttgtataggagttttttttctcattagtgttgagtagccattttttaaagaagactacttcttaaccttttttgaattgtattctctattttagaatcctagtaaagcttgcaccctctaagaaaaagtagagatgtccagtctcatgaaaaattctgcatataattttagattaaaatccttggcctgagaaagatactggaaccagagagacagccaagaaatagatagaagaatattggaagttggcatataataaaagtggtataaacatatcaatgaagaaatggctgaagaatgatacagaaaagaaactgatttctaattcatactgtattttaaaaaatatttgctaggtggattaaagatctaaatgtagaaaagtaaacttggaaaattcaaaagaaaatataagaatttttatgctatagagaaggatatttttaaaaacaaattgactaaaacataatatgcattgaaatacatcaaataaaagtaaacaaggtgaaaacttggaaaagatatttttaatacatacaaccgagtttgtattcagaatatgtataaataacgtttatgtatttatacaaaaataggaaaatgggcgaagaatatgaatagatggaagaggaaatcctaacagccaatataaacttagaaatgaagttggttcacataaccagataaatttgtttacttatttatttgccaatactttctgaatgccaattatgagctgagtatttggaaaaaataattcagaagacctaggcaatctatcccctaacaaagtaggatccatgaatgtctctaagacatggaacccattgacctgtttttttcaccttccttccatcagtagtcctttttcctatcagctggtagactttgtgataacttaaggttctaggcatgttcttctttccagaccaaggtggtcccaagttgaaattatggatggaaagtgacctggctataaaaatctatctttctgaaagtatcctccttccagactgccatctatgttgaagcaatgctcaaataaaaaaagtttgttgatggaattaatggtcaaagaagcaaagagaaggttacttagtactagccatgtattctggcttttaagtttgggaggtattcttgaatataaaatacaagacattttgagctatggggctctcctcactgctttctcttttgcacttaaaaaaaaaagtgttcactagttatatgaaaataggattttgtacacccaacatttaaagggttgtattgcagttttttagttccaaaatttagagaaatatttttcaagcttcttgtcaggtttctgataacactcctaataaagtggctatagccattaaaaaaaagaaagaagatagatttggatagcacacgatcccttgctttccataattgctttataaggtttagctatccaatcctaggaccaaataggagatacaaattaaatcaacaaaaatttgacaaacattaatgacagtagtgagtattggtaattggaaactaataggaggaatataatctgtcacattgccttaattatctattaccatataacaaattatcctagaagttagcagcttaaaacaacaaacatttggccggtgcggtggcccacacctgtaatcccagcactttgggtggccgaggcgggtggatcacaaggtcaggagatcgagaccatcctggttaacacagtgaaaccccgtctctactaaaaagacaaaaaaaaaattaagccaggcgtgatggcggacgcctgtagtcccagctactcgggaggctgaggcaggagaatggcatgaacccaggaggcggagcttgcagtgagccaagatcacaccactgcactccagcctgagccacagagcgacactccgtctccaaaaaaaaaaaaaaaaaaaaaatttattttatagtttctgtgagttaggaatcctgacacagctgtgttggattctttcaaggtcctctcaaggcccttatcaaggtgttgtcctgggctgcagtcacatttgactagagtagaatacattttgggttttttctttgtttgtttttttgagacagttactcgctctgttgcctaggctggaatgcagtggtgcggatcttggctcactgcaacctctgcctcccaggctcaaatgatcctcccacctcagttccccaagtagctgggaccacaggcatgtcctaccatgcctggataatttttgtatttttcagtagatacagggttttgccatgttgcccaggctggtctcgaactcctgacctaatctgctcgcctcagcctcctgaagtgctgggattatgggcataagccattgtacccggctttcagcatttttaatatatatagtatttcctctgtaaaaaagtacttcatcattcaccaaaatggcaagattaaaaaataataataaagcactttagagtgtattttatttttttatttttttgagacggaatctcgctctgtcgcccaggctggagtgcagtggcgtgatctcggctcactgcaacctccgcctccggttcaagtgattttccggcctcagtctcccaagtagctgggattacaggcatgcaccaccatgcccggctaatctttgtatttttagtagagacagggtttcatcatgttggccaggctggtctcgaactcctgacctcaagtgatccacccacctcggccttccaaagtgcaaggattacaggcgtgagccaccacacccagcccagagtgtattttaaatatgcatgcttttcaatatatataatcataccactgctatctttcataaaaaccgacattgatttgttaatatcaggtatccagacagtgtcgaaattccctatttgtttcataaatggaaaataagttgtgtctacttcataatggagggcagagcaggacttcttttttcctcttcagaacattttctgctttctagagaaatgtggataactctcggggaccaaaggagaccagtgtcagtagagtacaatcctttttttatgttcttttctgcagatacagttggtcccacctggacagatccagatccagggtggacaggctgtgcaggtgcagggccagcagggccagacccagcagatcatcatccagcagccccagacggctgtcactgctggccagactcaggtaattccactagctctgtcacacaggagcaaaactgatttggaagagtcagataactgagtcagatatttcatgtatagcatgtatagtagaaaaggggatgaaaaccataaaaaaatatatttttggccgggcgcggtggctcatgcctgtaatcccagcactttgagaggccgaggcaagctgatcacaaggtcaagagatcaagaacatcctggccaacatggtgaagccccgtcaaaatacaaaaattaggtgggcatggtggcgcatgcctgtaatcccagctactcgggaggctgaggcagagaatcgcttgaacccaggaggcggaggttgcagtgagctgagattgcgccactgcactgcactccagcctggcgacagagtgagactctgtctcaaaaaaataatttttttttttaaggactacatcgttctttgttagtatctttgggatctgttgaattgtgtcattacttatttcctccagacacagcagcagattgctgtccagggacagcaagtggcacagactgctgaagggcagaccatcgtctatcaaccagttaatgcagatggcaccattctccagcaaggtaagtgtacccataagcttccctaggactttttggggcaacttttttgtcccttagacaactgacatctttagaatttgagtggtgaacttgacactacatattttttggacaaaaaaaaaaaagatttcctctagctctccattgattgttggtttcttgtcaccatctgtgaccaacagtgattccatgtgtagcagtttctatagtggttgctaatctagggattgtgtaagcttttagggaagaagtgtttctaaacagaagaatagaaatagggagttcattggtaaagagagaaatagatcaaaaatcaagttggctttagagtgctattgctgcttatgtttttttctgggtcattccattactttaaatgactattatgtatacagcacttttactaagaagggtcctcaaagagcctctagtctagtaagaaagacgtgaacaaataaatacaatgcagggccctcatggaagtatgttctaggaatagataacataaataatagatgtttggtctgggaggaggagtgcagaaactgaacttgaaggcttttggaagcacctgttagtcaaatagttaaatcaaaaaaggacatctttgttagattccatgactttgtgattgcaaatttgcaatatacaggatccagagagtgcactaactgtgtgctcttgtattactccagggaggccctgaactggattgagcccaggcaagagctcaaacagaatggtgaacaaatcctcaagtgctgctattgatagtctggggacttggaatgcttggtttaattttaagttttaatactacaactgactcattgtcagtttgagataaacaaagtataagttttaaaatctctgtcctgaagcagattgctcattatgtacaagagcagtaggtatagctgtagtcagactgacctgtagaagaggaggcctccaaaccttttcaccttttgaaaactgctaaggatagagttactcaaaactgggacctagacagttaatagaatttcaaagattgtgattacttagattatatatagcacaccacagtgggagagtactttttctccccttgtgtttttcagtgtgttttgccaggatcggtgagtgtataccagatagaagagggactaactatgttcccttctttctgttctgtgtgcctgttttttgtttgttttatgttttgttttcttaaagttacagtccctgtttcaggcatgatcactatcccagcagccagtttggcaggagcacagattgttcaaacaggagccaataccaacacaaccagcagtgggcaagggactgtcactgtgacactaccagtggcaggcaatgtggtcaattcaggagggatggtcatggtaagaaaatgtatttttcagctttgtctttgaaattttcttgaacatgcaacttgatgcctcctaaaatttattatgttgacctcttgggattgagatcgatccttaaggcactgtcggtaatctactttgacaataacattatgacaaaccataattcattctgagcacctactatgtgccagggactattcaccagggactattctagatgctggagataaagcaatggataaatagtgattttatggaattcttttcagaattcaaataacgaagggaattatatactaatctttgagaagtggaaagtagtattgcccatgatggacaaaataagaaataagctaaaaattagaaagattgtaattgatagagaaaccaaaaaaaaagtgtcatgtaaatgtattgggaagataggaagatttgggtggtgtaactgaaagctaaatcctcatatgtcaaaataggatgttaaaatgcataaattaagaatgagtaacagaagtctgcacagaggtggaggaagctatgaaaagaaacagaaccaaccctggctcagtggcatgcacctgtagtcctagctacttgggaggctaatccaggaggatggcttaagtccaggagtttgagctcagcctgggcaatgtagagagacctcgtttctacgaattgaatgaaaaataaataatttttataaaagattcaatacagttattcaaagcggttgtatttgggaaagagctgtggggtacaggactctgttacttgtttttacctacatttagtacagtgttttggtgttttttaagaaaaattaggattgaattataagttaactattatttttataaatataggcatttagtagcacttggtctatctatttttgtgctgtttttttgtcttatgactactgttcctgaccattagatggcagcagaaatatctagagccatgggtggacatgaattagggcatggttatatagtttctcagagtggcacctgaatctcctatgacacagtcatctggggtgtttgtttaaagtgcagatctttagtataaatttctccagggatccgcatttacccaagtaccctataaaaattactttttgtggcatttacaaaaaaaatggatgaagaggaaccaagaaactgtttctatgtccatacttcatgccaccaataagctctggtttcctgttcacacagatggttcctggggctggctctgtgcctgctatccaaagaatccctctacctggagcagagatgcttgaagaagagcctctctacgtgaatgccaaacaataccaccgtattcttaagaggaggcaagcccgagctaaactagaggcagaagggaaaattccaaaggagagaagggtatgtataacattgggaaggatataggaaaggagaatagcagggttctacttttgaaattatcttttatatggcttgttttctcacgtaccttccaaacaattgacgttagatacttgttgtctcttttgtaagagttagcatttgttattactaatatgcagctgcagttataataacgaaaacaaacagtggcttaaataagatgttattccttttcatacataaaagtagtccagagataaattatcctggactggtagcacattttcacagttctcaagacctgtttcactgctttaatattgctagtgtgctgttcatggtccaagattcctgcttaggctccagcctaggaagaaagggaacaagaaaggtaccctttcttttttttttttttcctgagactcagtcttgctctgtcatccaggccggagtgcagtggcacaatctcagctcactgcaacctgcaccttccatgttcaagtgattctcctgcctcagcctcctgagtagctgggattacaggtgtgcgccaccacgcccagcttatttttgtgtttttagtagagacggggtttcaccatgttggccaggctggtctcgaactcctgacctcaggtgatccacctgcctgggcctcccaaagtgccgggattataggcgtgagccaccatacccggccaggtaccctttctttcaaggaaactttgaagaagttgtgtaccttccactagccggaatttagttacctgatcacacctaacatgcagataaggctaggaaagtccagcctggtgtggtggcaaatgcctgtagtcctacttggaaggcagaggcaggaggatcacatgagccgaggaattcaaggctgcagtgattcatgatcatgccactgcagtccaacagcaagggtgtcagagtgaaaccctgtttctagaaaataataataataaactttaatgctaggaaagtctttttactgaacactcatttgctcaaacgaaatttggcctgttattaaagcagaggaaagtgtatatattgtgaagtgtaggtggtagtctgttattttttttaaaaaaaattcatactataagcattcacagtcttacagtagttatatatggttagctatattacttactaggtgttttctccaaagcttccatcgtcattctaagtcataattgtcccttgtgactttgatcccagctgtcttaaactttggagaatggaatttgtgcactagataactgtgctggttctggatagtattaatagttaaatggttttatttctcgttttagaaatacctgcatgagtctcggcaccgtcatgccatggcacggaagcgtggtgaaggtggacgatttttctctccaaaggaaaaggatagtccccatatgcaggtaggaagacatatacattttattcttctctttattaccttgtattgacttgagttgaagccttcagcagtgtcctcttgctattttcctactctgggactactcacattctctaaactggatgcaatcttatgtctctttagattatcttttatcttaaaaccactaggccagacttggtggctcatgcctgtaatcccaacactttgggaggctgaggtgggaagcccaggatttcaagaccagcctgggcaacatggcaaaactccatctctacaaaaaaatacaaaaactagccaggcctggtgatgcatgcctgtagtcccagctacttggagggttgagatgctcttcgtctttgtcacttattactattcattctttcttgaaaatcacacttttcttaattttcaaggaacaagttttatttttattgaacaggttttattaccccatcacaaatataatttgaatgtttacttttttcccttctaactgatgtgagcctggtctaatcctctcttctttggcttagatttataaaatagctgcttaatttggtttcccttcttccacttttgttcccctctagcctactctccacatcctagtgtgatctttttaaaatgtttatcctatcaagtccctgttctgctcaagctccttcaacccctaccctttcccatttgcacttagactgacatccaaagtgcttactactatgcccagcaaagccttacatgctccagctcctgtctacctctaactgcatttctacttcttggtctctatgctgctgtttactgttcattggtctacttcctgccacgggtctttgtccttagaattttcagtctgtatgccctttatctttttcatgcatgtctatctccctatctgttaggtctgggtttaattaaataccctatctagaatagatctcttctctctcagtatgttcttacaacatcttttctttttttggaggcagtggtgtgattatggctcactttagtcttgacctcccagctcaagtgatcctcccactttaggctcccgagtagctgggactatagccacgcaccaccatgcccagctaatttttaaattttttgtagaaatggagtctcactttgttgcccaggcaggtctcaaactcctaggctcaagcgatcctctcgccttggcctcccaaagtgctaggattacaggcgcacaccattgcacttggcccttttctttacagtgtaataatatttaagttgttgaatttttcaagattgtttccttcactagactgtaagttgtatagagggtagaggattgtttcgttctctgttatatttattggacttaattctatttaagtaagttgtatttaagtactgacttagatgtatttgttgggtttagtatccagttctgaaccaagcaatcagtgtttcttgaattaatagattcctcccatttgctgatactccattctatattaacatcacattccacttgcactattgcaatatccatcaaattaatctccagtctcctctaattggccttatatagtacttatacagtacatggttaaagtgttttttttaacctgccagtccccaggtcaaggatgcatgctattaatagttctcatttcttaactgcatcaaatctcaaactatttctgtataacatctaagcaactttgccttatcaccccctcaacaatcaaactaggtttcctcagtgtccccacacatgaacactaacaactctttcagtgctattaatcctcacctgtagtgtgagagcccctcctttctcattgctattcattcataacggtgtatgaatgtgggcctgacagctattgtggcaggagggcattgtgccaggaactctcctcattctgtgtgctaacaatatgatcttggtcaattcagcctcttttatttttatctgtaaagtggaatactgttgatacttcacagcaatgttgtagggatttcattcagtaatccacattaggcatctgtgtagcaccatacctagtgcatggtgagttcagtaaatgctagttgtttttgctcattgttcaagacccagttccagtcttccatctccagaaggctttcagctttttctcagatcctgcctaccaaggcttcagagccttggtatgggggaactaaaggtggttcttgcggagtgttgcaaaaagcttccaaggatttatccttgtgttaacacggtaggtcttaagtgagaaacagcatatagagtttagtggaaagaagatgaaatgggagtcaggagatttgggagttagcccttgctggactcctaactttctgaccctgaccctagtccacgcaaatcactttacccatctggccttcagatttatctgtaaaacgagtacattaaagtgtatagattctaatgattctttctagccctgctaagtactcagtatttaaatgatgatcaaaaaacagtgacaaaaatacagcatgacatggtttctctgggtcttttccttagacacctgaatctgaatactcttaacccttaagtatagagaacaacacaaggttcttaggaaagagatacactaacagccctgcagtgtttcaccatggagtgcaggccagactttaaattattttaagaataaggtttattgtctcttctttcctaatggggctacactttaagccatgtatgcagacttaagatgtattacaagcctttgatttacttggtaaagttatgtgtattctcttggggggataagtagtgagagccatgagttcctgttgcttttgcaaaggactttaatcatcatgtcatctttgtctctaggatccaaaccaagccgatgaagaagcaatgacacagatcatccgagtgtcctaaccccacgccatgtgatggagctgatcaaggtcatgtttctcactgttccaggaaattgatcaactcttccaatgggacattgatgatcacattctgccctttactacaggacagaaaccacttagtttttaataagtggctcagtattacaattgcagcgatgcctggcaaattgaagttgcaagcctttgtcttactctttcagtcaggacctatttcagactgttgatgacattgacatttcatggattcggatgatgcaaggagacacatgccaccccagcagtacacaaagcacttaccttgactggtgaagtcagccagccatctcagcagggaagaacaaccttctcaaccaaaactgcaatcaggaaagcagcagcccactccttcccatggaatctagacagcatttatccctctggtgggggaatctcacactgactaactgaatggacgctttgtattcagagatggcttccaggcaaggaagttctatcttgtgatacggaaacaataaattcctgagatacattcttccaatctgtggtaataataagaattcctctctgcccagatggtaggttgatatttctggactctagccaagaaaaagctaattctggggatagaatgataaaagactcaagcactaaaaatatacattgccgaatctctttttctagctttgaaaagttgtggcctgcttgtccctctgttgactggtcatctggaccatcgtacttgctgtggctacttctaagacaatgtagagggttattaaaccttgaaactgcctttcctaagtagagaacaagactattcaacaacttctttgctgaagcactgaggagatttgtaatactcctaaaggaagggccaaactagagattttcaatcatagactttgtgacagcatttggggaactaaaagattcatgtgtttcagcctagtgggagagagtgggggagaggaagagagagagagagcatgtatacccgtatgttatcatagagcacgattctccagtggatggatacctggaatggatcattaagatgaagagagtaattcacatttactctagaacctttaacaagcactgaaaggaagaagcctgagatttgatccttgacaatttctggaaagcactggtcagtcacactgtcctggacagagtccaagttacccactaaagcttgaggtggatgttggcttcactcctgcagcacaatgctggccctagaaagcgagcattttcattcttcccatggcagctgattctttggtgccagttttcatgttttctccataggccttgtgcagaaaggttttctcattgcatccatactgtgagaataaactgcagactgaaagaaacatgcctgcagggtcaggaactgggccactgttcccagaacgggttgtgcctcagaaatctatttctcttttagatgttgaaccctgagagaactaagatgatatttcagaagagttggctgccttctctggaaacaaggaaaacccaataattccgaggaacattgggggttaaataccaagaataaaaattggttcttctttgacttcagcttaactgtattaagacagaaattaagccctctaaaaacaccacaaagagagatgattgtaatgatagaaatagaggtacagagctatgcaaaggaaacaggaagtgaaatattcctagtcccagggatctggtaatcgctcctggcttccagatgtcaaaggactgatcctttggtaagctcactagaaacttctagctctacaagagtttgggatattaatgttattcagtaagtcccaagtttttcagagaatagattactaacaatgaggaatttatattccttggttaatttaggagtctaagatgcagagttcagaaagaaattactcagacctaactttgagtgcttaagctgccaacagttagaagatgctatttatttgtgtctgtaagtttgtacatagtaatgccagccttgttgctgaattttttatttggggggagatgactttgaattttgtttgaaatgcttcagttgtcattttgtcattgcatttcaaatagctcatgacccttttcttgtggtcactttggcacaccatagtagcccacaaagtgggggcagggtattgacatttggattttttctttgatactagttcttttattcatttttatttgtgactgtagtgataactttacagatggagaaagagtgaatggatgaatgaataattggtttaatgcctagttatgcaacttgagtgcttttttttttttttgcaggataattttaagtgtatatattttaactgcactggtacattgaacatgtcagtgtcgatgccactggaccaacagagcattttgtggctatagggtgcctgataataatgtcttgatttttctttgggattcaactatatcgaaggtttttcccccagcagtatgggggcgtacaggtgatcgatcattaatgtcattgcaattgttattttttaaaataaatttataaaaataaccgaaaagtaatgtgacttttgaggaatctgcaactcctgggttctagtttgtgtttccagtgttgaaattttgatctcccccgacaagacttgtctgcatggacggtgtctctgtaaacagtatcaaacttgtaatgtctgagcctcttagctttatctccccttaatttcttcccttttggcccttccaccctgttgaggagattttttctgtcacctgcaggctgatcatacatttgatgctactactgaaagtgtttatcaaaatgtgatgaagtaattccatgaggaaaattagccgttatcacaaaaacagccttaagtattgtagaatttcaggtagtgaagatgtactatttacgttttgttagattttgttttggcagaagaccaaaacaaaagtacttttctgattgttaaaaatccacagcatgctcaccttgttactgttttaccttacggtcgctgggaatctaagcaacaaagactagaagcctccgatatgccattatcaacacacaagagacaaacagcccgaggaagcactcaatgatgagagcagtagacctgccctggcagatgagagaggagaaactctccacaatgaaggaaaagcactgacagtatttgatagctttagtcaaactgtgcttgagtttggcttagatttatgccagtggaacctgtccttaccaaattcagagatgacccaagattctactctgtggtatgagggaaagacctctcgatatttatctcacaccaacggctttatcgtaggagcgtcttcgcctcccccgtttccagtagaaaagacagctttgctcctttgaaagcgcagaccgccgcacctccagccccttctccccggggaagtaggccccgctaagaatgtgggaaggtggtggggcggcgactgaagtcgcttccgattggcgttgtcccaaggaagcctgcgcggattgatcggcggcaggcctccaatagagcctgctaggcggattggctgctacgcggctgggccctgtttccggtacctaggcgggcagccatggtgaccggcgagcggcatgcgacgccgcctctgtggcctgtggaggcccgcttggcggcgctgcttcccgacctactggtctttcggaagcctcggggatgggaacccgagctcgccacggcccagggcgtcctcctaggcgtccatgtgacgggtgagggcgacggccggcacttgcacttaagtctcctggcctgcgggagaggcggccgttgggtctaagcccctggaggcctcgacggttacaggcctagcctcccgcgagctaaggcacagtttaacttcgtgctgcggcttccttaggaaactttgagtatcttcgttttagcgtgggaggacatcttttgggatgaaccggctcagtccttgagctcaccccaaagatgatgaaattgaaactcagaggaaaggatttttacaggaccacgccccgggctttgaacccgtttttcccaaccccgagcattttctattaagcgttctgtttcaattattttattcgttcagttaattcgttcttggcgtcataagtatatgcccgccgttgttctggccgtagctatctagcagccactccgcgagtcgttcatttaacaaatacttactctgtgtcagggatatgaagatgggtaataccaggtgcctgtcctcactgtgtgagtggttctctagccagacatgaggagggatcctattgtttcccatagctaggcagcctaagagagtaggggaaagagctggctccagatgaaaagggcaccatctccagctcttggaagcagagagggtggtcctttggattcccagtggcagcagcaaccaacctggcccttagtagtttctaagttacaccatgttaatggataaaggaattactcagcttgaagggatctgtttcctttacactggcctgatgtgtggggagaaaggggccaaaaagtttaggatttggagttaacatcgtaatttctgctttgttggtcagggtttacagcattaatggacaggttcaccctgacctacaagtcggaacgtgacatggacaaactggcccatatcttcagttattacattagtgacatcgtggagcgtgagtgatcattgtagggtaacaaggtgtggtgctgggctcctgggggtttataaaagaagggggccagaagtactttaaaacaggtaccaaagggtcattcctttagcatcattcatctttggtttcttcaagttgccactgaaaagctagacctttgcctattatctgctaatctacccagtctcacattctattgactcattgttcaaagggggggcaggaggagctaatttcctttgcacatttgtattttatttcaaaataaagtattctcttctaacaataacgtatctcaagtgtgtattcagacaaaatttataaaacatctttttattattatattttgatcctgtgaggaaggaataggtgttttcttattttctgccatgtattaagcttttagatatttgccagatatccagtatctggaaaaaactcatttatgtagtacccatgttttgagtacctaccctgtgacatggactgtaataggtgcaggcagggcaagaacccactcttgaactttttagttaggcctacccaacagaaattactctgaccttataccttttagtacttacgtaacattctcatcctttactgacagtgccctgtatgcttccgtccatcattctgagattcaccagaataattactttgaggcatctccgttaagaatttgattatttgacttacctcttatccttaaggaacacatggaaggtcgtttgctttttcttataggtttggatgaaggggaagataaacattctatatcgtgtatgtactctaataccagcaacttctgggtactagaactacaggggaaagtaagacagagtaccctcgtggagtttccattttagtgggacagacaataaacacaataattgtagcttatatattctatcaaggaaataaacatagtatagtggtaaaaaaaaaacacaaaaaataattttagggtaggggagtatatgagacagggtggtcataggctcctctgaggaggtattatttaagctgacacttgaaggatgaggggaacagcttgtgaagaactaggggtaaagcatttcagacagaataccaagtgcaaaggtcctgagacaggagaaagctcggcatgctctaggagctaaaagaaggccagtgcaggccaaaacgtagctcgcagggtgaagagtggtttgaggcaaggttgggggatggtagctatgagaccaccacgctctgtagtccatagtgaagagttggaattatatatttctgtataaaggaaaactgtggaaaggtctagcaggggagtaatatgatctgattaacactttaaagctgattttggctaccttgtggagattgaatgctggtggaaagtgaatttaagaatagaagctggaagaggcaattgtcctggaaagatgttggagatttggtctagagcagtggttctcaacctcagctgtggttgcctgaggagctttttaattgttttttcttttttctttttttttttttgtaagagactggggtctcagtatgttgccaagtttgtcttgaactctagagcttaaaagattcttctgcctcaacctctcaaatagctaggactgcaggtaccataccaccttgtctaacaaaaaatcttaatgcctaagcttcaccccaggccatttaaatcggactttcttaaggttggcccaggaataagaccttttaaagtttcataggcaattccaatgtgcggtcaagactgaagattgttggtgtagaggtatggcaggggagctgtgtggggtagattaacctgaaatatattttgcaggttcaacagacaggagttgctaatacgttgaatttcagtgggaagtggtgagaaaaaggactcagttttttggctttcataaatgaattgatcgtgtcatttaccaagacaggaaagactgaacattgagaaagaaaatcaagagttctgttttgagtatgttgagtttgagatgccaataagtcattcaagtggagaatgactccattcaagtggagaatccagctatgattgagcctggagctcagagaagagatccctgttagagatgaaaatgtgagttgatggcataaagtgggacttaaagttaagaaccgattgagttcatgttgggagagcataaataaagagaaagagcctttggctgaggcttgaggaactccaggggaggattatgataagggagaaagaacctgaaaaagagactacaaacagccagtgaggtaggatattgtggtgttcctgaagccaaaggagaggtagtgtctctagaagaaagctgcagctagctgggttgaaaatgacagctgtcaagtacagtgaggtcagagaggtattgaatttagcaagattaatgctgttgatgaccttgataatttgaagtggtggaggtagaagtcagagtggagtaagctgagaaaaagaatgacagagaaaacatttaagaggaagagtaaatgggagatgaggaaaatatatatagccaacttttttgagatttgggggttttgtttgttgtgaatgtagcaggaaaaaaaatggagctaataggcagaagataaggtagaaccaagaatatgtgggttatttttgtgtgttttggttttgttttttaagctattgatgagaatatttcagtagagagattaggaacggtgtgaagttcttgagaaggtaaaaggggataagattcctatcacaaatggggtggctttgaagagagcaggaattcttccattttagaaacgatgtatgtaggtgcagatagatttggggagaaaatgaaaagaaggaagaaggagcctgagtcttggagtgagcaaatggacaagaatgatgtcaggataaactcagtaggccattcttttgaccatatatgattctgccctgatctggtttatatctgattttgactcattttcctctctcttccttacttgatttcagatgttctctgttttggaggggatatcctaaatatcacaggtatttttttagtttttctgaatacttaaaagactgagtgaggaggactatatttaggtggaattcagcatattggtttattcagcattgtttgattaataggtactggaccctggggatacaaagatgaggaagacatagtctgtgcctcaaaggatcccccagtctaatggaaaagctttgcccaaattaaactctcacatgctttgcatttttgtttagattgaaggacagcaaaataagtgccaataaagcgttcttgagaaaactaatgagaaatttggtcattaatagcagaagctaagcatgagatggggaggagttaagcatgtcctatctggagaactcaggatcactaacagctgtatgccccggagttggcctgtcttcttatttaaacataataaaaccagccatcaaattagatatgaacttgaacccacattttatgaatcttttgctagtacctctcctcctctgttagtatactggtggaaggaagattaccaaaaatatccttaggatcatttaaacttctacctagttacgtttttactgaatgattttgaggatctgaagcagtattttaacctagcataatgtatacagccaagaaaccttgcctgataacttacttgatatccacactgggtcaagttgatcttctgcattactgggactttgccctggaccaagtaagtctagatatttggtccccatcagcctatcctgtgtgtctgcagggaacatgctcctggcactctggagagtagaacaaaatcaactgagtgacatcattaccttggtggcaaaatgcagtctggagatacaggagaaatttgggatctatcataccagggaaggccaggacctgcagttaaagataggtagtacctcctaaaagagtgatccagttgggcaagggggaacccactataaaaacctcaaaagataaatgataaactgggaaaaaatgtttgcaattcatatagacaaagggtgaattgctctactagggaaagagcacttagaaatcaagaaaacaatagtactcttaagagaaaaattggacaaaggacatgagtaaattgtatatagacaaggaaatgcatgtcttttaacacgtaaaaagatgatcaacattcataataagaaaaatgccaattggaagtacactgactacctgtcttacctatagataggcaaaacttcagatgctggacaatgtactctttggtgagtctgaggaatgagctttttcttactgtgagtgaacaacggtataaggtgatttggcaatctttatttatttttattgtctattgtattttttatgtcaacaaaaactaaaccatataaaaatatatattaaaaagtcttgttttcacttatataccatctatactatttactcttacaagtgcatttattccttaacctagcaatccttctggacatctataggtatacgttcacacatctgaaatgttgcatgtgcaaggttattgattgtaatatggtttgtaattttaaaacattgaaaactatttataggagactggttaagtaaataatatgtatactcaataagattacctgcaacttaaaaaaaataagatgtcttgatatggcagtatctccaagatacagttaagtgaaaaaaagtaagatacaaaacagcatgtttagtatgctaccatttgtgtaaggaggaaaataagaatttttcttatttgtttatatctttttttttttttgagatggagtcttgctctgtcacccaggctggagtgcagtggcgccatctcagctcactgcaagctccacctcccgggatcacaccattctcctgcctcagcctcctactgagtagctgggactacaggagcctgccaccacgcctggctaatttttttgtatttttagtagagacagggtttcaccgtgttagccaggatgttctcgatctcctgacctcgtgttccgcccgcctcggcctcccaaagtgctggaattacagacttgagccaccgcacctggcctatttgtttatatcttgtataaagaaacactggaaaaaatatataagaaactaataaaattactaatatcaggaaaatagtaaagatggtcatgtaggtagaagcaagattttaaaatacatattctttcatatagtttagtttttgaactatgttattgcttgacagaatcaaaaatataatacaatataataaaaattaaaaagctacatacaggggccaaagtttcaccaatggcagagtcaggattggaggcgaagctcaatatacaaagctccttcacaagggttcagaaaactcctcaagggcaaaagttggctccagctattcttttatgttttgaggagcagtggtaaaggattatattctgtcttatatggcatctcttttgtcctgccgtcttttttgtttcttttggtttttgttgtattaaggataattgatactatacattggcatatttatacacttttgaaaccatcaccacaataaagatagtgaacatacttatcactcaaaaagtctcctcgtgcccctttgtacattcttccactactctccttcaccatctccagacagacaaaatgtccatctccaggtgtattatataagagaaggaaatctgggggaagaattttttttttttttttttgagatggagtctcactctgttgcccaggctggcatgcagtggcacggtcttggctcactgcaacctccgcctccagggttcaagcaattcttctgcctaagcctcctgagtagctgggattataggtgtgcaccaccacgcctggctaatttttttttttttttttgtatttttagtagagacagggtttcaccatgttggtcaggctagtctcgagttcccaacctcaggtcatctgcccgtctcagcctcccaaagtgctgggattacaggcgtgagccaccgtgcctggccgtaaggtattatttttaaaggttagctcacctaagacttccgcagctgagggcagtaacaagataggcatgatgcacagagccatgtggggattccagacccctcctgttgcatagtttcccagttgaatttgactcttctccatttatctcatttttttctggataggtctacctgcaagtcggatttcccaggttattgttggagatgagcggcagcaatacctcttggtgattgggcaggttgtagtgatgtccagttagctcagcgtttggctcaggcgaatgaaattgtcctatcctggaactgctggatgctttgcaagcagtatatgtttgaagtggcaatcatgagggaggatgaagctgtgaaggtaggaggctagcttcctgtactgccattctgaaaaggccttcctagtacacagcgcaatgctctggtagtgttcacatattgcctggccaaaccaatgaccattggaactcaatttaggagggaggctgggaatattctcctatgaagatagatgaggtagaacagtgaggctgaggagataaaaggcaaacaagggcaatagaatcctcagcctttcttgtgtgggggcacagaattaaacagtttcctttctgtagttaagagatatgtggatc

SEQ ID NO: 18 - DNA, 2316 bp, Homo sapiens
  mRNA (1)...(2316): Human transcription factor-like 4 (TCFL4) mRNA
cgccacccgcttcctcgccgcagggggcccgcccgctggcccgtttccggtccggtgggtacaagatgacggagccgggcgcctctcccgaggacccttgggtcaaggtggagtatgcctacagcgacaacagcctggaccccgatgatgaggacagtgattaccaccaggaggcctacaaggagtcctacaaagaccggcggcggcgcgcacacactcaggctgagcagaagaggagggacgccatcaagagaggctatgatgaccttcagaccatcgtccccacttgccagcagcaggacttctccattggctcccaaaagctcagcaaagccatcgttctacaaaagaccattgactacattcagtttttgcacaaggagaagaaaaagcaggaggaggaggtgtccacgttacgcaaggatgtcaccgccctaaagatcatgaaagtgaactatgagcagattgtgaaggcacaccaggacaacccccatgaaggggaggaccaggtctctgaccaggtcaagttcaacgtgtttcaaggcatcatggattccctgttccagtccttcaatgcctccatctcagtggccagcttccaggagctgtcagcgtgtgtcttcagctggatcgaggagcactgtaagcctcagaccctgcgggagattgtgattggcgtcctgcaccaattgaaaaaccagctttactgaccggttcttggaaacctggagaacagccaacaagaggcccttgaatctctacgtggccactgaactgctgggcccgggagactggactacaacacctcacactggtcagctggtttctacttggtgtttggtttttcccagccccattttatcttcagcggagccgcggtgtttgttttgtgaaagcttctgattaatttattatattgacgataaaactcaaacctacccagccttccccccactccatggaagtccttgggatgggcgtctgctctggacaccccaaagagctcctgccctctcagccctttattcaagcctcagatttctgctcatgatctacatagatttggaaactgttttcctctgttttggtctcttgggcaacatttttggcccaagtttgggcaacatttggcccaagtttgggcattttggcagtagctgtatgggagaaaaagagtaagaggaaatattcccacagccatgaagggtgaaagggcaccttgtgcctagactagggctgcctggtcagtcccaggtgaggccaagggctttctggccatctcagggaggggccaccaggttcctcccctcaccccatattccatcaccttcctcctctgctctgggtggtaagggaagccctcccggttcccacaggctatgatgctgcatggcagaggcaggtataacacagcactacatattggaaattttttatttttctaaataccaatgcagttttgctacggttacaattttgaaatattaactgagcctcaaaatcaccctttctgtcaagcatatcttggcctctcccatgtctcagtgttgcctgcatttctcccaggacttgggggtggggtgaaaagcgtacaaaagatacttaaaagggctcctggggtacacaagcccagcaggtcctgagtgaagccgtgggccctccaaatgctcgttttatagcaacctctctctaccctagttctccaaattcacttctgccttcctcaggtttgatatctggcaggtttgactatccagaggaaattaaatatttttatataaaattaaattataataaatattgccaaatgctttcctttagcattgttccaagtctaaatgttaacctcaagctactgcaatttagacaatgaaatgggctgggtctacccccagccaccagccctcatcctctctacccagtgctctggtttatgcttgtctcctgactgctctgcttaaaggtgaaagtagcaggaacaacaacaaaagccaaccaaaaacaaggtagccagtgcaagacatctcactcttctgacatcctgcagtccccaccagtcctgaccgtgggcccctcaggggtctgggagtgtgacgttgtaatcttcatccgtctctatcccaacttcctcctgtgagacagggagacaagtgaatgagatgtcaccaggataagaccacagggaagcaaagaaggaagagagctccacttacaaagaactgcttcttgctcttggggtatccttcaagtattgcatcagacagctctgtagcctgacaagaaataaaaccacccgttttcagatgggcaaaaaaa

SEQ ID NO: 19 - DNA, 2964 bp, Homo sapiens
  mRNA (1)...(2964): Human mitogen-activated protein kinase kinase kinase kinase 2 (MAP4K2) mRNA
cagagccacgggcgcccgccccgccccgcgccgccccgcgccggctccgcagctcgcgcccgcccgcctgccggcccgcccggcgccgggccatggcgctgctgcgggatgtgtcgctgcaggacccgcgggaccgcttcgagctgctgcagcgcgtgggggccgggacctatggcgacgtctacaaggcccgcgacacggtcacgtccgaactggccgccgtgaagatagtcaagctagacccaggggacgacatcagctccctccagcaggaaatcaccatcctgcgtgagtgccgccaccccaatgtggtggcctacattggcagctacctcaggaatgaccgcttgtggatctgcatggagttctgcggagggggctccctgcaggagatttaccatgccactgggcccctggaggagcggcagattgcctacgtctgccgagaggcactgaaggggctccaccacctgcattctcaggggaagatccacagagacatcaagggagccaaccttctcctcactctccagggagatgtcaaactggctgactttggggtgtcaggcgagctgacagcgtctgtggccaagaggaggtctttcattgggactccctactggatggctcccgaggtggctgctgtggagcgcaaaggtggctacaatgagctatgtgacgtctgggccctgggcatcactgccattgagctgggcgagctgcagccccctctgttccacctgcaccccatgagggccctgatgctcatgtcgaagagcagcttccagccgcccaaactgagagataagactcgctggacccagaatttccaccactttctcaaactggccctgaccaagaatcctaagaagaggccgacagcagagaagctcctgcagcacccgttcacgactcagcagctccctcgggccctcctcacacagctgctggacaaagccagtgaccctcatctggggaccccctcccctgaggactgtgagctggagacctatgacatgtttccagacaccattcactcccgggggcagcacggcccagccgagaggaccccctcggagatccagtttcaccaggtgaaatttggcgccccacgcaggaaggaaactgacccactgaatgagccgtgggaggaagagtggacactactgggaaaggaagagttgagtgggagcctgctgcagtcggtccaggaggccctggaggaaaggagtctgactattcggtcagcctcagaattccaggagctggactccccagacgataccatgggaaccatcaagcgggccccgttcctagggccactccccactgaccctccagcagaggagcctctgtccagtcccccaggaaccctgcccccacctccttcaggccccaacagctccccactgctgcccacggcctgggccaccatgaagcagcgggaggatcctgagaggtcatcctgccacgggctccccccaactcccaaggtgcatatgggcgcctgcttctccaaggtcttcaatggctgccccctgcggatccacgctgctgtcacctggattcaccctgttactcgggaccagttcctggtggtaggggccgaggaaggcatctacacactcaacctgcatgaactgcatgaggatacgctggagaagctgatttcacatcgctgctcctggctctactgcgtgaacaacgtgctgctgtcactctcagggaaatccacgcacatctgggcccatgacctcccaggcctgtttgagcagcggaggctacagcaacaggttcccctctccatccccaccaaccgcctcacccagcgcatcatccccaggcgctttgctctgtccaccaagattcctgacaccaaaggctgcttgcagtgtcgtgtggtgcggaacccctacacgggtgccaccttcctgctggccgccctgcccaccagcctgctcctgctgcagtggtatgagccgctgcagaagtttctgctgctgaagaacttctccagccctctgcccagcccagctgggatgctggagccgctggtgctggatgggaaggagctgccgcaggtgtgtgttggggccgaggggcctgaggggcccggctgccgcgtcctgttccatgtcctgcccctggaggctggcctgacgcccgacatcctcatcccacctgaggggatcccaggctcggcccagcaggtgatccaggtggacagggacacaatcctagtcagctttgaacgctgtgtgaggattgtcaacatgcagggcgagcccacggccacactggcacctgagctgacctttgatttccccatcgagactgtggtgtgcctgcaggacagtgtgctggccttctggagccatgggatgcaaggccgaagcctggataccaatgaggtgacccaggagatcacagatgaaacaaggatcttccgagtgcttggggcccacagagacatcatcctggagagcattcccactgacaacccagaggcgcacagcaacctctacatcctcacgggccaccagagcacctactaagagcagcgggcctgtccaggggctccccgccccaccccacgccttagctgcaggcccttttgggcaaaggggcccatcctagaccagaggagcccaggccctggccctgctggggctgaaggtcagaagtaatcctgagaaatgtttcaggcctggggagggaggggagcccccgacgcctctgcaataactggaccagggggagctgctgtcactcccccatccccgaggcagcccagtccctagtgcccaaggcagggaccctgggcctgggccatccattccattttgttccacatttcctttctactctttctgccaagagcctgcccctgcatttgtcctgggaaacacggtatttaagagagaactatattggtattaaagctggtttgttttaaaaaaaaaa

(19) United States
(12) Patent Application Publication
(10) Pub. No.: US 2007/0289889 A1
(43) Pub. Date: Dec. 20, 2007

(54) Biomarkers For The Prediction Of Drug-In Duced Diarrhea

(75) Inventor: Curt Douglas Wolfgang, Germantown, MD (US)

Correspondence Address: NOVARTIS;CORPORATE INTELLECTUAL PROPERTY, ONE HEALTH PLAZA 104/3, EAST HANOVER, NJ, 07936-1080, US

(73) Assignee: NOVARTIS AG, BASEL, SWITZERLAND (CH)

(21) Appl. No.: 10/574,769

(22) PCT Filed: Oct. 5, 2004
(86) PCT No.: PCT/EP04/11122

§ 371 Date: Mar. 13, 2007

Related U.S. Application Data
(60) Provisional application No. 60/508,973, filed on Oct. 6, 2003.

(51) Int. Cl. A61J 1/00

(52) U.S. Cl. 206/459.5

(57) ABSTRACT

The invention provides biomarkers for the prediction of diarrhoea based upon the gene expression of certain genes by the subject, the expression of the Diego blood type by the subject, or the results of haematological assays.

### FIELD OF THE INVENTION

This invention relates generally to the analytical testing of tissue samples in vitro, and more particularly to the analysis of gene expression profiles or haematology profiles as biomarkers for predicting drug-induced diarrhoea.

### DESCRIPTION OF THE RELATED ART

Epothilone B (EPO906) is currently being studied as single-agent therapy against many forms of solid tumours. The mechanism of epothilone B is similar to the taxane family of cytotoxics. Epothilone B acts by promoting microtubule polymerization that leads to a mitotic block in the cell cycle, ultimately leading to apoptotic cell death. Rothermel J et al., Semin. Oncol. 30(3 Suppl 6):51-5 (June 2003). An advantage of epothilone B over the taxane class of antiproliferation drugs is that epothilone B is equally cytotoxic to drug-sensitive and multidrug-resistant cells overexpressing P-glycoprotein.

With no myelosuppression having been observed to date, epothilone B-induced diarrhoea is the dose-limiting toxicity. Rothermel J et al., Semin. Oncol. 30(3 Suppl 6):51-5 (June 2003). Drug-induced diarrhoea is not unique to epothilone B. Diarrhoea has been reported for a variety of anticancer drugs targeted to inhibit the cell cycle, such as CPT-11 and paclitaxel. Trifan O C et al., Cancer Res. 62 (20):5778-84 (2002); Mavroudis D et al., Oncology 62 (3):216-22 (2002).

There is a need in the art to increase the safety and efficacy of epothilone B anti-cancer therapy in individual patients by predicting whether the patients will experience drug-induced diarrhoea and by targeting appropriate therapies to the individual patients.

### SUMMARY OF THE INVENTION

The invention provides methods for determining subjects who are at risk for developing drug-induced diarrhoea based upon an analysis of biomarkers present in the subject to be treated. In one embodiment, the invention provides for the use of genomic analyses to identify patients at risk for experiencing diarrhoea during therapy with a with a microtubule stabilizing agent. In a particular embodiment, the therapy involves the administration of epothilone B for treating solid tumours. The diarrhoea prediction involves the determination of gene expression profiles from the subject to be treated. In another embodiment, the invention provides methods for determining optimal treatment strategies for these patients. The prediction could therefore provide means of safer treatment regimens for the patient by helping the clinician to either (1) alter the dose of the drug, (2) provide additional or alternative concomitant medication or (3) choosing not to prescribe that drug for that patient.

The invention also provides a method for determining subjects who are at risk for developing drug-induced diarrhoea based upon a determination of whether the subject to be treated has the Diego blood type.

The invention also provides clinical assays, kits and reagents for predicting diarrhoea prior to taking a drug. In one embodiment, the kits contain reagents for determining the gene expression of certain genes, where the expression profile of the genes is a biomarker for the risk of the subject for experiencing diarrhoea. In one embodiment, the gene expression pattern indicative of increased risk is a higher than normal expression of the gene for Interferon regulatory factor 5 (IRF5; SEQ ID NO:1). In one embodiment, the gene expression pattern indicative of increased risk is a lower than normal expression of one or more genes selected from Cell division cycle 34 (CDC34; SEQ ID NO:2); BCL2/adenovirus E1B 19 kDa interacting protein 3-like (BNIP3L; SEQ ID NO:3); Tubulin, beta (SEQ ID NO:4); 2,3-bisphosphoglycerate mutase (BPGM; SEQ ID NO:5); Aminolevulinate, delta-, synthase 2 (ALAS2; SEQ ID NO:6); Selenium binding protein 1 (SELENBP1; SEQ ID NO:7); and Solute carrier family 4, anion exchanger, member 1 (erythrocyte membrane protein band 3, Diego blood group) (SLC4A1; SEQ ID NO:8). The invention also relates to the use of mRNA or haematology (haematocrit and haemoglobin levels) to identify patients at risk for experiencing drug-induced diarrhoea either prior to taking a drug or during the drug therapy, and methods to determine optimal treatment strategies for these patients.

### BRIEF DESCRIPTION OF THE DRAWINGS

FIG. 1 is a chart showing haematocrit (HCT) and levels for clinical pharmacogenetics (CPG) consenting subjects after a single dose of epothilone B based on whether the subject experienced diarrhoea. The timepoint used to generate the data for this figure was the second blood draw after baseline in cycle 1, corresponding to the first blood draw after the first epothilone B treatment. (A) All CPG subjects, P=0.0013; (B) Female CPG subjects, P=0.012; (C) Male CPG subjects, no ANOVA analysis could be performed due to sample size.

FIG. 2 is a chart showing haemoglobin (HGB) and levels for CPG-consenting subjects after a single dose of epothilone B based on whether the subject experienced diarrhoea. The timepoint used to generate the data for this figure was the second blood draw after baseline in cycle 1, corresponding to the first blood draw after the first epothilone B treatment. (A) All CPG subjects, P=0.0015; (B) Female CPG subjects, P=0.023; (C) Male CPG subjects, no ANOVA analysis could be performed due to sample size.

FIG. 3 is a chart showing haematocrit (HCT) levels for all subjects after epothilone B treatment based on whether the subject experienced diarrhoea. The timepoint used to generate the data for this figure was the second blood draw after baseline in cycle 1, corresponding to the first blood draw after the first epothilone B treatment. (A) All subjects, P=0.045; (B) Female subjects, P=0.322; (C) Male subjects, P=0.040.

FIG. 4 is a chart showing haemoglobin (GB) levels for all subjects after epothilone B treatment based on whether the subject experienced diarrhoea. The timepoint used to generate the data for this figure was the second blood draw after baseline in cycle 1, corresponding to the first blood draw after the first epothilone B treatment. (A) All subjects, P=0.046; (B) Female subjects, P=0.292; (C) Male subjects, P=0.042.

FIG. 5 is a chart showing haematocrit (HCT) levels for CPG-consenting subjects at baseline based on whether the subject experienced diarrhoea. The timepoint used to generate the data for this figure was the baseline value. (A) All CPG subjects, P=0.0002; (B) Female CPG subjects, P=0.003; (C) Male CPG subjects, no ANOVA analysis could be performed due to sample size.

FIG. 6 is a chart showing haemoglobin (HGB) levels for CPG-consenting subjects at baseline based on whether the subject experienced diarrhoea. The timepoints used to generate the data for this figure was the baseline value. (A) All CPG subjects, P<0.0001; (B) Female CPG subjects, P=0.0004; (C) Male CPG subjects, no ANOVA analysis could be performed due to sample size.

FIG. 7 is a chart showing haematocrit (HCT) levels for all subjects at baseline based on whether the subject experienced diarrhoea. The timepoint used to generate the data for this figure was the baseline value. (A) All subjects, P=0.079; (B) Female subjects, P=0.317; (C) Male subjects, P=0.118.

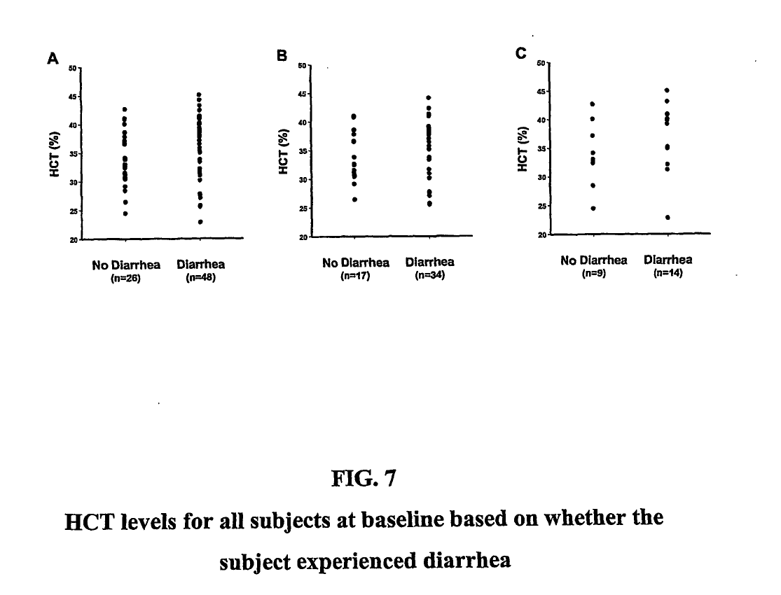

FIG. 8 is a chart showing haemoglobin (HGB) levels for all subjects at baseline based on whether the subject experienced diarrhoea. The timepoint used to generate the data for this figure was the baseline value. (A) All subjects, P=0.072; (B) Female subjects, P=0.254; (C) Male subjects, P=0.092.

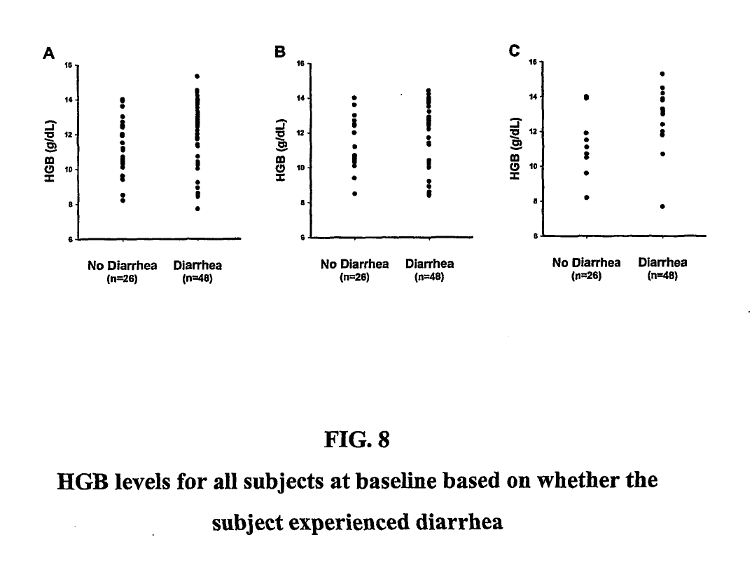

### DESCRIPTION OF THE PREFERRED EMBODIMENTS

The invention advantageously provides a way to determine whether a patient will experience diarrhoea during drug treatment, either prior to actually taking the drugs or during the course of treatment.

A group of eleven genes were identified as having statistically significant differences in expression levels when comparing the test samples to their respective baseline samples. In addition, a group of eight genes were identified to have statistically significant differences in expression levels when comparing subjects who did not experience diarrhoea to those who experienced any grade of diarrhoea. These genes were identified following a Phase L dose-finding clinical trial, which was undertaken in which epothilone B was administered weekly to adult patients with advanced solid tumours. A clinical pharmacogenetics (CPG) analysis identified biomarker candidates for the incidence of epothilone B-induced diarrhoea. The analysis also identified genomic-based factors (such as mRNA expression profiles) that are associated with the incidence of epothilone B-induced diarrhoea.

As used herein, a gene expression profile is predictive of the occurrence of diarrhoea when the increased or decreased gene expression is an increase or decrease (e.g., at least a 1.5-fold difference) over the baseline gene expression following administration of a microtubule stabilizing agent. Alternatively, a gene expression profile is also predictive of the occurrence of diarrhoea when the increased or decreased gene expression correlates significantly with subjects who develop drug induced diarrhoea and/or the lack of increased or decreased gene expression correlates significantly with subjects who do not develop drug induced diarrhoea.

As used herein, a gene expression pattern is “higher than normal” when the gene expression (e.g., in a sample from a treated subject) shows a 1.5-fold difference (i.e., higher) in the level of expression compared to the baseline samples. A gene expression pattern is “lower than normal” when the gene expression (e.g., in a sample from a treated subject) shows a 1.5-fold difference (i.e., lower) in the level of expression compared to the baseline samples.

Furthermore, clinical pharmacogenetics subjects who did not experience diarrhoea had significantly lower haematocrit and haemoglobin levels compared to those clinical pharmacogenetics subjects that experienced diarrhoea both at baseline and after epothilone B treatment. Thus, these genes and markers are useful as biomarkers in the blood for the prediction of diarrhoea by monitoring gene expression in the blood at either baseline or after drug treatment.

These results can reasonably be extrapolated to the prediction of diarrhoea in patients following the administration of any diarrhoea-inducing microtubule stabilizing agent or derivative thereof, based upon the structural similarity or the modes of action in the gut of microtubule stabilizing agent to epothilone. See, Su et al., Angew. Chem. Int. Ed. Engl. 36(19): 2093-2096 (1997) and Chou et al., Proc. Natl. Acad. Sci. USA 95: 9642-9647 (August 1998). The microtubule stabilizing agent may be paclitaxel, an epothilone, discodermolide or an analogue, or laulimalide or an analogue. U.S. Pat. Appln. 20030114450. Among the epothilones and epothilone derivatives are those described in U.S. Pat. Nos. 5,969,145, 6,583,290 and 6,605,726; U.S. Pat. Applns. 20020028839 and 20030114450; PCT patent publications WO 99/54330, WO 99/54319, WO 99/54318, WO 99/43653, WO 99/43320, WO 99/42602, WO 99/40047, WO 99/27890, WO 99/07692, WO 99/02514, WO 99/01124, WO 98/25929, WO 98/22461, WO 98/08849, and WO 97/19086; and German Pat. No. DE 41 38 042. In a preferred embodiment of the invention, the microtubule stabilizing agent is epothilone B or an analogue thereof, such as BMS-247550.

Moreover, the results can be extrapolated to the prediction of diarrhoea in patients who are being treated for diseases other than solid tumours. The method of the invention is applicable to vertebrate subjects, particularly to mammalian subjects, more particularly to human subjects.

Techniques for the detection of gene expression of the genes described by this invention include, but are not limited to northern blots, RT-PCT, real time PCR, primer extension, RNase protection, RNA expression profiling and related techniques. Techniques for the detection of gene expression by detection of the protein products encoded by the genes described by this invention include, but are not limited to, antibodies recognizing the protein products, western blots, immunofluorescence, immunoprecipitation, ELISAs and related techniques. These techniques are well known to those of skill in the art. Sambrook J et al., Molecular Cloning: A Laboratory Manual, Third Edition (Cold Spring Harbor Press, Cold Spring Harbor, 2000). In one embodiment, the technique for detecting gene expression includes the use of a gene chip. The construction and use of gene chips are well known in the art. See, U.S. Pat. Nos. 5,202,231; 5,445,934; 5,525,464; 5,695,940; 5,744,305; 5,795,716 and 5,800,992. See also, Johnston, M. Curr Biol 8:R171-174 (1998); Iyer V R et al., Science 283:83-87 (1999) and Elias P, “New human genome ‘chip’ is a revolution in the offing” Los Angeles Daily News (Oct. 3, 2003).

The synthesis and use of epothilones and epothilone derivatives are described in U.S. Pat. Nos. 5,969,145, 6,583,290 and 6,605,726; PCT patent publications WO 99/54330, WO 99/54319, WO 99/54318, WO 99/43653, WO 99/43320, WO 99/42602, WO 99/40047, WO 99/27890, WO 99/07692, WO 99/02514, WO 99/01124, WO 98/25929, WO 98/22461, WO 98/08849, and WO 97/19086; German Pat. No. DE 41 38 042; and scientific references cited therein.

As used herein, the administration of an agent or drug to a subject or patient includes self-administration and the administration by another.

The diagnosis of diarrhoea and other side effects of epothilone administration can be readily accomplished by those of skill in the medical arts. Rothermel J et al., Semin. Oncol. 30(3 Suppl 6):51-5 (June 2003). Diarrhoea may be treated with antidiarrhoeal agents such as opioids (e.g. codeine, diphenoxylate, difenoxin, and loeramide), bismuth subsalicylate, and octreotide. Nausea and vomiting may be treated with antiemetic agents such as dexamethasone, metoclopramide, diphenyhydramine, lorazepam, ondansetron, prochlorperazine, thiethylperazine, and dronabinol.

The maximum tolerated dose (MTD) for a compound is determined using methods and materials known in the medical and pharmacological arts, for example through dose-escalation experiments. One or more patients is first treated with a low dose of the compound, typically 10% of the dose anticipated to be therapeutic based on results of in vitro cell culture experiments. The patients are observed for a period of time to determine the occurrence of toxicity. Toxicity is typically evidenced as the observation of one or more of the following symptoms: vomiting, diarrhoea, peripheral neuropathy, ataxia, neutropaenia, or elevation of liver enzymes. If no toxicity is observed, the dose is increased 2-fold, and the patients are again observed for evidence of toxicity. This cycle is repeated until a dose producing evidence of toxicity is reached. The dose immediately preceding the onset of unacceptable toxicity is taken as the MID. A determination of the MTD for epothilone B is provided above.

Definitions. As used herein, “medical condition” includes but is not limited to any condition or disease manifested as one or more physical and/or psychological symptoms for which treatment is desirable, and includes previously and newly identified diseases and other disorders.

As used herein, the term “clinical response” means any or all of the following: a quantitative measure of the response, no response, and adverse response (i.e., side effects).

In order to deduce a correlation between clinical response to a treatment and a gene expression pattern, data is obtained on the clinical responses exhibited by a population of individuals who received the treatment, hereinafter the “clinical population”. This clinical data may be obtained by analyzing the results of a clinical trial that has already been run and/or the clinical data may be obtained by designing and carrying out one or more new clinical trials.

As used herein, the term “clinical trial” means any research study designed to collect clinical data on responses to a particular treatment, and includes but is not limited to phase I, phase II and phase III clinical trials. Standard methods are used to define the patient population and to enroll subjects.

It is preferred that the individuals included in the clinical population have been graded for the existence of the medical condition of interest. This grading of potential patients could employ a standard physical exam or one or more lab tests. Alternatively, grading of patients could use gene expression pattern for situations where there is a strong correlation between gene expression pattern and disease susceptibility or severity.

The therapeutic treatment of interest is administered to each individual in the trial population and each individual's response to the treatment is measured using one or more predetermined criteria. It is contemplated that in many cases, the trial population will exhibit a range of responses and that the investigator will choose the number of responder groups (e.g., low, medium, high) made up by the various responses.

After both the clinical and polymorphism data have been obtained, correlations between individual response and gene expression pattern are created. Correlations may be produced in several ways.

These results are then analyzed to determine if any observed variation in clinical response between polymorphism groups is statistically significant. Statistical analysis methods which may be used are described in L. D. Fisher & G. vanbelle, Biostatistics: A Methodology for the Health Sciences (Wiley-Interscience, New York, 1993). This analysis may also include a regression calculation of which polymorphic sites in the gene give the most significant contribution to the differences in phenotype.

A second method for finding correlations between gene expression pattern and clinical responses uses predictive models based on error-minimizing optimization algorithms. One of many possible optimization algorithms is a genetic algorithm (R. Judson, “Genetic Algorithms and Their Uses in Chemistry” in Reviews in Computational Chemistry, Vol. 10, pp. 1-73, K. B. Lipkowitz and D. B. Boyd, eds. (VCH Publishers, New York, 1997). Simulated annealing (Press et al., “Numerical Recipes in C: The Art of Scientific Computing”, Cambridge University Press (Cambridge) 1992, Ch. 10), neural networks (E. Rich and K. Knight, “Artificial Intelligence”, 2nd Edition McGraw-Hill, New York, 1991, Ch. 18), standard gradient descent methods (Press et al., supra Ch. 10), or other global or local optimization approaches (see discussion in Judson, supra) could also be used.

Correlations may also be analyzed using analysis of variation (ANOVA) techniques to determine how much of the variation in the clinical data is explained by different subsets of the polymorphic sites in the gene. ANOVA is used to test hypotheses about whether a response variable is caused by or correlated with one or more traits or variables that can be measured (Fisher & vanbelle, supra, Ch. 10).

From the analyses described above, a mathematical model may be readily constructed by the skilled artisan that predicts clinical response as a function of gene expression pattern.

The identification of an association between a clinical response and a genotype or haplotype (or haplotype pair) for the gene may be the basis for designing a diagnostic method to determine those individuals who will or will not respond to the treatment, or alternatively, will respond at a lower level and thus may require more treatment, i.e., a greater dose of a drug. The diagnostic method may take one of several forms: for example, a direct DNA test (i.e., of gene expression pattern), a serological test, or a physical exam measurement. The only requirement is that there be a good correlation between the diagnostic test results and the underlying genotype or haplotype that is in turn correlated with the clinical response. In a preferred embodiment, this diagnostic method uses the predictive haplotyping method described above.

A computer may implement any or all analytical and mathematical operations involved in practicing the methods of the present invention. In addition, the computer may execute a program that generates views (or screens) displayed on a display device and with which the user can interact to view and analyze large amounts of information relating to the gene and its genomic variation, including chromosome location, gene structure, and gene family, gene expression data, polymorphism data, genetic sequence data, and clinical data population data (e.g., data on ethnogeographic origin, clinical responses, gene expression pattern for one or more populations). The polymorphism data described herein may be stored as part of a relational database (e.g., an instance of an Oracle database or a set of ASCII flat files). These polymorphism data may be stored on the computer's hard drive or may, for example, be stored on a CD-ROM or on one or more other storage devices accessible by the computer. For example, the data may be stored on one or more databases in communication with the computer via a network.

In other embodiments, the invention provides methods, compositions, and kits for determining gene expression pattern in an individual. The methods and compositions for establishing the gene expression pattern of an individual described herein are useful for studying the effect of the polymorphisms in the etiology of diseases affected by the expression and function of the protein, studying the efficacy of drugs targeting, predicting individual susceptibility to diseases affected by the expression and function of the protein and predicting individual responsiveness to drugs targeting the gene product.

In yet another embodiment, the invention provides a method for identifying an association between a gene expression pattern and a trait. In preferred embodiments, the trait is susceptibility to a disease, severity of a disease, the staging of a disease or response to a drug. Such methods have applicability in developing diagnostic tests and therapeutic treatments for all pharmacogenetic applications where there is the potential for an association between a genotype and a treatment outcome including efficacy measurements, PK measurements and side effect measurements.

The invention also provides a computer system for storing and displaying polymorphism data determined for the gene. The computer system comprises a computer processing unit; a display; and a database containing the gene expression pattern data. The gene expression pattern data may include the gene expression pattern in a reference population. In a preferred embodiment, the computer system is capable of producing a display showing gene expression pattern organized according to their evolutionary relationships.

As used herein, the term “complementary” means exactly complementary throughout the length of the oligonucleotide in the Watson and Crick sense of the word.

As used herein, “expression” includes but is not limited to one or more of the following: transcription of the gene into precursor mRNA; splicing and other processing of the precursor mRNA to produce mature mRNA; mRNA stability; translation of the mature mRNA into protein (including codon usage and tRNA availability); and glycosylation and/or other modifications of the translation product, if required for proper expression and function.

In practicing the present invention, many conventional techniques in molecular biology, microbiology and recombinant DNA are used. These techniques are well-known and are explained in, e.g., “Current Protocols in Molecular Biology”, Vols. I-III, Ausubel, Ed. (1997); Sambrook et al., “Molecular Cloning: A Laboratory Manual”, 2nd Ed., Cold Spring Harbor Laboratory Press, Cold Spring Harbor, N.Y. (1989); “DNA Cloning. A Practical Approach”, Vols. I and II, Glover, Ed. (1985); “Oligonucleotide Synthesis”, Gait, Ed. (1984); “Nucleic Acid Hybridization”, Hames & Higgins, Eds. (1985); “Transcription and Translation”, Hames & Higgins, Eds. (1984); “Animal Cell Culture”, Freshney, Ed. (1986); “Immobilized Cells and Enzymes”, IRL Press (1986); Perbal, “A Practical Guide to Molecular Cloning”; the series, Methods in Enzymol. (Academic Press, Inc., 1984); “Gene Transfer Vectors for Mammalian Cells”, Miller and Calos, Eds., Cold Spring Harbor Laboratory, NY (1987); and Methods in Enzymology, Vols. 154 and 155, Wu & Grossman, and Wu, Eds., respectively.

The standard control levels of the gene expression product, thus determined in the different control groups, would then be compared with the measured level of an gene expression product in a given patient. This gene expression product could be the characteristic mRNA associated with that particular genotype group or the polypeptide gene expression product of that genotype group. The patient could then be classified or assigned to a particular genotype group based on how similar the measured levels were compared to the control levels for a given group.

As one of skill in the art will understand, there will be a certain degree of uncertainty involved in making this determination. Therefore, the standard deviations of the control group levels would be used to make a probabilistic determination and the methods of this invention would be applicable over a wide range of probability based genotype group determinations. Thus, for example and not by way of limitation, in one embodiment, if the measured level of the gene expression product falls within 2.5 standard deviations of the mean of any of the control groups, then that individual may be assigned to that genotype group. In another embodiment if the measured level of the gene expression product falls within 2.0 standard deviations of the mean of any of the control groups then that individual may be assigned to that genotype group. In still another embodiment, if the measured level of the gene expression product falls within 1.5 standard deviations of the mean of any of the control groups then that individual may be assigned to that genotype group. In yet another embodiment, if the measured level of the gene expression product is 1.0 or less standard deviations of the mean of any of the control groups levels then that individual may be assigned to that genotype group.

Thus this process will allow the determining, with various degrees of probability, which group a specific patient should be place in and such assignment to a genotype group would then determine the risk category into which the individual should be placed.

Methods to detect and measure mRNA levels and levels of polypeptide gene expression products are well known in the art and include the use of nucleotide microarrays and polypeptide detection methods involving mass spectrometers and/or antibody detection and quantification techniques. See also, Human Molecular Genetics, 2^{nd} Edition. Tom Strachan & Andrew, Read (John Wiley and Sons, Inc. Publication, NY, 1999).

As used herein, “medical condition” includes, but is not limited to, any condition or disease manifested as one or more physical and/or psychological symptoms for which treatment is desirable, and includes previously and newly-identified diseases and other disorders.

As used herein, the term “clinical response” means any or all of the following: a quantitative measure of the response, no response and adverse response, i.e., side effects.

As used herein the term “allele” shall mean a particular form of a gene or DNA sequence at a specific chromosomal location (locus).

As used herein, the term “genotype” shall mean an unphased 5′ to 3′ sequence of nucleotide pair(s) found at one or more polymorphic sites in a locus on a pair of homologous chromosomes in an individual. As used herein, genotype includes a full-genotype and/or a sub-genotype.

As used herein, the term “polynucleotide” shall mean any RNA or DNA, which may be unmodified or modified RNA or DNA. Polynucleotides include, without limitation, single- and double-stranded DNA, DNA that is a mixture of single- and double-stranded regions, single- and double-stranded RNA, and RNA that is mixture of single- and double-stranded regions, hybrid molecules comprising DNA and RNA that may be single-stranded or, more typically, double-stranded or a mixture of single- and double-stranded regions. In addition, polynucleotide refers to triple-stranded regions comprising RNA or DNA or both RNA and DNA. The term polynucleotide also includes DNAs or RNAs containing one or more modified bases and DNAs or RNAs with backbones modified for stability or for other reasons.

As used herein the term “single nucleotide polymorphism (SNP)” shall mean the occurrence of nucleotide variability at a single nucleotide position in the genome, within a population. An SNP may occur within a gene or within intergenic regions of the genome.

As used herein the term “gene” shall mean a segment of DNA that contains all the information for the regulated biosynthesis of an RNA product, including promoters, exons, introns, and other untranslated regions that control expression.

As used herein the term “polypeptide” shall mean any polypeptide comprising two or more amino acids joined to each other by peptide bonds or modified peptide bonds, i.e., peptide isosteres. Polypeptide refers to both short chains, commonly referred to as peptides, glycopeptides or oligomers, and to longer chains, generally referred to as proteins. Polypeptides may contain amino acids other than the 20 gene-encoded amino acids. Polypeptides include amino acid sequences modified either by natural processes, such as post-translational processing, or by chemical modification techniques that are well known in the art. Such modifications are well described in basic texts and in more detailed monographs, as well as in a voluminous research literature.

As used herein, the term “polymorphic site” shall mean a position within a locus at which at least two alternative sequences are found in a population, the most frequent of which has a frequency of no more than 99%.

As used herein, the term “nucleotide pair” shall mean the nucleotides found at a polymorphic site on the two copies of a chromosome from an individual.

As used herein, the term “phased” means, when applied to a sequence of nucleotide pairs, for two or more polymorphic sites in a locus, the combination of nucleotides present at those polymorphic sites on a single copy of the locus is known.

As used herein, the term “clinical trial” means any research study designed to collect clinical data on responses to a particular treatment, and includes, but is not limited to, Phase I, II and III clinical trials. Standard methods are used to define the patient population and to enroll subjects.

As used herein the term “locus” shall mean a location on a chromosome or DNA molecule corresponding to a gene or a physical or phenotypic feature.

The therapeutic treatment of interest is administered to each individual in the trial population and each individual's response to the treatment is measured using one or more predetermined criteria. It is contemplated that in many cases, the trial population will exhibit a range of responses and that the investigator will choose the number of responder groups, e.g., low, medium and high, made up by the various responses. In addition, the gene for each individual in the trial population is genotyped and/or haplotyped, which may be done before or after administering the treatment.

Kits. The kits of the invention may contain a written product on or in the kit container. The written product describes how to use the reagents contained in the kit to determine whether a patient will experience diarrhoea during drug treatment. In several embodiments, the use of the reagents can be according to the methods of the invention. In one embodiment, the reagent is a gene chip for determining the gene expression of relevant genes. In another embodiment, the reagent is a reagent for determining the Diego blood type. In yet another embodiment, the reagent is useful for performing haematocrit or haemoglobin assays, or both haematology assays.

In a preferred embodiment, such kit may further comprise a DNA sample collecting means.

It is to be understood that the methods of the invention described herein generally may further comprise the use of a kit according to the invention. Generally, the methods of the invention may be performed ex-vivo, and such ex-vivo methods are specifically contemplated by the present invention. Also, where a method of the invention may include steps that may be practised on the human or animal body, methods that only comprise those steps which are not practised on the human or animal body are specifically contemplated by the present invention.

### EXAMPLE

### mRNA Expression Profile Analysis of Diarrhoea In Subjects Participating in the Clinical Trial

Clinical trial design. This clinical trial was an open-label, dose-escalation trial using a standard Phase I protocol design (3+3 design) of enrolling three-six patients per cohort to establish the maximum tolerated dose. Peripheral whole blood was collected from patients that consented to clinical pharmacogenetics analysis. Two clinical pharmacogenetics blood samples were scheduled: baseline and on Day 2 of Week 1 at hour 24. The core treatment period consisted of two nine-week cycles of weekly intravenous administrations of epothilone B as tolerated by haematologic and other toxicities. The doses of epothilone B used in this trial were 0.3, 0.5, 0.75, 1.1, 1.85, 2.5, 3.0 and 3.6 mg/m².

Samples. Forty-three out of the ninety-one subjects who enrolled in the clinical trial consented to clinical pharmacogenetics analysis. For each subject, two clinical pharmacogenetics blood samples were scheduled: baseline and on Day 2 of Week 1 at hour 24. White blood cell (WBC) pellets were ficoll-hypaque separated from the whole blood by the investigator, frozen at −80° C. mRNA was extracted and profiled on the Affymetrix U95A GeneChip® platform.

mRNA expression profiling analysis. Any array with greater than 20% of genes called present by the Affymetrix MAS5 algorithm was a candidate for the analyses described herein. Affymetrix, “New statistical algorithms for monitoring gene expression on GeneChip® probe arrays.” Affymetrix Technical Notes. (2001). The search criteria for the comparative analysis were as follows: (1) the Signal values for the arrays grouped into the “baseline” category were averaged together, (2) all probe sets who had an Affymetrix call of “absent” for all arrays used in the search were excluded from the analysis and (3) identified those genes whose probes sets had a 1.5-fold Signal change for each array used in the “analysis” group compared to the “baseline” Signal value. Forty-two out of the possible eighty-six arrays met the quality standards needed for analysis.

Statistical analysis. Fisher's Exact tests were performed to compare the demographics of the clinical pharmacogenetics participants to the overall trial population. An analysis of variance (ANOVA) was used to determine whether mRNA gene expression patterns correlated to either treatment status (baseline vs. treated), to experiencing diarrhoea (no diarrhoea vs. diarrhoea) or to whether specific blood cell type levels correlated to experiencing diarrhoea. All statistical analyses were performed using the SigmaStat 2.03 and SAS 8.02 programs.

Demographics of clinical pharmacogenetics study participants. The clinical pharmacogenetics study population was representative of the overall trial study population in terms of age, race and gender. Although the differences between the consent rate per treatment group between the clinical pharmacogenetics study population and the overall trial population has weak statistical significance (p=0.0591), comparison of only treatment groups (2.5, 3.0 and 3.6 mg/m²) showed no statistically significant difference, indicating that the clinical pharmacogenetics study population was not biased in terms of treatment.

TABLE 1
Distribution of clinical pharmacogenetics (CPG) samples compared
to the overall clinical trial samples

| | | | All CPG | | | |
|---|---|---|---|---|---|---|
| | All Trial | | Consenting | | CPG Subjects used | |
| | Subjects | | Subjects | | in the analysis | |
| ^{a}AGE (years) | 56.4 | | ^{a}57.4 | | ^{b}56.5 | |
| ^{b}RACE | | | | | | |
| Caucasian | (77) | 84.6% | ^{c}(34) | 79.1% | ^{d}(15) | 75% |
| Black | (4) | 4.4% | ^{c}(2) | 4.7% | ^{d}(2) | 10% |
| Oriental | (7) | 7.7% | ^{c}(4) | 9.3% | ^{d}(2) | 10% |
| Other | (3) | 3.3% | ^{c}(3) | 6.9% | ^{d}(1) | 5% |
| ^{c}GENDER | | | | | | |
| Male | (27) | 29.6% | ^{e}(13) | 30.2% | ^{f}(6) | 30.0% |
| Female | (64) | 70.4% | ^{e}(30) | 69.8% | ^{f}(14) | 70% |
| TREATMENT | | | | | | |
| 0.3 mg/m² | (5) | 5.5% | (0) | 0% | (0) | 0% |
| 0.5 mg/m² | (7) | 7.7% | (0) | 0% | (0) | 0% |
| 0.75 mg/m² | (4) | 4.4% | (0) | 0% | (0) | 0% |
| 1.1 mg/m² | (5) | 5.5% | ^{g}(3) | 7.0% | (0) | 0% |
| 1.85 mg/m² | (5) | 5.5% | ^{g}(5) | 11.6% | (0) | 0% |
| 2.5 mg/m² | (46) | 50.6% | ^{g}(18) | 41.9% | ^{h}(12) | 60.0% |
| 3.0 mg/m² | (14) | 15.4% | ^{g}(12) | 27.9% | ^{h}(5) | 25.0% |
| 3.6 mg/m² | (5) | 5.5% | ^{g}(5) | 11.6% | ^{h}(3) | 15.0% |

^{a}p = 0.6418 (Parametric ANOVA)
^{b}p = 0.9548 (Parametric ANOVA)
^{c}p = 0.7387 (Fisher's Exact)
^{d}p = 0.4925 (Fisher's Exact)
^{e}p = 1.0 (Fisher's Exact)
^{f}p = 1.0 (Fisher's Exact)
^{g}p = 0.0591 (Fisher's Exact). Based on the subject's dose at Week 1, corresponding to the CPG blood draw.
^{h}p = 0.4263 (Fisher's Exact). Comparison of the 2.5, 3.0 and 3.6 mg/m² treatment groups only.

Clinical pharmacogenetics subjects used for the analysis. Epothilone B was administered to subjects as a single intravenous infusion over five minutes in a maximum volume of 20 ml either every week for up to six weeks followed by a three-week wash-out period, or every week for three weeks followed by one week without treatment. The 2.5 mg/m² treatment was considered to be the maximum tolerated dose (MTD). Therefore, twenty clinical pharmacogenetics participants who were in the 2.5, 3.0 and 3.6 mg/m² treatment groups and whose arrays met the quality standards were used. The rationale behind this decision was based on the assumption that those genes whose expression was affected by the 2.5 mg/m² treatment would be more pronounced in 3.0 and 3.6 mg/m² treatment groups.

Analysis of baseline vs. treated mRNA profiles by treatment group. To determine if gene expression in white blood cells was altered by epothilone B at 24 hours after treatment, a comparison between baseline and treated expression profiles was performed. When all treated samples were combined into one group and compared to all of the baseline samples, no genes with statistically significant differences were identified.

A similar analysis was performed for the treatment group. No genes with statistically significant differences were identified for the 2.5 and 3.0 mg/m² treatments.

Eleven genes were identified for the 3.6 mg/m² treatment. The expression of these eleven genes in the gut was investigated. See, TABLE 2 and TABLE 14, below. These genes were determined to be good candidates for genotyping.

TABLE 2
Genes with statistically significant differences between
the baseline and 3.6 mg/m² treatment groups

| Affymetrix | | | | | |
|---|---|---|---|---|---|
| U95A Probe | Gene | GenBank Accession | | ^{a}Fold | |
| Set Name | Symbol | Number | GenBank Description | Change | ^{b}P Value |
| 38210_at | SURF2 | NM_017503 | Surfeit 2 | 2.4 | 0.042 |
| | | (SEQ ID NO: 9) | | | |
| 38835_at | TM9SF1 | NM_006405 | Transmembrane 9 | 2.2 | 0.032 |
| | | (SEQ ID NO: 10) | superfamily member 1 | | |
| 40049_at | DAPK1 | NM_004938 | death-associated protein | 2.1 | 0.034 |
| | | (SEQ ID NO: 11) | kinase 1 | | |
| 1848_at | RAP1A | NM_002884 | RAP1A, member of RAS | 1.9 | 0.015 |
| | | (SEQ ID NO: 12) | oncogene family | | |
| 32621_at | DR1 | NM_001938 | down-regulator of | 1.9 | 0.015 |
| | | (SEQ ID NO: 13) | transcription 1, TBP-binding | | |
| | | | (negative cofactor 2) | | |
| 1457_at | JAK1 | NM_002227 | Janus kinase 1 | 1.7 | 0.035 |
| | | (SEQ ID NO: 14) | | | |
| 32272_at | K-ALPHA-1 | NM_006082 | tubulin, alpha, ubiquitous | 1.7 | 0.002 |
| | | (SEQ ID NO: 15) | | | |
| 40448_at | ZFP36 | NM_003407 | zinc finger protein 36, C3H | 1.6 | 0.002 |
| | | (SEQ ID NO: 16) | type, homolog (mouse) | | |
| 33297_at | none | AL031778 | nuclear transcription factor | −1.6 | 0.002 |
| | available | (SEQ ID NO: 17) | Y, alpha | | |
| 32578_at | TCFL4 | NM_013383 | Transcription factor-like 4 | −1.6 | 0.005 |
| | | (SEQ ID NO: 18) | | | |
| 187_at | MAP4K2 | NM_004579 | mitogen-activated protein | −1.7 | 0.049 |
| | | (SEQ ID NO: 19) | kinase kinase kinase kinase 2 | | |

^{a}Fold changes were calculated as [treated/baseline]. Negative fold changes reflect a quotient <1.0, indicating reduced expression in the 3.6 mg/m² epothilone B-treated population.
^{b}Parametric ANOVA

Analysis of the mRNA profiles for clinical pharmacogenetics subjects who received the 3.6 mg/m² treatment compared to their baseline profiles revealed a list of eleven genes that had statistically significant changes in expression. While this dose is well above maximum tolerated dose and is currently not being used in the ongoing phase 2 trials, some of the genes identified have relevance to the mechanism of action of epothilone B.

Epothilone B inhibits cell cycle progression. Some of the genes listed in TABLE 2 have an association to cell cycle-dependant mechanisms. For example, RAP1A (also known as KREV1; SEQ ID NO:12) and JAK1 (SEQ ID NO:14) are key signal transduction molecules that help stimulate cell cycle progression. Kitayama H et al., Cell 56 (1):77-84 (1989); Schindler C & Darnell J E, Jr., Annu. Rev. Biochem. 64:621-51 (1995). Interestingly, JAK1 has also been implicated haematopoiesis. Kirken R A et al., Prog. Growth Factor Res. 5 (2):195-211 (1994). Other genes listed in TABLE 2 have a direct impact in the downregulation of transcription, such as DR1 (SEQ ID NO:13) and TCFL4 (also known as MLX, SEQ ID NO:18). DR1 interacts with the TATA-binding protein (TBP) which is a key regulator of both basal and activated transcription. The interaction of DR1 with TBP inhibits TBP from associating with the transcriptional machinery, thereby repressing both basal and activated levels of transcription. Inostroza J A et al., Cell 70 (3):477-89 (1992). TCF4, on the other hand, is believed to repress transcription through the interaction with Mad and the mSin3-histone deacetylase complex. Billin A N et al., J. Biol. Chem. 274 (51):36344-50 (1999). Therefore, the changes in expression of aforementioned genes observed in this analysis have biological significance to the mechanism of epothilone B action. Importantly, all of these genes are expressed in the small intestine and colon.

Epothilone B is believed to induce cell death by an apoptotic mechanism. Significantly, one of the genes identified by this analysis has been shown to have a direct effect on inducing apoptosis. Death associated protein kinase (DAPK1) mRNA was shown to have higher levels of expression in the blood 24 hours after 3.6 mg/m² epothilone B treatment compared to its baseline level. DAPK1 has been shown to suppress integrin-mediated cell adhesion and signal transduction. Wang W J et al., a Cell Biol. 159 (1):169-79 (2002). Importantly, cell adhesion to the extracellular matrix is primarily mediated by integrins. Wang and colleagues demonstrated that the adhesion-inhibitory effect by DAPK1 is the major mechanism by which it induces apoptosis in cells (Wang, et al 2002). DAPK1 (SEQ ID NO:11) is expressed in normal small intestine and normal colon, but at low levels. Thus, the possible upregulation of DAPK1 in these cells may be one mechanism by which epothilone B induces diarrhoea. Several polymorphisms have been identified in the DAPK1 gene. Therefore, DAPK1 is a strong candidate for genotyping.

TM9SF1 (SEQ ID NO:10) is believed to encode G-protein-like receptor with nine integral membrane-spanning domains. Chluba-de Tapia J et al., Gene 197 (1-2):195-204 (1997). Importantly, polymorphisms within the TM9SF1 gene have been identified. Therefore, TM9SF1 is a candidate for genotyping.

Analysis of mRNA profiles between clinical pharmacogenetics subjects who did not experience diarrhoea to those who experienced any grade of diarrhoea. Genes are differentially expressed in the blood between subjects who did not experience diarrhoea compared to those who experienced diarrhoea after epothilone B treatment but prior to the observation of a diarrhoea event. To identify these genes, clinical pharmacogenetics subjects were divided into two groups based on diarrhoea status: (1) five subjects who did not experience diarrhoea after epothilone B treatment, irregardless of dose and (2) fifteen subjects who experienced any grade of diarrhoea after epothilone B treatment, irregardless of dose. Because there were only three subjects who experienced grade 3 diarrhoea, all fifteen subjects who experienced any grade of diarrhoea were grouped together to strengthen the statistical power of this analysis.

The mean onset of diarrhoea for clinical pharmacogenetics subjects was 371±18 days after the scheduled blood draw. Hence, the differences in gene expression described herein are well before the incidence of diarrhoea.

A comparison of the mRNA expression profiles of white blood cells identified eight genes with statistically significant differences between the two groups of subjects 24 hours after epothilone B administration. See, TABLE 3.

TABLE 3
Genes with statistically significant differences between
the no diarrhoea and diarrhoea groups

| Affymetrix | | | | | |
|---|---|---|---|---|---|
| U95A Probe | Gene | GenBank Accession | | ^{a}Fold | |
| Set Name | Symbol | Number | GenBank Description | Change | P Value |
| 477_at | IRF5 | U51127 | Interferon regulatory factor 5 | 2.9 | ^{b}<0.001 |
| | | (SEQ ID NO: 1) | | | |
| 1274_s_at | CDC34 | NM_004359 | Cell division cycle 34 | −2.2 | ^{b}<0.001 |
| | | (SEQ ID NO: 2) | | | |
| 39436_at | BNIP3L | NM_004331 | BCL2/adenovirus E1B 19 kDa | −2.8 | ^{c}0.01 |
| | | (SEQ ID NO: 3) | interacting protein 3-like | | |
| 297_g_at | none | V00599 | Tubulin, beta | −3.9 | ^{c}0.008 |
| | available | (SEQ ID NO: 4) | | | |
| 33759_at | BPGM | X04327 | 2,3-bisphosphoglycerate | −4.9 | ^{c}0.003 |
| | | (SEQ ID NO: 5) | mutase | | |
| 37285_at | ALAS2 | X60364 | Aminolevulinate, delta-, | −9.6 | ^{c}0.002 |
| | | (SEQ ID NO: 6) | synthase 2 | | |
| 37405_at | SELENBP1 | NM_003944 | Selenium binding protein 1 | −11.3 | ^{c}0.001 |
| | | (SEQ ID NO: 7) | | | |
| 33336_at | SLC4A1 | NM_000342 | Solute carrier family 4, anion | −15.3 | ^{c}0.002 |
| | | (SEQ ID NO: 8) | exchanger, member 1 | | |
| | | | (erythrocyte membrane protein | | |
| | | | band 3, Diego blood group) | | |

^{a}Fold changes were calculated as [diarrhoea/no diarrhoea]. Negative fold changes reflect a quotient <1.0, indicating reduced expression in the “no diarrhoea” population.
^{b}Parametric ANOVA
^{c}Non-parametric ANOVA

Analysis of the mRNA profiles for clinical pharmacogenetics subjects who experienced any grade of diarrhoea versus those who did not revealed a list of eight genes that had statistically significant differences in level of expression. The mean time of experiencing the first episode of diarrhoea after the receiving dose of epothilone B for clinical pharmacogenetics subjects was 37 days; with a minimum of 6 days (grade 1 diarrhoea) and a maximum of 304 days (grade 1 diarrhoea). Therefore, the gene expression signatures identified by this analysis are before the diarrhoea event and may shed some light into the mechanism behind epothilone B-induced diarrhoea.

There is no apparent unifying theme to the genes that were identified by this analysis. IRF5 (mRNA shown in SEQ BD NO:1) is a transcription factor involved in the transcriptional activation of inflammatory genes such as interferon alpha, RANTES, macrophage inflammatory protein 1-beta, monocyte chemotactic protein 1 and interleukin-8. Barnes B J et al., Mol. Cell. Biol. 22 (16):5721-40 ((2002)). A mutation in the ALAS2 gene (mRNA shown in SEQ ID NO:6) has been associated with X-linked sideroblastic anaemia. Hurford M T et al., Clin. Chim. Acta 321 (1-2):49-53 (2002). Selenium has been shown to exhibit anticarcinogenic properties. Ip C, Cancer Res. 41 (7):2683-6 (1981); Ip C & Sinha D, Carcinogenesis 2 (5):435-8 (1981).

Surprisingly, a probe set against an isotype of beta-tubulin (Hall J L et al., Mol. Cell. Biol. 3 (5):854-62 (1983)), the target of epothilone B, was identified by this analysis. What was also surprising was the identification of lower levels of BNIP3L (SEQ ID NO:3) in subjects experiencing diarrhoea. BNIP3L is a member of the BNIP3 family of BCL-2 family of proapoptotic proteins that interact with antiapoptotic proteins such as BCL-2 and BCL-x_{L} to promote apoptosis. Yasuda M et al., Cancer Res. 59 (3):533-7 (1999).

Thus, these genes make up a “gene-signature” of diarrhoea in the blood that can be used as a biomarker at either baseline or after epothilone B treatment for the future occurrence of diarrhoea.

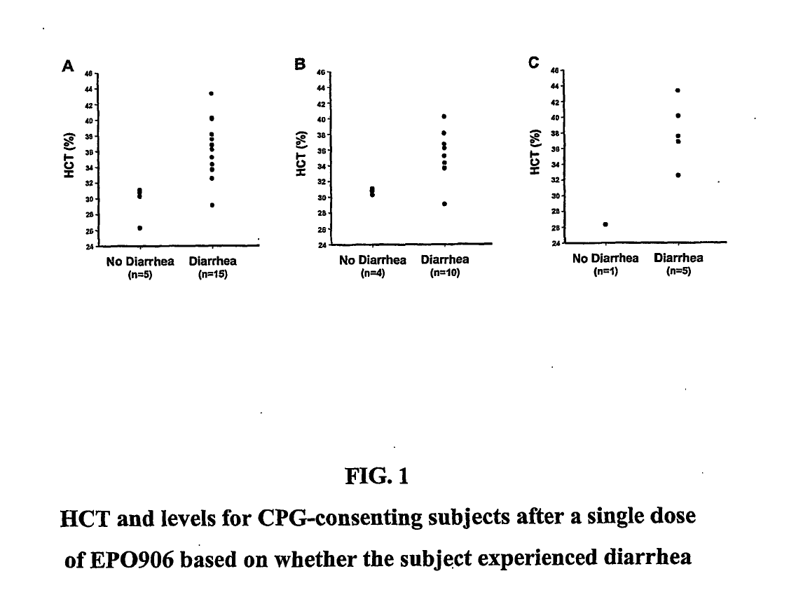

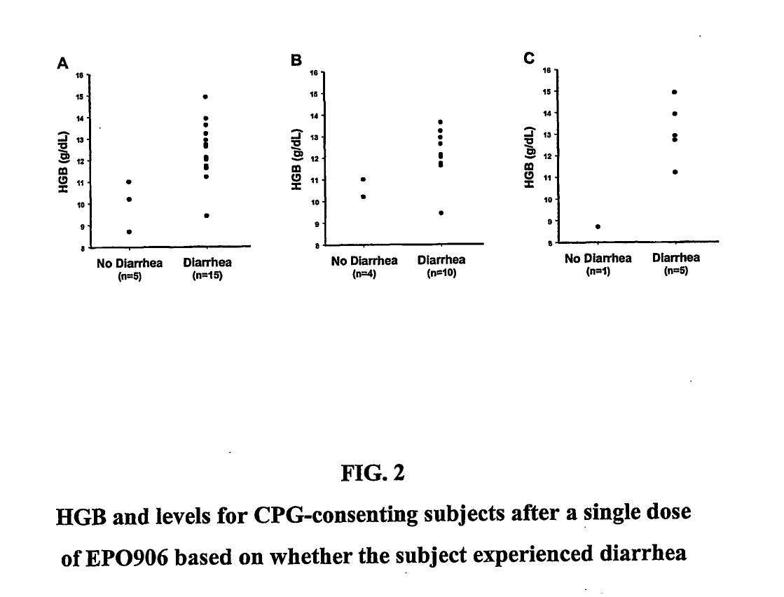

Next, the levels of each blood cell type were compared between the two groups of subjects. Because these values were not determined at the blood draw timepoint, values for the second blood draw timepoint after baseline in cycle 1, corresponding to the first blood draw after the first epothilone B treatment (usually 24 hours after the blood draw) were used for this comparison. As shown in TABLE 4, no statistically significant differences were observed for the total number of white blood cells, neutrophils, eosinophils, basophils, lymphocytes, monocytes and platelets. Interestingly, statistically significant differences in haematocrit (HCT) and haemoglobin (HGB) levels were identified. See, TABLE 4 and FIGS. 1-2.

TABLE 4
Blood cell levels for clinical pharmacogenetics-consenting subjects
after a single dose of epothilone B based on whether the subject
experienced diarrhoea

| | No Diarrhoea | Diarrhoea | P Value |
|---|---|---|---|
| Assay Parameter | (n = 5) | (n = 15) | (ANOVA) |
| Haematocrit (%) | 29.76 ± 0.87 | 36.11 ± 0.91 | 0.0013 |
| Haemoglobin (g/dL) | 10.06 ± 0.84 | 12.40 ± 0.33 | 0.0015 |
| Platelets (THOU/MM³) | 334.40 ± 54.80 | 259.20 ± 23.25 | 0.1555 |
| White Blood Cells | 5.92 ± 0.87 | 5.60 ± 0.44 | 0.7292 |
| (THOU/MM³) | | | |
| Neutrophils (%) | 73.60 ± 2.05 | 68.81 ± 2.38 | 0.2850 |
| Eosinophils (%) | 3.42 ± 0.73 | 2.74 ± 0.45 | 0.4546 |
| Basophils (%) | 0.64 ± 0.22 | 0.57 ± 0.12 | 0.7616 |
| Lymphocytes (%) | 14.50 ± 0.74 | 19.92 ± 1.92 | 0.1469 |
| Monocytes (%) | 8.10 ± 0.74 | 7.88 ± 0.71 | 0.8683 |

Mean and standard error of the mean are shown. All data were normally distributed. The timepoint used to generate the data for this table was the second blood draw after baseline in cycle 1, corresponding to the first blood draw after the first epothilone B treatment. Absolute neutrophils, eosinophils, basophils, lymphocytes and monocytes were not used for this analysis because they were not measured for every subject.

In addition, clinical pharmacogenetics subjects who did not experience diarrhoea had haematocrit and haemoglobin levels that were significantly lower than the lower limit of normal (ANOVA; P=0.0002 and 0.001, respectively). Because females generally have lower levels of haematocrit and haemoglobin compared to males, a similar analysis was done by sex. As shown in TABLE 5 and FIGS. 1-2, similar trends in haematocrit and haemoglobin levels were identified for each sex. To determine if these associations exist for the entire trial subject population, the haematocrit and haemoglobin levels for all subjects at the second blood draw after baseline in cycle 1 were investigated.

TABLE 5
Haematocrit (HCT) and haemoglobin (HGB) levels by sex for clinical
pharmacogenetics-consenting subjects after a single dose of epothilone
B based on whether the subject experienced diarrhoea

| | Females | | | Males | | |
|---|---|---|---|---|---|---|
| Assay | No Diarrhoea | Diarrhoea | | No Diarrhoea | Diarrhoea | |
| Parameter | (n = 4) | (n = 10) | P Value | (n = 1) | (n = 5) | ^{c}P Value |
| HCT (%) | 30.63 ± 0.20 | 35.63 ± 0.01 | ^{a}0.012 | 26.30 | 38.30 ± 1.77 | ND |
| HGB (g/dL) | 10.40 ± 0.20 | 12.01 ± 0.35 | ^{b}0.018 | 8.70 | 13.18 ± 0.62 | ND |

Mean and standard error of the mean are shown. The timepoint used to generate the data for this table was the second blood draw after baseline in cycle 1, corresponding to the first blood draw after the first epothilone B treatment.
^{a}Parametric ANOVA
^{b}Non-parametric ANOVA
^{c}Due to small sample size, ANOVAs could not be performed.

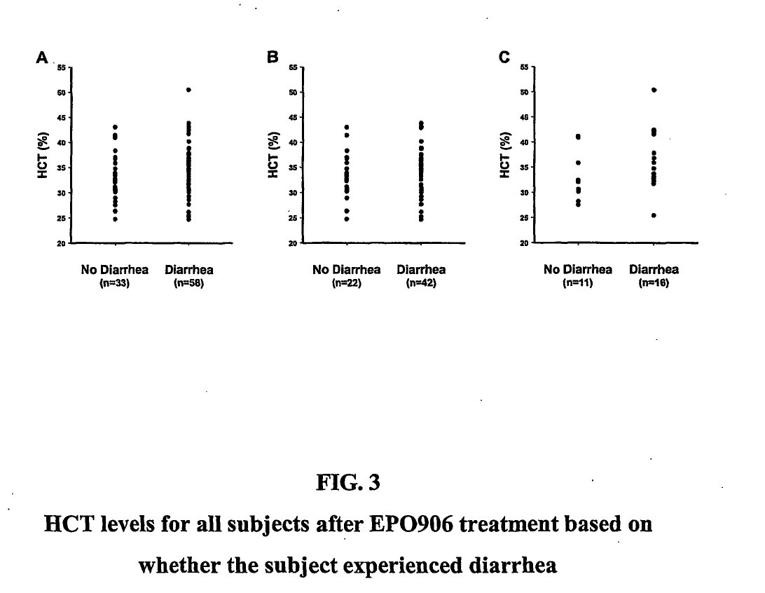

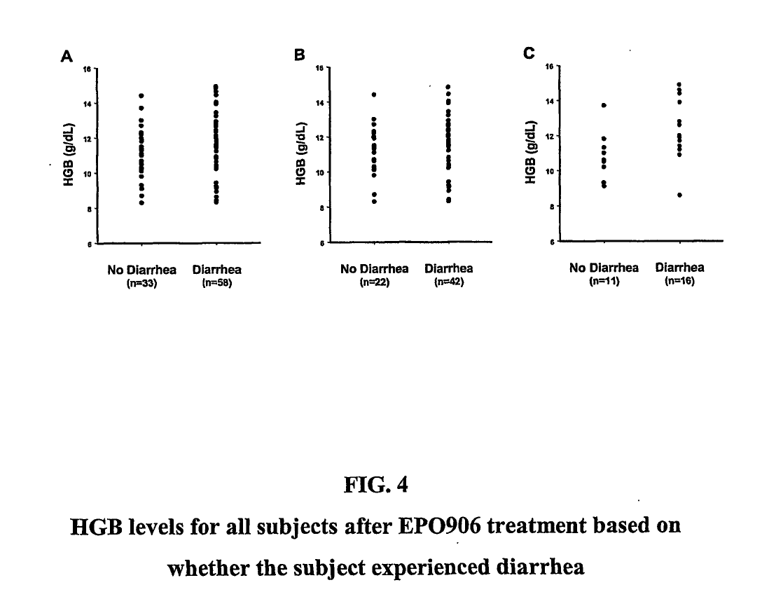

As shown in TABLE 6 and FIGS. 3-4, subjects who did not experience diarrhoea had significantly lower levels of haematocrit and haemoglobin compared to subjects who experienced diarrhoea (ANOVA; P=0.045 and 0.046, respectively).

TABLE 6
Comparison of haematocrit (HCT) and haemoglobin (HGB)
levels for all subjects after epothilone B treatment based on
whether the subject experienced any grade of diarrhoea

| | No Diarrhoea | Diarrhoea | P Value |
|---|---|---|---|
| Assay Parameter | (n = 33) | (n = 58) | (ANOVA) |
| HCT (%) | 33.06 ± 0.77 | 35.21 ± 0.67 | 0.045 |
| HGB (g/dL) | 11.11 ± 0.25 | 11.81 ± 0.22 | 0.046 |

Mean and standard error of the mean are shown. All data were normally distributed. The timepoint used to generate the data for this table was the second blood draw after baseline in cycle 1, corresponding to the first blood draw after the first epothilone B treatment.

However, when subjects were compared by sex, only males showed statistically significant differences in haematocrit and haemoglobin levels. See, TABLE 7.

TABLE 7
Haematocrit (HCT) and haemoglobin (HGB) levels for all subjects by sex after epothilone
B treatment based on whether the subject experienced any grade of diarrhoea

| | Females | | | Males | | |
|---|---|---|---|---|---|---|
| | No Diarrhoea | Diarrhoea | P Value | No Diarrhoea | Diarrhoea | P Value |
| Assay | (n = 22) | (n = 42) | (ANOVA) | (n = 11) | (n = 16) | (ANOVA) |
| HCT (%) | 33.17 ± 0.94 | 34.34 ± 0.69 | 0.322 | 37.48 ± 1.39 | 32.84 ± 1.50 | 0.040 |
| HGB (g/dL) | 11.13 ± 0.30 | 11.56 ± 0.25 | 0.292 | 11.06 ± 0.46 | 12.46 ± 0.44 | 0.042 |

Mean and standard error of the mean are shown. All data were normally distributed. The timepoint used to generate the data for this table was the second blood draw after baseline in cycle 1, corresponding to the first blood draw after the first epothilone B treatment.

To determine if the differences in gene expression shown in TABLE 3 were detected at baseline prior to epothilone B treatment, the expression levels of the eight genes were compared using the baseline blood draw as well. As shown in TABLE 8, similar changes in expression levels were observed at baseline when comparing the two groups of subjects. However, only one baseline array for the “no diarrhoea” group was available for this analysis due to quality control standards observed.

TABLE 8
Comparison of the baseline versus treated Signal values
for the genes that are associated with diarrhoea status

| | Signal Values | | Signal Values | | ^{e}Fold | ^{e}Fold |
|---|---|---|---|---|---|---|
| | No Diarrhoea | | Diarrhoea | | Change | Change |
| Probe Set | ^{a}Baseline | ^{b}Treated | ^{c}Baseline | ^{d}Treated | Baseline | Treated |
| 477_at | 70 | 97 | 263 | 278 | 3.8 | 2.9 |
| 1274_s_at | 524 | 278 | 141 | 128 | −3.7 | −2.2 |
| 39436_at | 15007 | 4200 | 1718 | 1476 | −8.7 | −2.8 |
| 297_g_at | 474 | 232 | 105 | 59 | −4.5 | −3.9 |
| 33759_at | 1497 | 344 | 150 | 70 | −9.9 | −4.9 |
| 37285_at | 16718 | 4292 | 1524 | 448 | −10.7 | −9.6 |
| 37405_at | 5169 | 1200 | 387 | 106 | −13.4 | −11.3 |
| 33336_at | 5194 | 1422 | 429 | 93 | −12.1 | −15.3 |

^{a}Only one usable array was available for this population. Signal values for array is shown.
^{b}Signal values shown is the average off all arrays for this group.
^{c}Signal values shown is the average off all arrays for this group.
^{d}Signal values shown is the average off all arrays for this.
^{e}Fold changes were calculated as [diarrhoea/no diarrhoea]. Negative fold changes reflect a quotient <1.0, indicating reduced expression in the “no diarrhoea” population.

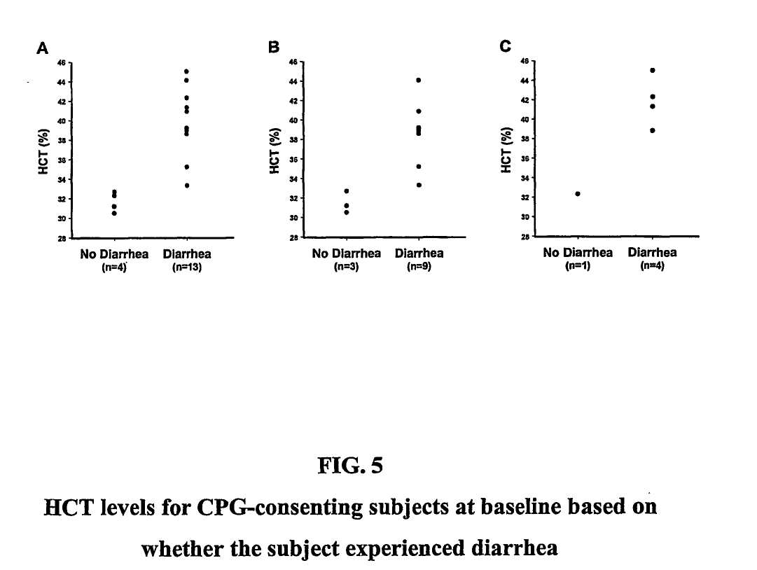

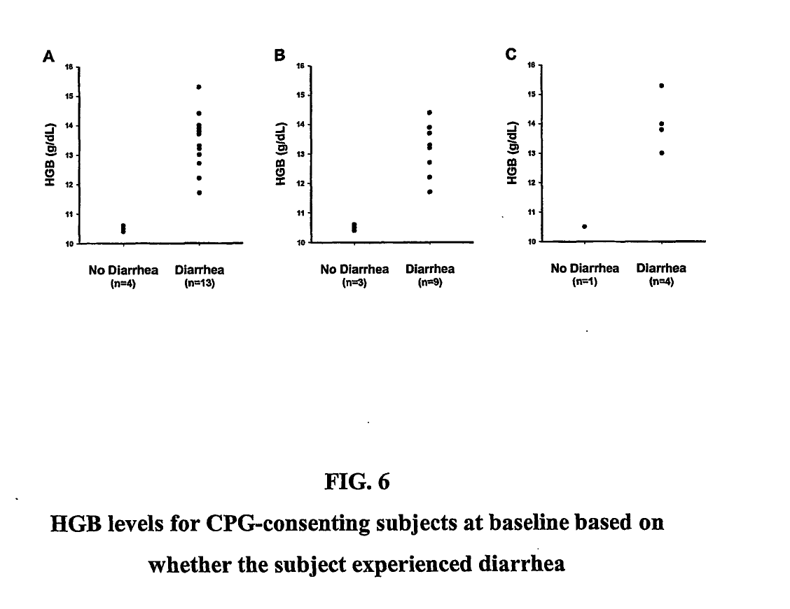

Haematocrit and haemoglobin levels show similar differences at baseline ell, as shown in TABLES 9-10 and FIGS. 5-6. Notably, clinical pharmacogenetics subjects who did not experience diarrhoea had haematocrit and haemoglobin levels that were significantly lower than the lower limit of normal (ANOVA; P=0.0014 and 0.0025, respectively).

TABLE 9
Comparison of haematocrit (HCT) and haemoglobin (HGB)
levels for clinical pharmacogenetics-consenting subjects at
baseline based on whether the subject experienced diarrhoea

| | No Diarrhoea | Diarrhoea | P Value |
|---|---|---|---|
| Assay Parameter | (n = 4) | (n = 13) | (ANOVA) |
| HCT (%) | 31.68 ± 0.50 | 39.69 ± 0.89 | 0.0002 |
| HGB (g/dL) | 10.50 ± 0.04 | 13.42 ± 0.26 | <0.0001 |

Mean and standard error of the mean are shown. All data were normally distributed. The timepoint used to generate the data for this table was the baseline value.

TABLE 10
Haematocrit (HCT) and haemoglobin (HGB) levels by sex for clinical pharmacogenetics-
consenting subjects at baseline based on whether the subject experienced diarrhoea

| | Females | | | Males | | |
|---|---|---|---|---|---|---|
| Assay | No Diarrhoea | Diarrhoea | | No Diarrhoea | Diarrhoea | |
| Parameter | (n = 3) | (n = 9) | ^{a}P Value | (n = 1) | (n = 4) | ^{b}P Value |
| HCT (%) | 31.47 ± 0.65 | 38.71 ± 1.02 | 0.003 | 32.30 | 41.90 ± 1.24 | ND |
| HGB (g/dL) | 10.50 ± 0.06 | 13.14 ± 0.28 | 0.0004 | 10.50 | 14.03 ± 0.48 | ND |

Mean and standard error of the mean are shown. The timepoint used to generate the data for this table was the baseline values.
^{a}parametric ANOVA
^{b}Due to small sample size, ANOVAs could not be performed.

To determine if these associations exist for the entire trial subject population, all baseline haematocrit and haemoglobin levels were investigated. Although there appears to be similar trends in haematocrit and haemoglobin levels between subjects who did not experience diarrhoea to subjects who experienced any grade of diarrhoea, the differences are not statistically significant. See, TABLE 11. Furthermore, there were no statistically significant differences observed when doing the comparisons by sex. See, TABLE 12.

TABLE 11
Haematocrit (HCT) and haemoglobin (HGB) levels for all subjects
at baseline based on whether the subject experienced
any grade of diarrhoea

| | No Diarrhoea | Diarrhoea | P Value |
|---|---|---|---|
| Assay Parameter | (n = 26) | (n = 48) | (ANOVA) |
| HCT (%) | 33.96 ± 0.92 | 36.16 ± 0.76 | 0.079 |
| HGB (g/dL) | 11.37 ± 0.32 | 12.17 ± 0.27 | 0.072 |

Mean and standard error of the mean are shown. All data were normally distributed. The timepoint used to generate the data for this table was the baseline value.

TABLE 12
Haematocrit (HCT) and haemoglobin (HGB) levels for all subjects by sex at
baseline based on whether the subject experienced any grade of diarrhoea

| | Females | | | Males | | |
|---|---|---|---|---|---|---|
| | No Diarrhoea | Diarrhoea | | No Diarrhoea | Diarrhoea | |
| Assay | (n = 17) | (n = 34) | P Value | (n = 9) | (n = 14) | P Value |
| HCT (%) | 34.17 ± 1.04 | 35.62 ± 0.87 | ^{a}0.317 | 33.58 ± 1.86 | 37.49 ± 1.50 | ^{a}0.118 |
| HGB (g/dL) | 11.42 ± 0.37 | 11.95 ± 0.32 | ^{b}0.254 | 11.28 ± 0.62 | 12.71 ± 0.51 | ^{a}0.092 |

Mean and standard error of the mean are shown. The timepoint used to generate the data for this table was the baseline value.
^{a}Parametric ANOVA
^{b}Non-parametric ANOVA

Thus, the clinical pharmacogenetics subjects who did not experience diarrhoea had significantly lower haematocrit and haemoglobin levels both at baseline and after epothilone B treatment compared to subjects who experienced any grade of diarrhoea. In addition, the clinical pharmacogenetics subjects who did not experience diarrhoea had haematocrit and haemoglobin levels that were significantly lower than the lower limit of normal. Interestingly, similar differences in haematocrit and haemoglobin levels after epothilone B treatment were also observed for the entire trial subject population. This significance appears to be driven by the male subjects participating in the trial.

The gene expression levels were compared between clinical pharmacogenetics subjects who did not experience diarrhoea and clinical pharmacogenetics subjects who experienced grade 3 diarrhoea. As shown in TABLE 13, similar differences in gene expression were observed when studying subjects who experienced grade 3. Compare, TABLE 8 and TABLE 13.

TABLE 13
Comparison of the baseline versus treated Signal values
for the genes that are associated with grade 3 diarrhoea

| | Signal Values | | Signal Values | | ^{e}Fold | ^{e}Fold |
|---|---|---|---|---|---|---|
| | No Diarrhoea | | Diarrhoea | | Change | Change |
| Probe Set | ^{a}Baseline | ^{b}Treated | ^{c}Baseline | ^{d}Treated | Baseline | Treated |
| 477_at | 70 | 97 | 291 | 264 | 4.2 | ^{f}2.7 |
| (SEQ ID NO: 1) | | | | | | |
| 1274_s_at | 524 | 278 | 153 | 123 | −3.4 | −2.3 |
| (SEQ ID NO: 2) | | | | | | |
| 39436_at | 15007 | 4200 | 1274 | 1489 | −11.0 | −2.8 |
| (SEQ ID NO: 3) | | | | | | |
| 297_g_at | 474 | 232 | 165 | 77 | −2.9 | −3.0 |
| (SEQ ID NO: 4) | | | | | | |
| 33759_at | 1497 | 344 | 97 | 51 | −15.5 | ^{f}−6.7 |
| (SEQ ID NO: 5) | | | | | | |
| 37285_at | 16708 | 4292 | 1336 | 428 | −12.5 | −10.0 |
| (SEQ ID NO: 6) | | | | | | |
| 37405_at | 5169 | 1200 | 200 | 113 | −25.8 | ^{f}−10.3 |
| (SEQ ID NO: 7) | | | | | | |
| 33336_at | 5194 | 1421 | 210 | 90 | −24.7 | −15.9 |
| (SEQ ID NO: 8) | | | | | | |

^{a}Only one usable array was available for this population. Signal values for array is shown.
^{b}Signal values shown is the average off all arrays for this group..
^{c}Signal values shown is the average off all arrays for this group.
^{d}Signal values shown is the average off all arrays for this group.
^{e}Fold changes were calculated as [diarrhoea/no diarrhoea]. Negative fold changes reflect a quotient <1.0, indicating reduced expression in the “no diarrhoea” population.
^{f}P value<0.05; parametric ANOVA

However, while the overall fold changes are similar comparing grade 3 diarrhoea versus all grades of diarrhoea, only three genes had statistically significant differences for the grade 3 diarrhoea comparison: IRF5 (477_at), BPGM (33759_at) and SELENBP1 (37405_at). These results suggest that IRF5 (SEQ ID NO: 1), BPGM (SEQ ID NO:5) and SELENBP1 (SEQ ID NO:7) may be potential biomarkers for the prediction of grade 3 diarrhoea.

The expression of the genes listed in TABLE 3 in the gut was investigated. As shown in TABLE 14, CDC34 (1274_s_at), BNIP3L (39439_at), beta tubulin (297_g_at) and SELENBP1 (37405_at) are expressed in the small intestine and colon. Therefore, some of these genes would therefore be good candidates for genotyping.

TABLE 14
Gene expression in the small intestine and colon

| Affymetrix | | ^{a}Small Intestine | ^{b}Affymetrix | ^{c}Colon | ^{b}Affymetrix |
|---|---|---|---|---|---|
| Probe Set | Gene Symbol | (Signal) | Call | (Signal) | Call |
| 38210_at | SURF2 | 92 | P | 78.2 | P |
| | (SEQ ID NO: 9) | | | | |
| 38835_at | TM9SF1 | 294.3 | P | 341.6 | P |
| | (SEQ ID NO: 10) | | | | |
| 40049_at | DAPK1 | 111 | P | 54 | P |
| | (SEQ ID NO: 11) | | | | |
| 1848_at | RAP1A | 443.8 | P | 262.3 | P |
| | (SEQ ID NO: 12) | | | | |
| 32621_at | DR1 | 210.6 | P | 260.3 | P |
| | (SEQ ID NO: 13) | | | | |
| 1457_at | JAK1 | 66.7 | P | 64.3 | P |
| | (SEQ ID NO: 14) | | | | |
| 32272_at | K-ALPHA-1 | 2607.6 | P | 2311.8 | P |
| | (SEQ ID NO: 15) | | | | |
| 40448_at | ZFP36 | 2376.4 | P | 1488.7 | P |
| | (SEQ ID NO: 16) | | | | |
| 33297_at | none available | 89.4 | P | 97.7 | P |
| | (SEQ ID NO: 17) | | | | |
| 32578_at | TCFL4 | 153.8 | P | 196.1 | P |
| | (SEQ ID NO: 18) | | | | |
| 187_at | MAP4K2 | 110.1 | P | 48.7 | A |
| | (SEQ ID NO: 19) | | | | |
| 477_at | IRF5 | 79.4 | A | 120.3 | A |
| | (SEQ ID NO: 1) | | | | |
| 1274_s_at | CDC34 | 70.8 | P | 219.9 | P |
| | (SEQ ID NO: 2) | | | | |
| 39436_at | BNIP3L | 1207.7 | P | 315.3 | P |
| | (SEQ ID NO: 3) | | | | |
| 297_g_at | None available | 346.9 | P | 540.0 | P |
| | (SEQ ID NO: 4) | | | | |
| 33759_at | BPGM | 36.1 | A | 39.8 | A |
| | (SEQ ID NO: 5) | | | | |
| 37285_at | ALAS2 | 152.9 | A | 141.6 | A |
| | (SEQ ID NO: 6) | | | | |
| 37405_at | SELENBP1 | 687.7 | P | 2878.7 | P |
| | (SEQ ID NO: 7) | | | | |
| 33336_at | SLC4A1 | 12.7 | A | 63.2 | A |
| | (SEQ ID NO: 8) | | | | |

^{a}Array number p2368e in the NPGN database from normal human small intestine.
^{b}Absent (A) or Present (P) call based on the Affymetrix MAS5 algorithm.
^{c}Array number p2378e in the NPGN database from normal human colon.

CDC34 (SEQ ID NO:2, BNIP3L (SEQ ID NO:3) and SELENBP1 (SEQ ID NO:7) are expressed in the small intestine and colon, making them candidates for genotyping.

One interesting finding is the identification of significantly lower levels of SLC4A1 (SEQ ID NO:8) in subjects experiencing diarrhoea. SLC4A1 encodes the major glycoprotein of the erythrocyte membrane and mediates the exchange of chloride and bicarbonate across the phospholipid bilayer. Palumbo A P et al., Am. J. Hum. Genet. 39 (3):307-16 (1986). SLC4A1 also regulates the expression of genes located on erythrocyte band 3. Zelinski T, Transfus. Med. Rev. 12 (1):36-45 (1998). Many SLC4A1 mutations have been linked to the destabilization of the red blood cell membrane leading to hereditary spherocytosis, and defective kidney acid secretion leading to renal tubular acidosis. Other known mutations in SLC4A1 that do not result in disease form the Diego blood group system. Two of the major antigens that make up the 16-member Diego blood group system are Di^{a} and Di^{b}. Di^{a} is normally detected in individuals of Mongolian descent (Chinese, Japanese and American Indian), while Di^{b} is detected in all populations. Zelinski T, Transfus. Med. Rev. 12 (1):36-45 (1998). Importantly, clinical pharmacogenetics subjects who experienced diarrhoea had little to no expression of SLC4A1 mRNA. Thus, subjects who lack the expression of the Diego blood group may be predisposed to experiencing diarrhoea. A PCR-based system for Diego blood group genotyping has been developed. Wu G G et al., Transfusion 42 (12):1553-6 (2002). Hence, the Diego blood group marker may be used as a potential biomarker at baseline for drug-induced diarrhoea.

In summary, this analysis identified a set of genes that may be used for genotyping. In addition, this study also identified potential biomarkers for the prediction of diarrhoea: (1) screening subjects for baseline or post-dose gene mRNA levels for the genes shown in TABLE 3, and (2) screening subjects for the Diego blood group.

All references cited herein are incorporated herein by reference in their entirety and for all purposes to the same extent as if each individual publication or patent or patent application was specifically and individually indicated to be incorporated by reference in its entirety for all purposes. In addition, all GenBank accession numbers, Unigene Cluster numbers and protein accession numbers cited herein are incorporated herein by reference in their entirety and for all purposes to the same extent as if each such number was specifically and individually indicated to be incorporated by reference in its entirety for all purposes.

The present invention is not to be limited in terms of the particular embodiments described in this application, which are intended as single illustrations of individual aspects of the invention. Many modifications and variations of this invention can be made without departing from its spirit and scope, as will be apparent to those skilled in the art. Functionally equivalent methods and apparatus within the scope of the invention, in addition to those enumerated herein, will be apparent to those skilled in the art from the foregoing description and accompanying drawings. Such modifications and variations are intended to fall within the scope of the appended claims. The present invention is to be limited only by the terms of the appended claims, along with the full scope of equivalents to which such claims are entitled.

1. Use of epothilone B in the manufacture of a medicament for the treatment of solid tumour with a reduced occurrence of drug-induced diarrhoea in a selected patient population, wherein the patient population is selected on the basis of the gene expression profile of the patients, wherein the gene expression profile comprises the gene expression pattern of one or more genes that are predictive of the occurrence of diarrhoea in a patient following administration of epothilone B.

2. A method for predicting diarrhoea in a subject to whom a microtubule stabilizing agent is to be administered, comprising the steps of:
(a) obtaining the gene expression profile of the subject, wherein the gene expression profile comprises the gene expression pattern of one or more genes, where the expression patterns of the one or more genes are predictive of the occurrence of diarrhoea in a subject following administration of a microtubule stabilizing agent,
(b) determining whether the subject is at risk for diarrhoea from the administration of the microtubule stabilizing agent.

3. The method of claim 2, wherein the prediction occurs prior the administration of the agent to the patient.

4. The method of claim 2, wherein the prediction occurs during the course of drug therapy.

5. The method of claim 2, wherein the gene expression pattern is the higher than normal expression of the gene for Interferon regulatory factor 5 (IRF5).

6. The method of claim 2, wherein the gene expression pattern is the lower than normal expression of one or more genes selected from the group consisting of group consisting of Cell division cycle 34 (CDC34); BCL2/adenovirus E1B 19 kDa interacting protein 3-like (BNIP3L); Tubulin, beta; 2,3-bisphosphoglycerate mutase (BPGM); Aminolevulinate, delta-, synthase 2 (ALAS2); Selenium binding protein 1 (SELENBP1); and Solute carrier family 4, anion exchanger, member 1 (erythrocyte membrane protein band 3, Diego blood group) (SLC4A1).

7. The method of claim 2, wherein the gene expression pattern is the increased expression of one or more genes following administration of the microtubule stabilizing agent as compared with the expression of a gene prior to the administration of the microtubule stabilizing agent, wherein the gene is selected from the group consisting of Surfeit 2 (SURF2); Transmembrane 9 superfamily member 1 (TM9SF1); death-associated protein kinase 1 (DAPK1); RAP1A, a member of RAS oncogene family (RAP1A); down-regulator of transcription 1 (DR1); Janus kinase 1 (JAK1); tubulin, alpha (K-ALPHA-1) and zinc finger protein 36, C3H type, homolog (ZFP36).

8. The method of claim 2, wherein the gene expression pattern is the decreased expression of one or more genes following administration of the microtubule stabilizing agent as compared with the expression of a gene prior to the administration of the microtubule stabilizing agent, wherein the gene is selected from the group consisting of nuclear transcription factor Y, alpha; Transcription factor-like 4 (TCFL4) and mitogen-activated protein kinase kinase kinase kinase 2 (MAP4K2).

9. A method for predicting diarrhoea in a subject to whom a microtubule stabilizing agent is to be administered, comprising the steps of:
(a) determining whether the subject expresses the Diego blood type; and
(b) determining whether the subject is at risk for diarrhoea following the administration of the microtubule stabilizing agent.

10. A method for predicting diarrhoea in a subject to whom a microtubule stabilizing agent is to be administered, comprising the steps of:
(a) determining whether the subject has a lower than normal haematological levels as determined by haematological assays selected from the group consisting of haematocrit and haemoglobin levels; and
(b) determining whether the subject is at risk for diarrhoea following the administration of the microtubule stabilizing agent.

11. The method of claim 2, further comprising the steps of:
(c) determining the appropriate therapy for the subject from the group consisting of (1)altering the dose of the drug, (2) providing additional or alternative concomitant medication; and (3) choosing not to prescribe that drug for that subject.

12. (canceled)

13. (canceled)

14. (canceled)

15. (canceled)
